(19) United States
(12) Patent Application Publication
(10) Pub. No.: US 2005/0289524 A1
(43) Pub. Date: Dec. 29, 2005

(54) Systems and methods for software based on business concepts

(76) Inventor: Simon McGinnes, Hilton Head Island, SC (US)

Correspondence Address: SUTHERLAND ASBILL & BRENNAN LLP, 999 PEACHTREE STREET, N.E., ATLANTA, GA, 30309, US

(21) Appl. No.: 11/158,969

(22) Filed: Jun. 22, 2005

Related U.S. Application Data
(60) Provisional application No. 60/581,759, filed on Jun. 22, 2004.

(51) Int. Cl. G06F 9/45

(52) U.S. Cl. 717/140

(57) ABSTRACT

Business concept definitions may be utilized with software applications, components, tools, and system software. The business concepts definitions are each associated with archetypal definitions, which may also be known as innate concepts. These archetypal definitions may include a person, an organization, a system, a place, an activity, a document, a conceptual object, a physical object, and a category. The business concept definitions may also be represented by an image on a user interface, where the images may be selectable by a user. These business concept definitions may be manipulated and modified. Indeed, certain relationships may be denoted between business concept definitions through the positioning of the images on a user interface. Because these business concept definitions are associated with archetypal definitions, which may be intuitive for users, application definitions using these business concept definitions may be easily created by a user without programming skills.

### RELATED APPLICATIONS

The present application claims priority to U.S. Provisional Patent Application Ser. No. 60/581,759 filed Jun. 22, 2004, which is hereby incorporated by reference as if set forth fully herein.

### FIELD OF THE INVENTIONS

The present invention generally relates to software, and more specifically, to software applications, components, tools, and system software that support the rapid construction, deployment, use, and modification of sophisticated business software applications through the definition of mental concepts and without requiring programming skills.

### BACKGROUND OF THE INVENTION

Today, much software is constructed without a clear idea of the mental model which the user or customer holds of their own business world. The dissonance between the customer's mental model and the model implicit in software can be a major source of frustration and dissatisfaction with software. Traditional software development methods have resulted in software that is extremely costly and complicated to build and modify, yet which often matches poorly with the customer's own world-view, and consequently fails to address all of the customer's needs.

Moreover, each piece of software implements a unique set of concepts which the user must understand and match to their own situation. For example, the program Microsoft Outlook incorporates the concepts appointment, task, contact, amongst others. Yet other programs offer different (and often conflicting) concepts, all of which the user must mentally reconcile.

Most operating systems provide shared services which are used by different applications programs. It would be reasonable to suppose that operating systems could impose some kind of common conceptual framework within which applications programs could operate. For example, an operating system will typically support the concept of “a file” and allow application programs to use common services for manipulating files. But operating systems do not support business-oriented concepts like “person,” “place,” and “physical object.” In other words, operating systems do not provide a common set of concepts that relate to the user's business world, and so cannot offer shared services designed especially to manipulate data about people, places and physical objects in appropriate ways.

One reason for this lack of support is that business concepts have traditionally been regarded as unique to each business situation, and therefore the province of each individually-tailored software application. It has been left up to systems analysts and programmers to devise the concepts that each software application will support. It has not been considered possible (or desirable) to support common business concepts at the level of the operating system, or even between selected software applications. This is why, for example, two programs (even from the same software company) can offer widely varying ways of representing what are, in fact, the same underlying mental concepts. For example, consider the different ways in which people are represented in the two software products Microsoft Outlook and Microsoft Project. As another example, consider information about purchases held by a typical small business, stored both in the accounting system and in operational databases. Any attempt at combining or reconciling this information between the two types of system will quickly show that they structure the information in different ways, making data sharing difficult if not impossible.

In summary, the idea of formulating concepts especially for each software application, on an ad hoc basis, is the industry standard practice and yet is fraught with problems. It leads to similar ideas being expressed in incompatible ways, at the whim of the software designer. The consequence is incompatible and hard-to-understand software.

It is, in fact, rather difficult for software designers to map and formulate the mental concepts inherent in an end-user's business world. This is often because of lack of expertise or understanding. But there is also an inherent tension between the software designer's need for formality and rigor and the end-user's need for communication and understandability. To appreciate this tension between formality and understandability, consider a situation in which a business process must be analyzed or modeled to allow the introduction of supporting software. The resulting “model” would represent the design specifications for the software required to support the business process. The software designer needs to be able to capture details of the business process in detail and with great accuracy, and this information then needs to be “refined” until it is useful as part of the design specification for a new software system. On the other hand, the end user or customer needs to be able to understand the designer's representation of their business process so that they can verify its accuracy.

In an effort to improve communication with the customer, the designer might decide to represent the relevant business process using a video recording. This would help increase the understandability of the “model” since the video recording is a very accessible representation of the business process in operation. However, it is also an inherently unstructured representation, and aspects that are not visible cannot be shown. The internal structure of a business process cannot easily be brought out in a video recording. It is difficult to imagine how a video recording could easily be “refined” until it became useful as the design specification for a new software application or system.

Alternatively, the designer may choose to communicate the model to the layperson through prose. However, prose is also a poor candidate for structuring models in the rigorous way required for detailed systems design. The flexibility and ambiguity of natural language make it difficult to maintain a high level of structure, which is typically necessary in a system or application specification. Prose specifications often contain indefinite, indeterminate, or contradictory statements, which are oftentimes undetected. Thus, prose would also be insufficient as a means of system specification.

As a third example, the designer might represent the business process very accurately by adopting the highly structured VDM (Vienna Development Method) notation, which uses a notation resembling mathematical equations. The VDM model may capture all of the intricacies and alternatives of the business process in extensive detail. But a layperson, such as a customer, would not recognize or understand the model as a depiction of his or her own business process. The customer would therefore be unable to confirm whether or not the specification modeled in VDM notation was accurate. The sheer technicality of this technique, and of other popular highly structured techniques such as UML (Unified Modeling Language), reduces their effectiveness as a communication tool. The need to express concepts in a highly structured way results in representations, constructions and terminology that do not correspond to recognizable real-world concepts from the customer's point of view.

A further problem with current methods of producing software applications is that they are labor-intensive. Programming is slow, costly, and error-prone. It requires increasingly specialized skills, and knowledge. The latest technologies for application construction, such as Microsoft NET and Sun's J2EE standard, are more complex than ever and demand great expertise on the part of the designer and developer. One obvious way of making programming less labor-intensive is to automate it. To date, however, it has not been possible to automate the programmer's job in any widely-applicable way. A series of code generators, CASE (computer-aided software engineering) tools and other products have emerged with claims in this direction. Some of these have been used successfully by programmers to improve their own productivity. But the idea of replacing the programmer altogether remains a “holy grail.” Experience has shown that none of these tools has allowed typical business computer users to meet their own needs for software.

Despite the welter of new software development techniques that have emerged during the past few decades, and the development of exciting new technologies such as the World-Wide Web, the problems outlined above have still not been solved. Programmers continue to produce systems that match poorly with the end user's view of their own business world. Different systems represent the same things in incompatible ways. It remains difficult to get software applications to work together. Most end users still cannot build their own systems and continue to rely on packaged software and programmers to meet their own needs for all but the simplest requirements.

### SUMMARY OF THE INVENTION

Systems, methods, and software of the present invention, also referred to herein as the Business Concept Implementation Manager (“BCIM”), place capturing mental concepts at the top of the agenda when designing and using computer software including operating systems, systems software, software components, software applications and software tools. The BCIM allows usable software to be created directly from descriptions of mental concepts expressed in terms of a set of shared, innate, or archetypal concepts. In doing so, it removes the need to carry out many tasks that today are done by software designers and developers.

Embodiments of the present invention may satisfy several conditions. First, a simple shared framework of common underlying “innate” or archetypal concepts may be implemented within operating systems, application servers, database management systems, software applications and other types of software. These common high-level concepts correspond to mental concepts of real-world things such as people, places and physical objects. They can help programs share information without the need for manual programming. For example, if two programs share the common archetype or innate concept place (physical location), then they can exchange data about places, even if they do not share complex schemas describing the structure of information about places. Use of the common concepts within network operating systems and web servers would allow this sharing of information to occur globally.

This may be analogous to the way people typically interact with one another. People are able to exchange information usefully with each other, even though they do not share identical mental structures, because they assume that they share some very fundamental innate concepts or archetypes, such as the concept of a person and that of a place. In contrast, technologies like XML web services and EDI (electronic data interchange) seek to link software applications using a myriad of distinct low-level message formats without agreement on the existence of any shared high-level concepts.

Secondly, a method may exist to permit the representation of more complex mental concepts in terms of the shared innate concepts or archetypes, in a way that is both understandable to the end user and rigorous enough to be used as the basis for system design and construction, whether by software professionals or automated tools. With such a representation, end users can understand much more easily the concepts that their software implements, and can even change those concepts to suit their own needs.

Thirdly, a technology may be implemented such that the definitions of more complex mental concepts, in terms of the shared innate concepts, can be turned automatically into working software functionality. The technology would encapsulate rules to convert concept definitions into usable software applications, components, or subsystems for a range of software and hardware platforms, including personal computers, servers, Internet search engines, handheld devices, and the like. The operator of the technology would not need programming skills. Ideally, this technology would be built into the relevant operating systems, web servers, and the like so that many of the functions traditionally considered the business of applications software would become standardized operating system services to be shared between multiple applications, or even used in the absence of applications as we now know them.

Thus, much of today's software design, construction and maintenance can be either avoided or done automatically, and end users would be able to satisfy far more of their own needs, if several or all of these conditions were met:
A shared set of well-formed “innate” (i.e., underlying) or archetypal concepts is identified to act as a common basis for design.
These innate concepts are embedded in operating systems, application servers and other software.
Understandable methods of describing more specific mental concepts, in terms of the shared innate concepts, are available to end users.
Software design principles are codified in and automated by tools, applications, and systems software such that the resulting more specific concept definitions can be converted transparently into useable software functionality, applications and services.

According to an embodiment of the invention, there is a system for providing application functionality. The system includes an application definition, where the application definition includes a plurality of archetypal categories, a plurality of business concept definitions, where at least one business concept definition corresponds to one of the plurality of archetypal categories, where at least one business concept is named and represented by a marker, and where at least two business concept definitions have a relationship that is based at least in part on the archetypal categories associated with each of the two business concept definitions. The system further includes a run-time component, where the run-time component executes: the application definition, and upon modification of one of the business concept definitions, a modified application definition reflecting the modification to the business concept definitions.

According to an aspect of the invention, at least a portion of the plurality of archetypal categories are associated with one or more sets of persons, of organizations, of systems, of places, of activities, of documents, of conceptual objects, of physical objects, or of categories. According to another aspect of the invention, the run-time component includes one or more of system software and application software. According to yet another aspect of the invention, the executed application may include one or more user interfaces associated with the business concept definitions, where constructs of the user interfaces depend at least in part on the archetypal categories associated with the business concept definitions. According to still another aspect of the invention, the system may further include at least one window associated with a business concept definition, the window capable of displaying components of the business concept definition. According to another aspect of the invention, the system may further include an interpretation function for presenting components of the business concepts in at least one of natural language and object model view. According to yet another aspect of the invention, the relationship between the two business concept definitions is determined, at least in part, on positions of the markers on a user interface. The markers in close proximity to each other may denote a close relationship between the corresponding business concept definitions. According to an aspect of the invention, the markers may include images. According to yet another aspect of the invention, the system may further include a data table associated with one or more business concept definitions.

According to another embodiment of the invention, there is a method for defining business concept associations. The method includes providing a plurality of archetypal categories, defining a plurality of business concepts, where at least one business concept definition corresponds to one of the plurality of archetypal categories, where at least one business concept is named and represented by a marker, and where at least two business concept definitions have a relationship that is based at least in part on the archetypal categories associated with each of the two business concept definitions. The method further includes automatically deducing a relationship between a first business concept definition represented by a first marker and a second business concept definition represented by a second marker based at least in part on a position of the first marker relative to the second marker.

According to an aspect of the invention, the method may further include generating at least one database table associated with the deduced relationship between the first business concept definition and the second business concept definition. According to another aspect of the invention, the method may further include providing a user interface associated with at least one of the business concept definitions, where characteristics of the user interface are based at least in part on the archetypal categories associated with the business concept definitions. According to yet another aspect of the invention, providing a plurality of archetypal categories includes providing types corresponding to one or more sets of persons, of organizations, of systems, of places, of activities, of documents, of conceptual objects, of physical objects, or of categories. According to still another aspect of the invention, the relationship may include a relationship where a first business concept definition contains a second business concept definition.

According to yet another embodiment of the invention, there is software for modeling business scenarios. The software includes a plurality of archetypal categories, each archetypal category being associated with a category of real-world elements in a business scenario and an application definition including a plurality of business concept definitions, where each business concept definition is defined at least in part based on the archetypal categories. The software further includes an image selector facility for selecting images corresponding to business concept definitions, where the positioning of the images on a user interface denotes, at least in part, a relationship between a first business concept definition and a second business concepts definition and a generation function, where the generation function is operable to generate at least one application based on the application definition.

According to an aspect of the invention, at least a portion of the archetypal categories may include categories associated with one or more sets of persons, of organizations, of systems, of places, of activities, of documents, of conceptual objects, of physical objects, or of categories. According to another aspect of the invention, the image search facility provides a plurality of images for selection based at least in part on the archetypal category associated with the business concept definition. According to yet another aspect of the invention, the software may further include an interpretation function for viewing the application definition in natural language. According to still another aspect of the invention, the software may further include one or more tables for use in automatically deducing relationships between business concept definitions based on corresponding archetypal categories. According to an aspect of the invention, the generation function may be operable to generate at least one database implementing at least a portion of the business concept definitions and at least a portion of the deduced relationships between the business concept definitions. According to another aspect of the invention, the generation function may be operable to generate at least one user interface for at least a portion of the plurality of business concept definitions. According to another aspect of the invention, characteristics of the user interface may depend at least in part on the archetypal categories for the business concept definitions. According to yet another aspect of the invention, characteristics of the user interface may depend at least in part on user roles.

### BRIEF DESCRIPTION OF THE SEVERAL VIEWS OF THE DRAWING(S)

Reference will now be made to the accompanying drawings, which are not necessarily drawn to scale, and wherein:

FIG. 1 is illustrative of innate concepts according to an embodiment of the present invention.

FIG. 2 shows the structured and unstructured components according to an embodiment of the present invention.

FIG. 3 shows an activity wizard according to an embodiment of the present invention.

FIG. 4 shows two help components according to an embodiment of the present invention.

FIG. 5 shows examples of the contents of help components according to an embodiment of the present invention.

FIG. 6 displays examples of annotations according to an embodiment of the present invention.

FIG. 7 illustrates the business concepts created from an annotation according to an embodiment of the present invention.

FIG. 8 shows an example of locators according to an embodiment of the present invention.

FIG. 9 displays a set of innate business concept types according to an embodiment of the present invention.

FIG. 10 displays an image search facility according to an embodiment of the present invention.

FIG. 11 displays an example of a compound symbol generated in accordance with an embodiment of the present invention.

FIG. 12 is a flow chart of the process utilized by an image search facility according to an embodiment of the present invention.

FIG. 13 displays sets of data item types and annotation types according to an embodiment of the present invention.

FIG. 14 displays an example of plural names according to an embodiment of the present invention.

FIG. 15 displays a use of customized backgrounds according to an embodiment of the present invention.

FIG. 16A-E illustrates a simple animation for an activity business concept according to an embodiment of the present invention.

FIG. 17 illustrates denoting a part relationship according to an embodiment of the present invention.

FIG. 18 shows a view of a business concept according to an embodiment of the present invention.

FIG. 19 illustrates a Microsoft Access database generated according to an embodiment of the present invention.

FIG. 20 shows an application definition according to an embodiment of the present invention.

FIG. 21 shows a view of an application definition according to an embodiment of the present invention.

FIG. 21A illustrates a user interface form according to an embodiment of the present invention.

FIGS. 22A and 22B illustrate properties of a business concept according to an embodiment of the present invention.

FIG. 23 illustrates a list of possible values for a data item according to an embodiment of the present invention.

FIGS. 24A to 24C show application properties according to an embodiment of the present invention.

FIG. 25 shows an ordering window according to an embodiment of the present invention.

FIG. 26 shows the default view of an application definition according to an embodiment of the present invention.

FIG. 27 shows a concept explorer window according to an embodiment of the present invention.

FIG. 28 illustrates an example of an interpretation view window according to an embodiment of the present invention.

FIG. 29 shows a sentence-style interpretation according to an embodiment of the present invention.

FIG. 30 displays a business concept and its related concepts represented in the form of an object class diagram according to an embodiment of the present invention.

FIG. 31 shows a complete application definition represented in the form of an object class diagram according to an embodiment of the present invention.

FIG. 32 shows an overview flowchart of the steps in creating an application according to an embodiment of the present invention.

FIG. 33 shows a flowchart of the steps in designing and providing application functionality according to an embodiment of the present invention.

FIG. 34 shows an application definition interpreted in natural language format according to an embodiment of the present invention.

FIG. 35 displays an example of the result after a check of the application definition according to an embodiment of the present invention.

FIG. 36 shows a portion of the importation process according to an embodiment of the present invention.

FIG. 37 shows a flowchart of the application generation process according to an embodiment of the present invention.

FIG. 38 displays an example of a source table according to an embodiment of the present invention.

FIG. 39 shows an example of an application definition according to an embodiment of the present invention.

FIGS. 40-66 illustrate exemplary pages of applications generated according to an embodiment of the present invention.

FIGS. 67 and 68 illustrate applications that have been linked according to an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams and flowchart illustrations of systems, methods, apparatuses and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

For illustrative purposes only, an aspect of the present invention may be referred to as the Business Concept Implementation Manager (“BCIM”). The BCIM may be used as a standalone tool or it may be embedded within other software such as software applications and operating systems. It allows applications to be designed through the identification and definition of business concepts (“business concept definition”), and allows workable software application functionality, storage media, and user interfaces to be created directly from the business concepts. The use of business concepts in the BCIM to provide application functionality automatically lessens the need for high-level planning and requirements analysis because the cost of making mistakes at the planning/requirements stage is greatly diminished by the reduction in manual programming. In fact, with the BCIM, the creation, use and modification of working application functionality becomes a very feasible strategy for identifying and refining software requirements.

The BCIM encapsulates the kinds of knowledge and expertise applied by expert analysts and designers of information systems. For example, experienced analysts and designers have some pre-existing knowledge of typical business processes or scenarios, or at least of situations in which humans interact to achieve some end. This pre-existing knowledge is utilized when more specific information about a business scenario is not known or otherwise available. Thus, a designer or analyst can understand a new business process by reference to general ideas and knowledge about similar business processes or situations, or even general knowledge about human activity and interaction. The same approach may be taken to define standard business situations that occur naturally across different business domains. For example, human beings may naturally generalize the idea of a “consultation” so that it can be applied to visiting a doctor, seeing a lawyer, talking to an accountant, and the like.

Thus, the BCIM allows general knowledge to be applied to more specific situations through an understanding of business scenarios. These are common patterns that are not specific to a particular business area but are eminently recognizable in the realm of human activity in the real-world. Each business scenario is made up of people, objects, locations, and the like. The BCIM has the ability to describe the different types of people, objects, locations, and the like that are found in a business scenario. Accordingly, the BCIM provides baseline knowledge of typical business scenarios by incorporating innate or predefined types, known as innate concepts and also known as archetypal types or categories, basic types, or innate types. The incorporation of these innate concepts allows a full range of business concepts to be conveniently and easily described in the BCIM. Further, the use of these innate concepts allows the BCIM to make important distinctions between business concepts, a process which is otherwise known as differential design. One useful type of differential design by the BCIM is the use of the most appropriate user interface constructs for each different type of business concept. At its simplest level this could result in a list of people being presented in a different manner from, say, a list of products, because the two mental concepts (people and products) are represented with different innate concepts.

The BCIM is also capable of predictive modeling of business situations based on the statistical probability of association between the known innate concepts that are used to represent business concepts. For example, the BCIM can judge whether one business concept is best represented as part of another business concept, by determining the statistically most likely relationship between the two innate concepts in question. It can also judge whether items described by a given business concept are most likely to be linked to one or many items for another business concept, again by examining the underlying innate concepts. As another example, the BCIM can predictively judge the correct database design approach to use in the case of “is a” relationship-when one business concept is a more specific version of another business concept. This latter use automates the process whereby a human database designer would have to decide between (a) aggregating subtype and supertype entities to form one physical table in the database, and (b) implementing separate tables. The semantic implications of each alternative are different, and so this decision is a crucial one if the database is to meet requirements. Again, the BCIM tool does this based on statistical probability. Aspects of these examples are illustrative of automated differential design by the BCIM based on innate concepts.

Each business concept may correspond to at least one mental concept. Business concepts may share several properties: each business concept may be represented using a unique image chosen by the designer, it may be defined in terms of an underlying innate concept, and it may be defined by association to other business concepts.

I. Business Concepts Correspond to Mental Models

Business concepts may be put together to form application definitions, using a suitable medium or tool such as a BCIM. The resulting application definitions may then closely match the user's mental model about one or more business scenarios. Business concepts may be defined in terms of innate concepts, which are intended to be familiar concepts, and they may be depicted in a BCIM using recognizable images, which may be selectable by the user. These features may increase the understandability of the application definitions. The user is able to define the software application in terms of placeholders which stand in for business-oriented mental concepts. This allows users to focus on modeling their real-world business scenarios, something they know about, instead of implementing program designs or data structures, something they typically do not know about

A mental model may correspond to a visual depiction of a scenario, and a particular way in which the scenario could occur. Using a theatrical analogy, the mental model can be thought of as a scene within which actors participate in a situation and act out their roles. The scene includes fixed and moveable elements representing buildings, equipment, and furniture. In any particular scene:
The actors represent people and organizations.
The actors may be grouped into organizations or parties.
The scene takes place at a physical location.
Actors may create or exchange physical objects and documents.
Less concrete concepts may be represented, discussed, or exchanged by the actors in the scene, thereby symbolizing intangible concepts such as ideas, information, and intentions.
   As the action proceeds, elements of the scene or the physical location of the scene may change. Thus, the mental model may further involve many individual scenes, strung together to form a narrative. A mental model can therefore be described in terms of people, organizations, places, physical objects, documents, conceptual objects, and the like. Each mental concept in the mental model is associated or related to other mental concepts. These associations are crucial in understanding mental concepts, since a mental concept has little meaning when taken in isolation from other mental concepts.

The building blocks of BCIM application definitions are components that represent the mental concepts of the mental model described above. The different types of building block components (“innate concepts” or “archetypal categories”) supported by an embodiment of the BCIM include persons, organizations, systems, places, activities, documents, conceptual objects, physical objects, and categories. Each of the business concepts represented in the application definition will be defined in terms of one or more of these innate concepts. In addition, business concepts may be described by association to other business concepts since, like a mental concept, a business concept lacks meaning if it is not adequately expressed in terms of or in relation to other business concepts. However, to provide flexibility, business concepts may be initially defined without reference to any other business concepts. The relationship between the business concepts may then be specified at a later time.

Further, each business concept may be assigned one or more of a name, an image, and one or more annotations as desired. The names of the business concepts defined in the application definition may be terms provided by the user, thereby increasing the level of understandability of the application definitions. Images or pictures, also chosen by the user, may be used together with the names to make the meaning of the business concepts as clear as possible. The annotations allow users to reference existing documents, images and web sites and to add notes that may be helpful in understanding the business concepts and the application definition as a whole.

II. Innate Concepts and Other Component Types

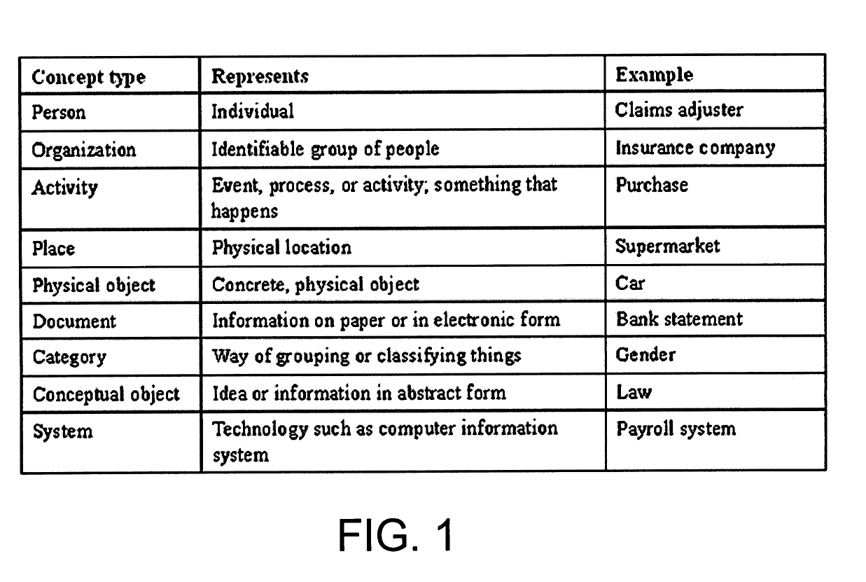

According to one embodiment, the BCIM includes a plurality of built-in innate concepts (also referred to as archetypal categories, basic types, or innate types) that can be used in defining business concepts that describe mental concepts relevant to business processes. As illustrated in FIG. 1, these innate concepts may include one or more of a person, an organization, an activity, a place, a physical object, a document, a category, a conceptual object, and a system. Examples of each of the innate concepts may include:
Person—an individual
Organization—an identifiable group of people, such as a company
Activity—an event, process, or activity (something that happens)
Place—a physical location
Physical Object—a concrete, physical object
Document—information on paper or in electronic form
Category—way of grouping or classifying things
Conceptual Object—idea or information in abstract form
System—technology such as a computer information system
   As described above in the examples, these innate concepts may be associated with real-world elements in a business scenario.

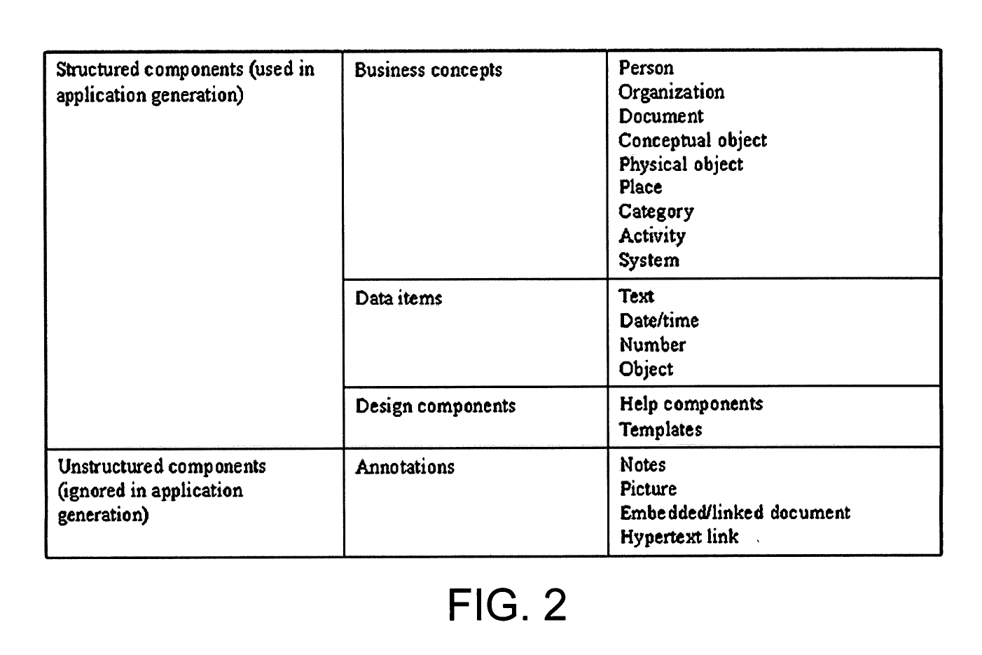

Other sets of innate concepts are possible for use in specific situations. In addition to supporting the innate concepts that underlie business concepts, the BCIM also supports data items, design components, and annotations as shown in FIG. 2. Some of these components are utilized during application design but not in the resulting application functionality. In particular, annotations are considered unstructured components, which are ignored during the generation of the application; however, they may be used in building help systems and other documentation relevant to the application functionality. Business concepts, data items, and design components are considered structured components, and are used directly to provide application functionality.

To capture information requirements, data items (e.g., text items, date/time, number and object) are supported so that they can be assigned and owned by the higher-level business concepts. Data items may also have formatting attributes, such as the length of a text item. If the user does not specify a formatting attribute for a data item, default attributes may be provided. In addition, each data item may be assigned a default value. The following types of data items may be used:
1. Text items may be of various standard types (e.g., name, address, email address, universal resource locator (URL)). Various attributes may be available for text items, including length and the types of acceptable characters. In addition, a list of valid values can be specified for any text item. For example a text item may be limited to the values “male” and “female.”

2. Dates/times are handled very flexibly. The content of each date/time may be specified as a combination of a date type and a time type. Examples are shown in Table I.

TABLE I

| Date types | | Time types | |
|---|---|---|---|
| None | Week (of year) | None | Minute and |
| Day of year | Week and day of | Hour | second |
| Day of month | week | Hour and minute | Second |
| Day of week | Year | Hour, minute and | Hour and |
| Month | Year and month | second | second |
| Month and | Year, month and day | Minute | |
| day of month | of month | | |
| | Year and week of year | | |

This allows any combination of the component parts of dates and times to be constructed simply by picking the types from lists. Note that these date and time types do not govern formatting (e.g., whether to represent dates as “Jan. 12-05,” “Jan. 12, 2005,” “Jan. 12, 2005,” or “Jan. 12, 2005”). Instead, the preferred date and time formatting may be specified globally for the whole application. If no formatting is specified, the operating system date/time display settings may be used.

3. Numbers may be assigned a length attribute and a number of decimal digits attribute. Formatting instructions allow numbers to be shown as currency amounts, percentages, autonumber fields, and the like.

4. Object items are embedded files, linked files, or documents such as word processor documents, pictures, video clips, and the like. These items are stored in an appropriate way depending on the platform (e.g., as binary large objects (BLOBS), OLE objects, or files).

Data items may be defined in terms of other data items to form compound data items. For example, the text item “Full Name” may be defined as a grouping of three separate text items: “Title,” “First Name,” and “Last Name.” Compound items may be nested to any depth. In addition, data items may be declared as read-only values (e.g., calculated values) in which case a derivation rule or formula may be entered to determine the values (e.g., a calculation or construction in terms of other values). Examples of a derivation rule or formula may include:
A customer number constructed as a concatenation of a running number, the first three letters of the customer name, and the date in form “yymmdd”.
The total amount payable on an invoice calculated as the sum of the price multiplied by the quantity on each order line.
An order status determined on the basis of the presence or absence of delivery and payment records.

As discussed in the previous section, innate concepts may be used to define business concepts that represent mental concepts in a user's world. The innate concepts do not describe software constructs such as objects, classes, or data entities, but rather correspond to mental business-oriented concepts. Therefore, the use of innate concepts in defining business concepts provides an increased level of understanding about the business processes embodied by the business concepts.

The innate concepts in the BCIM are intended to be general enough to describe almost any scenario naturally. However, they are also intended to be sufficiently concrete to be self-explanatory and easily understood by the layperson. For example, most people know what people, places, and organizations are. The meaning of the innate concept conceptual object may be somewhat less intuitively obvious, since the range and variety of possible conceptual objects may be large. For example, the mental concepts “bank account” and “law” both fall into the category of conceptual objects, despite their lack of similarity.

The range of mental models that can be modeled using innate concepts is virtually unbounded. Indeed, these innate concepts cover the majority of business models and processes quite naturally. Additional flexibility is available since business concepts can be defined by extending the definitions of existing business concepts. Existing business concepts may be located and reused, for example from the current application definition, another application definition, or from a repository on the Internet. This allows a large body of pre-existing knowledge in existing business concepts to be applied to new business concepts.

For example, when defining a new business concept employee based on the innate concept person, the BCIM can consult pre-existing business definitions for other business concepts based on the innate concept person, which are named employee (or a synonym of “employee” such as “worker”). It can therefore suggest one or more suitable business concepts that have already been formulated. The advantage to a user is that an existing business concept may already contain suitable data items (e.g., text items such as the employee's name, address, contact details, job title, and the like) and relationships to other business concepts. Additionally, each data item referenced in the existing business concept may have already been fully defined (e.g., constituent components and attributes). For example, name could be defined as a text item consisting of three lower-level text items: title, first name, and last name, each of which may have its own attributes. Accordingly, the designer has only to modify the existing business concept such that it matches the desired requirements. By reusing definitions, the designer speeds up the application design process, while maintaining a high level of consistency among similar business concepts, especially when business concepts are extended rather than modified.

In addition, there are many situations where providing default business concepts can offer large productivity gains. For example, in the example above, significant time would be saved by initially defining what is meant by the business concept employee and the data items name, address, and phone contained within. This is because, in many cases, there is no need to restate business concepts repeatedly if they are defined similarly across applications. Additionally, where one business concept is frequently related to other specific business concepts, these relationships can also be offered by default.

Although the idea of providing default definitions for business concepts has been discussed, there is no necessity for the innate concepts to have predefined definitions of their own, since the user can easily define new business concepts or reuse existing business concept definitions. This may be counter-intuitive to software professionals who might expect the “supertype” concept to have at least one property. But, in today's environment, each software application implements its own set of business concepts from the ground up. To introduce the idea of innate concepts alongside today's software applications requires that the innate concepts be devoid of predefined definitions (because we cannot assume that anything is common between existing software concepts that correspond to any innate concept, for example). That way, the user may be completely free to define arbitrary new concepts based on the innate concepts.

However, the BCIM does allow innate concepts to have predefined definitions when appropriate. This is because it may not only support present day application architectures but also a future environment, where support for innate concepts is built into a range of system and application software including operating systems and Internet-based services. In this future environment, there may be advantages in providing standard definitions for innate concepts. For example, all operating systems that support innate concepts may assume that a name property exists for each business concept based on the person innate concept. In other words, the minimum that all applications would know about any person would be the person's name. This is the simplest possible example of standard innate concept definition, but even this simple example may confer significant benefits. For example, it may allow organizations to link all of their records about people even if those records were stored across multiple applications. This is because the operating system may be responsible for storing the “master record” (in this case, the name) of each individual, while either the operating system or specific applications would store more specialized information as required.

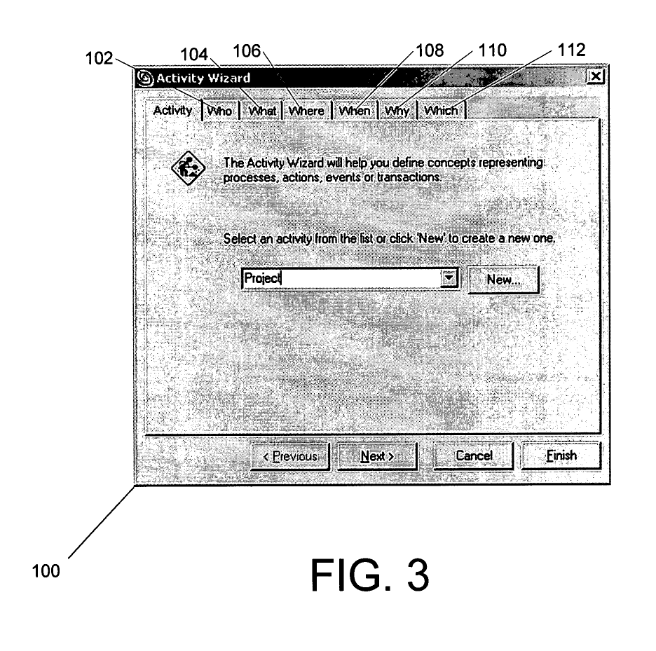

One of ordinary skill in the art would recognize that there is enormous scope for creation of other and more complex standard definitions for the innate concepts, and that each would bring its own benefits. For example, business concepts based on the innate concept activity may benefit from the use of default definitions. This is because almost every business activity takes place at a particular time (or time period), at a particular location(s), is performed by a person, an organization, or a machine, is the result of some other activity, and may give rise to more activities, and the like. As illustrated in FIG. 3, the Activity Wizard 100 exploits this commonality in the structure of activities to help define activity concepts easily and rapidly. In particular, for each activity concept, the Activity Wizard 100 prompts the user for:
the who 102: people, organizations, and systems that carry out the activity or that the activity is carried out on behalf of,
the what 104: documents, information, or physical object that are used as input to the activity or that are produced by the activity,
the where 106: place or organization where the activity takes place,
the when 108: time or time periods when the activity occurs,
the why 110: other activities that trigger or are triggered by the activity; other activities that contain or are contained by the activity, and
the which 112: categories that describe the activity or that indicate the status of an activity.
   At each of the prompts 102, 104, 106, 108, 110, and 112, the user may choose existing business concepts to fill the various slots, or may alternatively define new business concepts, perhaps in terms of one or more existing business concepts.

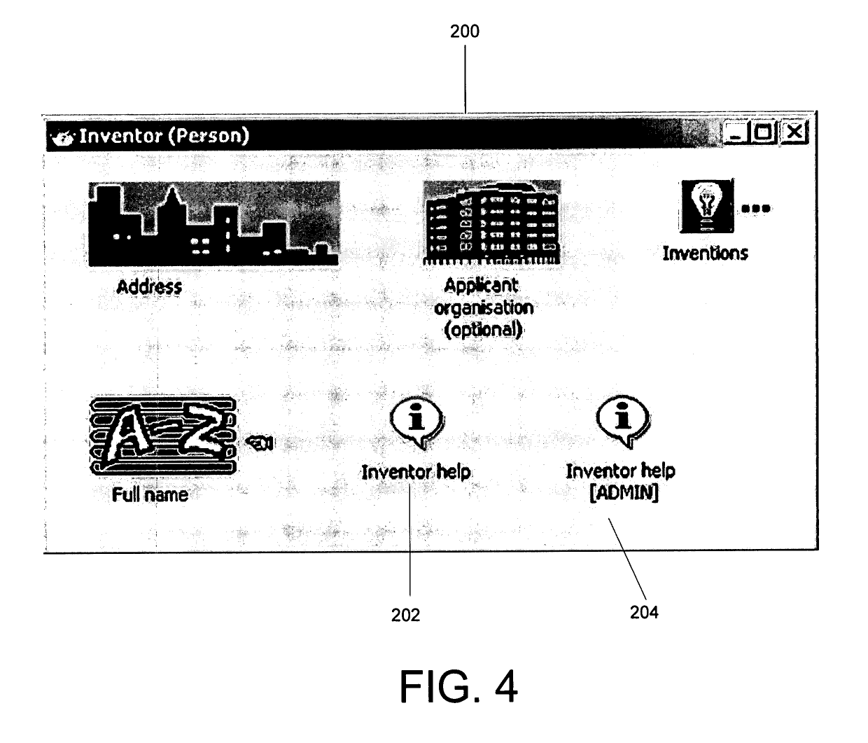

In addition to the business concepts and data items described above, the BCIM supports the definition of design components, which include help components and templates as shown in FIG. 2. Help components may be used to create help systems, which assist the user of a generated application by providing useful information and guidance. The BCIM can be used to build applications that incorporate suitable help systems. To enable creation of a help system, the user may place a help component in the window for each business concept as desired. There may not be a need to add any detail to the help components, since default help content may be created automatically. Pages can be omitted from the help system for a particular business concept simply by omitting the help component from the relevant business concept's window. FIG. 4 shows two help components in the inventor business concept's window 200—specifically, the inventor help component 202 and the inventor help [admin] component 204—which apply to two different user roles (e.g., general users and admin). The inventor help component 202 may be provided for general users while the inventor help [admin] component 204 may be provided for administrators, where general users and administrators have differing roles.

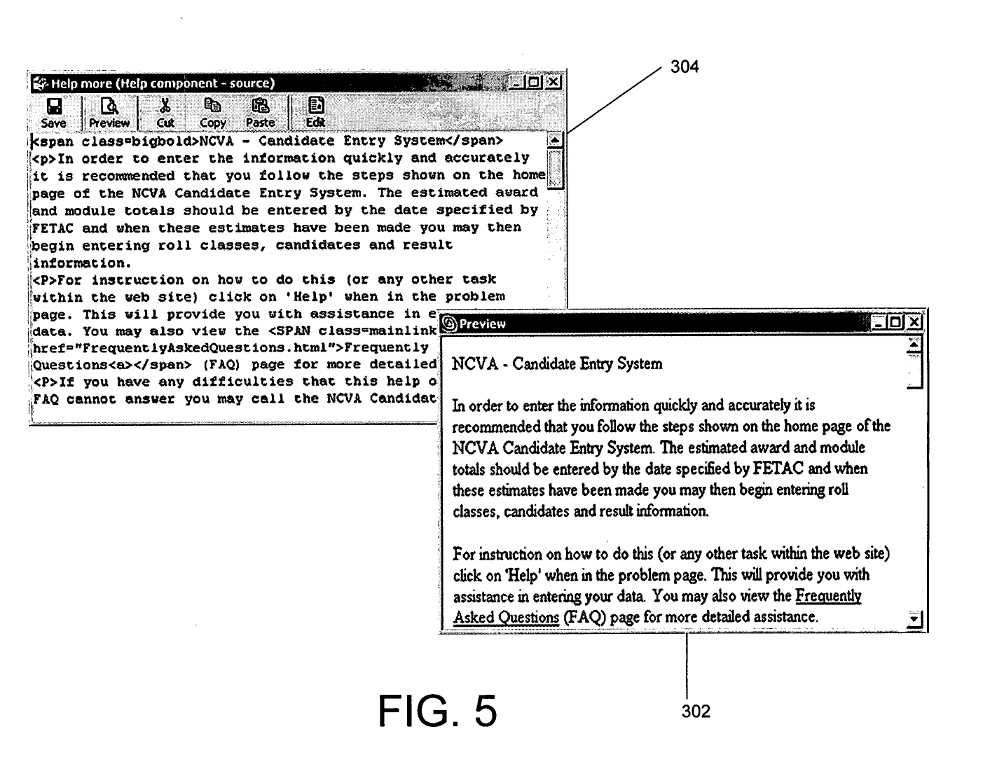

In the absence of specific content for each page, a default help page will be created by the BCIM in resulting application functionality for each help component associated with a business concept. The default help pages will be accessible from application forms and/or pages that derive from these business concepts. No code is needed to support these default help pages, since the BCIM incorporates them into the generated application automatically. The user can control the style and content for all help pages by providing customized templates, if desired. In addition, the user may be able to add additional help content to pages, either for a specific business concept or by adding new help components anywhere in the application definition. The additional content will automatically be inserted into the generated help systems at the appropriate points. As shown in FIG. 5, this additional content may be entered in the form of HTML (HyperText Markup Language) as illustrated in window 302, which may be previewed during the design stage as shown in window 304.

Multiple help systems can be built for specific classes of users (e.g., user roles) by adding further help components, each associated with one or more user roles. For example, in FIG. 4, inventor help [admin] 204 is associated with the admin user role. Therefore, the inventor help [admin] 204 is provided specifically for administrators. The additional help systems may be assumed to include all content from the default help system (e.g., inventor help 202) except where overridden by the inclusion of specific content associated with specified roles as outlined above. Standard content can also be omitted from the additional help systems if required.

Referring to FIG. 2, another type of design component is a design template. The BCIM allows design templates and other files to be inserted into an application definition. When the BCIM builds application functionality, the files may be incorporated into the generated application. For example, this approach can be used to provide modified or altered help templates, style sheets, properties files, customized page templates, static HTML pages, and scripts for use at run time in providing application functionality. In addition, the design template can be used to specify other aspects of the application functionality, including:
Fonts
Color scheme, backgrounds, etc
Screen layout (i.e., placement of elements)
Standard components such as boilerplate headers and footers
Graphical elements, such as logos
Navigation style (e.g., buttons, menus, navigator bar, toolbars, and the like)
Window behavior (e.g., open in same window, and the like)
   To edit the content of files used in the design templates, the BCIM may use the standard programs that are associated by the operating system with the particular file types. Because the BCIM uses the standard operating system programs, the designer can choose their favorite software authoring or revision tools to use. In other embodiments, the BCIM may provide its own authoring or revision tools. Further, the design templates can be used to preview application functions.

All materials used in providing application functionality, including the design templates, may be maintained in the application definition, thereby simplifying the application design process. If a user does not specify an application template, the BCIM may use a default template. The settings in the template may be applied to every relevant part of the resulting application functionality. If an application template defines non-standard components such as fonts and colors, these may override the standard ones used in the target environment (e.g., Windows or a web browser like Internet Explorer) when the resulting application functionality is provided.

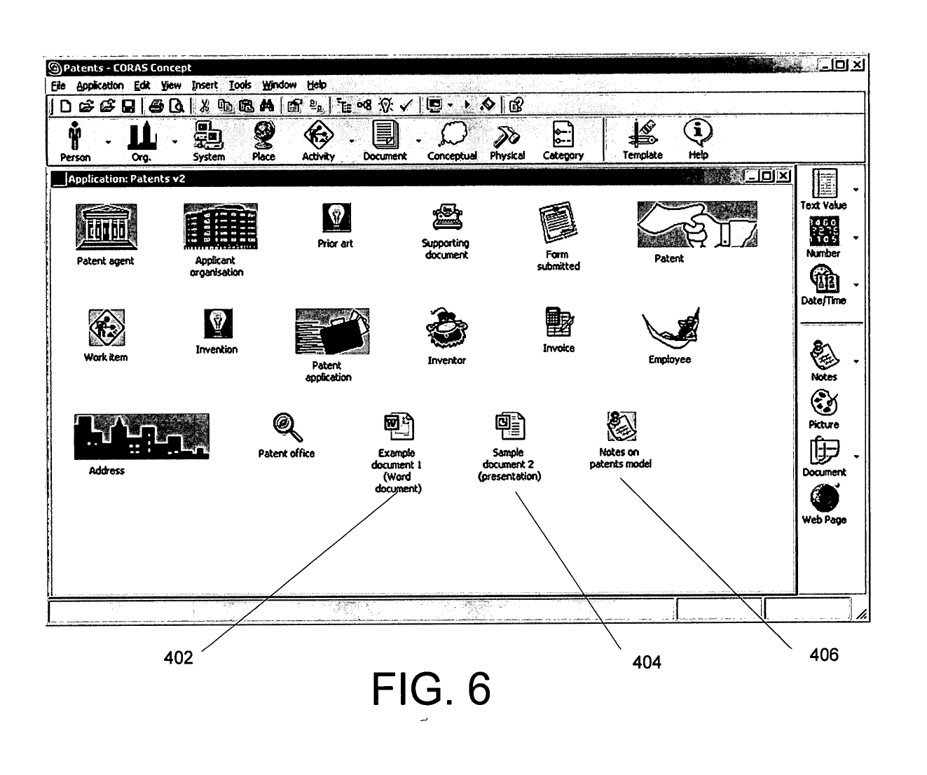

In addition, each business concept can be annotated to help make its meaning clear, using text notes, pictures, references to documents, hyperlinks, and the like to create a collage or compilation designed to add meaning and aid understanding. As discussed above, the annotations are unstructured concepts, in that they are not utilized by the BCIM in providing application functionality. Instead, these annotations allow the designer and others such as customers participating in the design phase to view related material and notes conveniently as needed. The annotations may include a range of helpful documents in an application definition such as application specifications (e.g., requirements statements from a customer), hyperlinks to websites with useful background information, designs, graphics, to-do lists, user comments, email communications, test results, and the like. FIG. 6 illustrates a business concept window that contains some annotations, including a Word document 402, a PowerPoint presentation 404, and notes 406.

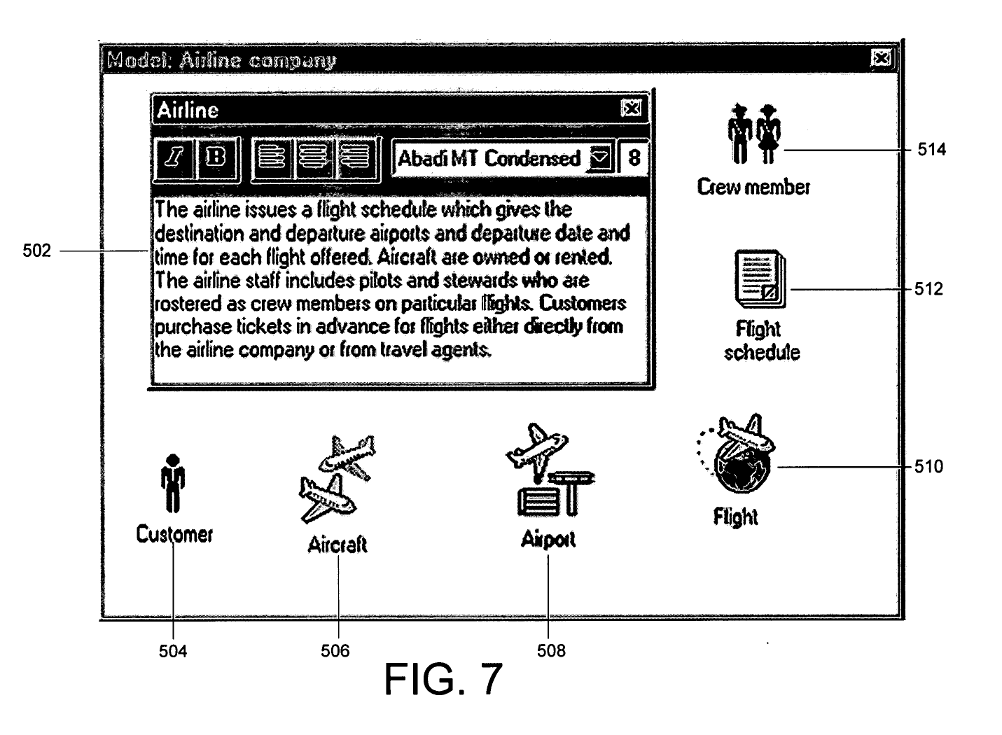

Recall that annotations may be ignored when the application definition is used by the BCIM to provide application functionality. However, as annotations are refined over time, they may eventually give rise to one or more structured concepts (e.g., business concepts) in the application definition. For example, terms or pictures used in annotations may be used as the basis for new business concepts, which will be used when applications functionality is provided. As an example, in FIG. 7, selected terms from the notes window 502 have been used to create new business concepts such as customer 504, aircraft 506, airport 508, flight 510, flight schedule 512, and crew member 514.

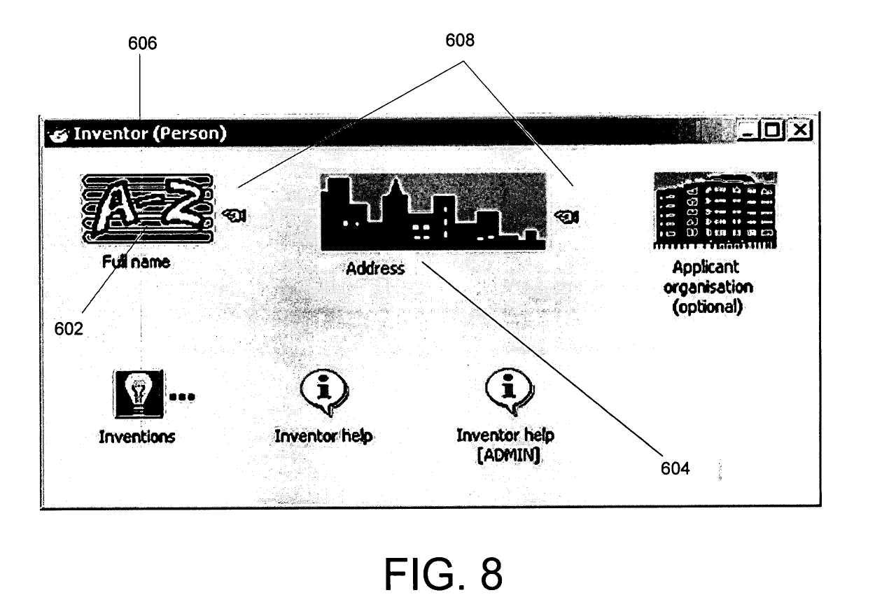

It may be convenient to nominate one or more constituent concepts to act as a locator for each business concept. Locators may be utilized to assist in the display of a data corresponding to a business concept in windows, reports, and the like. For example, in FIG. 8, the data items full name 602 and address 604 have been declared as locators for the business concept inventor 606. An indication 608, which may be a pointing hand or some other visual symbol, may be placed next to each item that is intended to be part of the business concept's locator. This means that the inventor's full name and address will always appear in resulting application functionality where it is necessary to choose an inventor, perhaps from a drop down list box in a user interface, or to identify inventors in some other way. Where appropriate, the values chosen as locators may appear first in any list of values and/or at the top of the screen or report. Locators can also be nested; if a business concept is used as a locator, its own locator will appear in its place. For example, the data item address may have constituent data items address 1 and city, both of which may be locators for the business concept address. Consequently, if address 604 is used as a locator for the business concept inventor 606, then these fields (address 1 and city) will appear alongside the inventor's name, in any context where it is necessary to choose an inventor.

Locators may affect the view of user interfaces, but not database structures. The BCIM does not assume that locators are unique, since it is quite possible for duplicate values to occur in the real world (e.g., for name). The use of locators is not to be confused with definition of primary or secondary keys, or with enforcement of uniqueness in a data table. By comparison, primary and secondary keys are defined automatically by the BCIM independent of locators, and there is no need for the user ever to specify or otherwise be concerned with them. In the event that no locators are defined, the BCIM will make sensible assumptions about what locators to use. For example, in the situation where a business concept contains several constituent business concepts and data items, the BCIM may assume that all or a subset of the constituents are locators.

While nine innate concepts are described above, one of ordinary skill in the art would readily recognize that other embodiments of the invention are not limited to those nine innate concepts. In particular, there may be more or fewer than those innate concepts, and, further, the innate concepts may be different according to the context that is to be captured. For example, another embodiment of the present invention may be directed towards chemists in a laboratory. In such a situation, the set of innate concepts might include concepts like test, compound, and element. As another example, a stock-trading system might include innate concepts for financial instrument, quote, deal, and third party.

III. Images and/or Names are Utilized to Represent Business Concepts

Another aspect of an embodiment of the BCIM is to take advantage of unconscious or “pre-attentive” processing, which relies on the use of simple, highly recognizable, and distinctive visual markers such as symbols, images, icons, or pictures. The visual appearance of application definitions in the BCIM may assist individuals and groups to explore and refine business concepts. In the BCIM, application definitions are intended to resemble both the situations they describe and the users' mental models of the same situations. Visual “chunking” methods and appropriate layout are used to improve understandability and to provide context.

As understood by the BCIM, an optimal marker such as a symbol may be one that conveys the maximum information with the minimum conscious effort by the viewer. Symbols that are too specific can lose visual economy and may convey unintended meanings. The symbols must be specific enough to represent real things but general enough to represent generic concepts. Economy of representation helps avoid information overload and may also be desirable for ease of implementation.

One possible embodiment of the BCIM utilizes the familiar graphical user interface (GUI) style, which is known to many computer users. Business concepts that are referenced within the application definition may be represented by markers such as icons in windows, which can be explored or exploded by double-clicking to reveal further windows containing icons that represent associated concepts, including other business concepts, data items, and help templates. This way of representing linked components contrasts with current best practice in the software industry, which focuses on “box-and-line” notations such as flowcharts and UML diagrams.

According to the illustrative embodiment, it should be noted that this is not the traditional meaning of icons and windows, but an entirely distinct and new use that takes advantage of the visual analogy between a mental model that contains mental concepts and a window that contains icons. It is a simple yet powerful way of expressing the fact that one business concept's definition “contains” another business concept. Further, icons can be created, moved, copied and deleted, in familiar ways, to represent the manipulation of concepts in an application definition. Since many users understand how to manipulate icons and windows, they already know a good deal about how to express and manipulate business concepts in this embodiment of the BCIM.

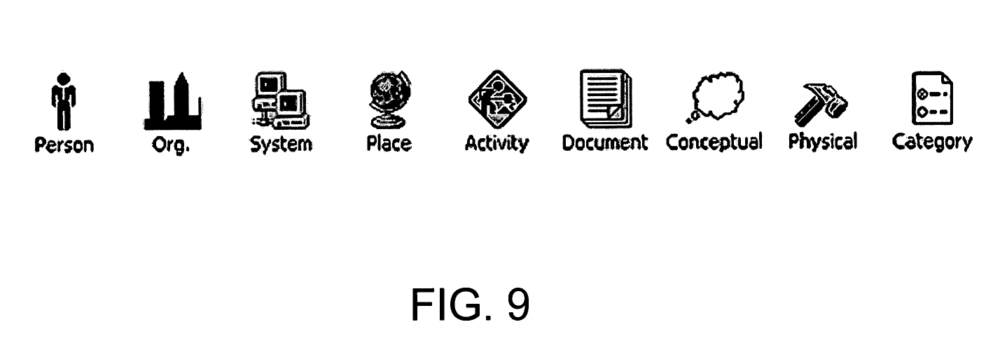

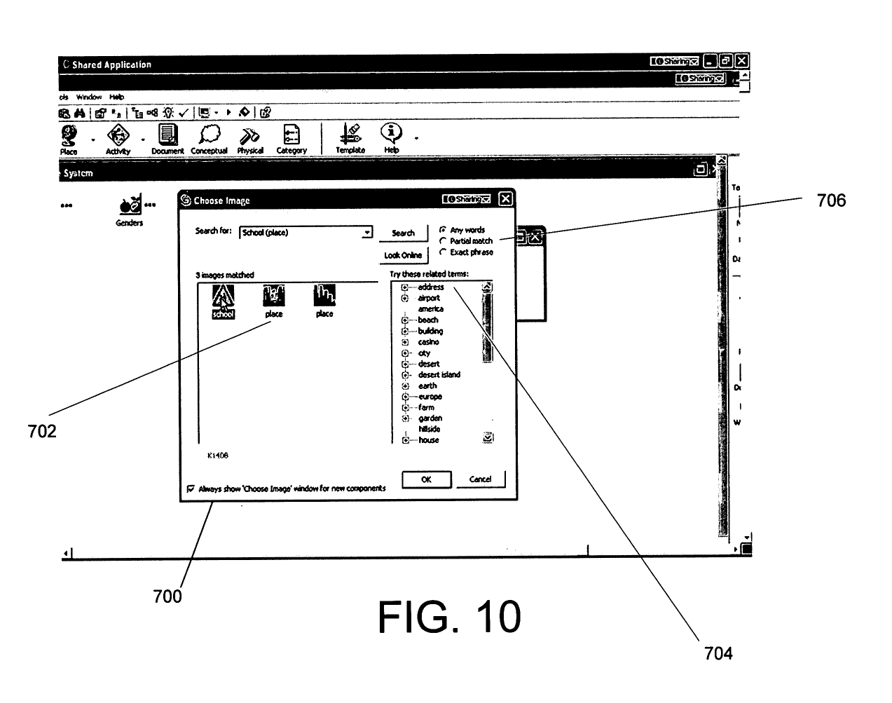

The BCIM may use default symbols to denote the innate concepts shown in FIG. 9. The designer may use customized images to denote more specific business concepts based on the innate concepts, either by choosing a marker (e.g., an image) from the built-in image search facility or by using an image from another source such as a website or CD-ROM image collection. Using the BCIM's built-in image search facility, a designer may be presented with a collection of images and icons that match the name or type of the business concept in question. The images and icons may either be stored locally or located on the Internet. For example, for a business concept school built from the innate concept place, the image search facility 700 might suggest the images and icons 702 based upon the business concept's name (“school”) and its innate concept (“place”) as illustrated in FIG. 10.

Related phrases and associated terms 704 are also displayed by the image search facility so that images and icons with related meanings and connotations can be explored. In this way, the image search facility 700 may mimic mental associative processes to find images based on meaning rather than simply by matching text strings. This makes it possible to locate useful images even for unusual business concepts; even if no images matching a specific name can be found by the image search facility 700, other more general images may be available based upon the innate concept that the business concept is based on. In addition, the image search facility 700 allows the user to specify what type of comparison should be done when searching (e.g., match any words, partial word match, “starts with” match, exact phrase match, Boolean expression, and the like) (706).

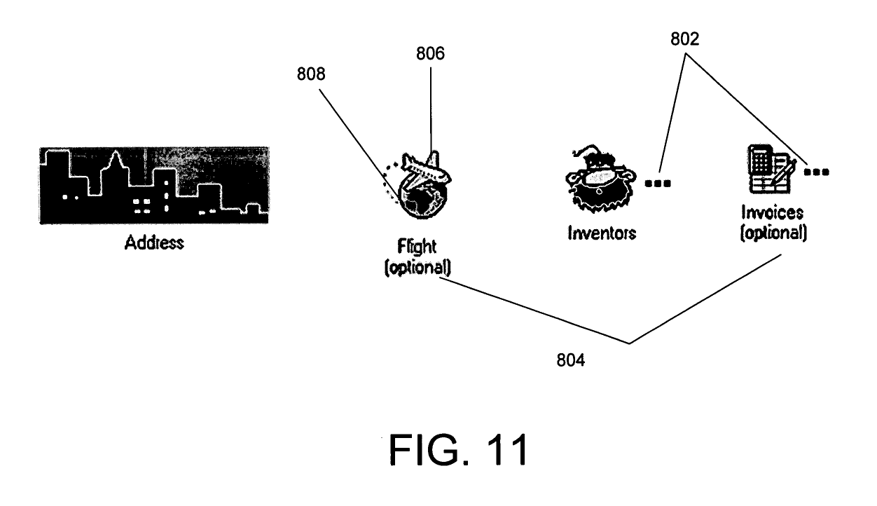

If no suitable image is readily available from the BCIM image search facility, then it may be possible to quickly and easily create new ones, perhaps from existing images. The ability to combine existing symbols may be useful for compound concepts, just as many words have been formed by combining existing words; the word “airport” is one example of such a compound word. As an example, in the BCIM, the business concept airport may be represented by combining symbols for a building and an aircraft. As an additional example, in FIG. 11, the compound symbol for “flight” was created by combining images of an airplane 806 and a globe 808.

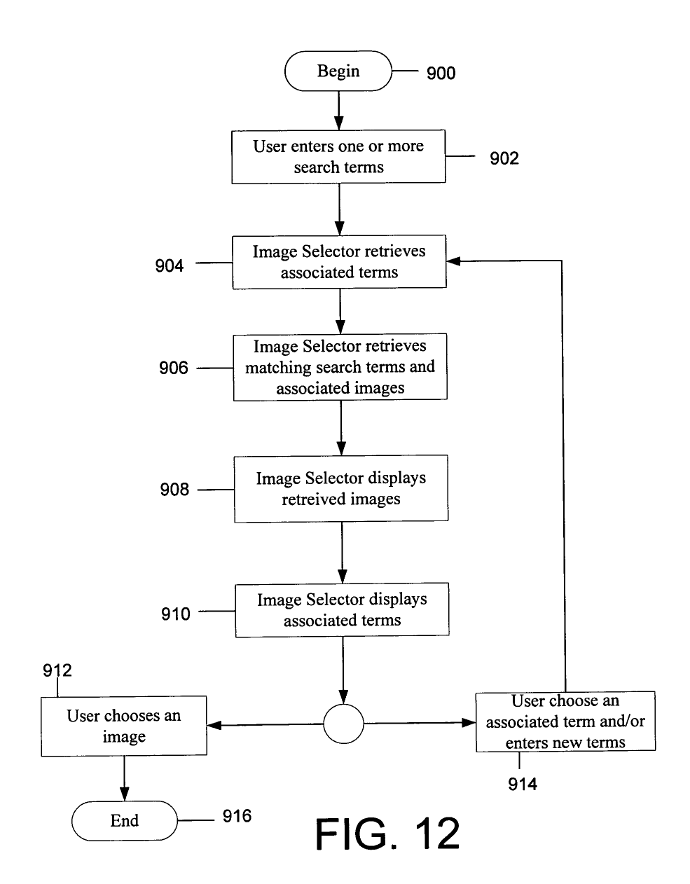

With reference to FIG. 12, the process utilized by the image search facility 700 in FIG. 10 (also referred to as the “image selector”) will now be described in further detail. According to block 902, the user selects or creates a business concept and invokes the image selector. The image selector may then use the name and innate concept of a particular business concept to search for images. Alternatively, the user may enter one or more search terms. In block 904, the image selector retrieves the related phrases and associated terms. These related phrases and associated terms allow a user to navigate to find alternative images in the event the image selector does not initially suggest suitable images. Next, the image selector retrieves the matching search terms and images (block 906). Subsequently, the image selector displays these matching search terms and retrieved images (block 908) as well as the related phrases and associated terms (block 910). If a suitable image is displayed, the user can select the image (block 912). Alternatively, the user may choose one of the displayed related phrases and associated terms (block 914) and repeat blocks 904-910 as necessary according to an illustrative embodiment.

The following data structures illustrated in Table II may be used internally by the BCIM's built-in image selector. The images utilized by the image selector may be in a plurality of graphical formats including bitmaps, icons, jpegs, gifs, tiffs, or other graphical formats as well known to one of ordinary skill in the art. An image terms table, which may be utilized by the image selector, may contain links between words and phrases and image files. The linked terms table functions similarly to a thesaurus in that it may contains links between similar words and phrases.

TABLE II

| Table or file | Purpose | Contents |
|---|---|---|
| Images | Image files in bitmap, | Images |
| | icon, jpeg, gif, tiff, or | |
| | other graphical format | |
| Image terms table | Link image files to phrases | Image file name |
| | | Phrases |
| Linked terms table | Link phrases to one another | Phrase |
| (thesaurus) | | Linked phrases |

As an example of the image search facility's operation (also shown in block 906 of FIG. 12), consider the case where a user defines a business concept based on innate concept person and named customer representative. Examples of searches performed by the image selector may include one or more of the following:
1. Search on “Image terms” table for phrases exactly matching the phrase “Customer representative.”
2. Search on “Image terms” table for phrases exactly matching the phrase “Customer.”
3. Search on “Image terms” table for phrases exactly matching the phrase “Representative.”
4. Search on “Linked terms” table for phrases exactly matching the phrase “Customer representative.”
5. The image selector displays all linked phrases, together with phrases linked to those terms, and then repeats steps 1 to 4 for each phrase found.
6. Search on “Image terms” table for phrases exactly matching the innate type name “Person.”

At each step, the image selector retrieves and displays any images whose file names are linked to the phrases retrieved (block 908 of FIG. 12), adding to the results to be displayed to the user. Although searching has been described above as a series of steps, the algorithm can be implemented efficiently in a minimal number of database queries (e.g., using structured query language (SQL)) thereby optimizing retrieval time. According to an illustrative embodiment, where a search retrieves more than perhaps twenty images, the user may be presented with the first twenty images and allowed to scroll on to view the next twenty images at a single time. This can reduce waiting time because searching can continue asynchronously in the background while the user is viewing the first set of images (and also subsequent sets, if necessary).

The image selector may include sub-searches for related terms to a depth of n levels (where n is configurable). The automatic use of linked terms, using a form of thesaurus to search for images, may make it more likely that suitable images will be found. The search for linked terms preemptively searches for associated images, so that the user may be presented only with possible alternative terms that have associated images. The image selector can optionally search for phrases containing a given text string, starting with a given string, or matching any Boolean expression.

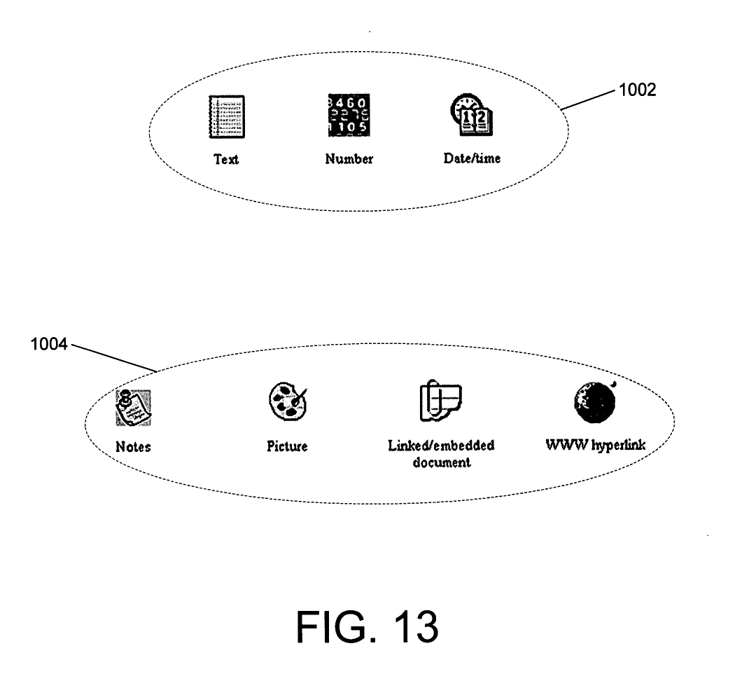

Images or icons are also used for the three kinds of data items 1002 and the four types of annotations 1004 as shown in FIG. 13. The user may use the built-in images or choose alternative images as discussed above. Note that all of the images displayed up until this point for business concepts, data items 1002, and annotations 1004, have been icon-sized graphics. However, larger-sized graphics may be just as effective, and therefore the library of images included in the image selector may contain larger-sized images and icons. In addition, users may utilize images of any size, as images can be automatically rendered smaller or larger by the image selector and BCIM where necessary.

As alluded to above, the image selector may not necessarily be limited to images that are built into the BCIM image search facility. For example, the image path for each image can also be an Internet URL, so the image selector has access to a vast number of images. According to an illustrative embodiment, if the user selects an option to “Look Online,” the image selector may automatically connect to the Internet and search for and display potentially suitable images from image and icon archives. With this feature, the user can optionally specify which sites to search. Since the contents of remote web sites may change, the image selector may ignore any images that are indexed but cannot be found at search time.

Each business concept, data item, or other component's selected image may be consistently used by the BCIM to represent the component wherever it appears, in both the application definition and in all resulting user interfaces. This consistency may be important, since the component may appear many times in an application definition and in user interfaces for different purposes. Consistently using the same image for a given business concept may reinforce a user's association between the relevant mental concept, the business concept's chosen image, and the name used to denote it. Reinforcement may aid learning, helping the user to go from conscious interpretation, which may be a slow and cognitively-intensive process, to unconscious interpretation, which may be an instantaneous, pre-attentive process. This provides opportunities for rapid visual scanning and increases the understandability of both the application definition and resulting user interfaces.

In addition to (or in conjunction with) images, business concepts may include visual indications of properties according to an illustrative embodiment. For example, if a business concept is plural, an indication 802, which may be three dots, may be placed next to its image, and its name may also be made plural as indicated in FIG. 11. If a business concept is plural, it means that there can be more than one (i.e., multiple) data instances corresponding to the particular business concept. For instance, in FIG. 11, the business concept inventor (based on innate concept person) is plural, indicating that there can be more than one inventor. If a business concept is optional, an indication 804 such as the word “Optional” may be included, as also shown in FIG. 11. A business concept or data item that is optional means that there may not be any entries (e.g., database rows or column values) for that particular business concept or data item in the application. Further, a business concept can be both plural and optional, as indicated by the business concept invoices. In this example, a client's invoice may not be produced until the relevant work is completed, thereby making the business concept invoices optional. In addition, once multiple projects are completed, then multiple invoices may be generated, thereby also making the business concept invoices plural.

As discussed above, business concepts and data items may have pictures, images, icons, and the like associated with them. One of ordinary skill in the art would recognize that many variations of these pictures, images, and icons are possible. For example, multimedia clips or animated images may be used instead of single picture images. Further, one could readily envision particular sounds, backgrounds or color scheme associations with respect to the images, pictures, icons, and the like.

In addition to or instead of a marker such as an image, each business concept and data item may have a marker in the form of a unique name. The name may represent the function that the component plays in the application definition, depending on user preferences. For example, in an application definition regarding student enrollments, a business concept based on an innate concept person may be named student, whereas it could be named employee in another application definition. In addition, a business concept named student in an application definition may appear as scholarship applicant elsewhere in the same application definition. The connection between a business concept and the roles that it can play is a useful form of “chunking” and facilitates mental associations between related ideas.

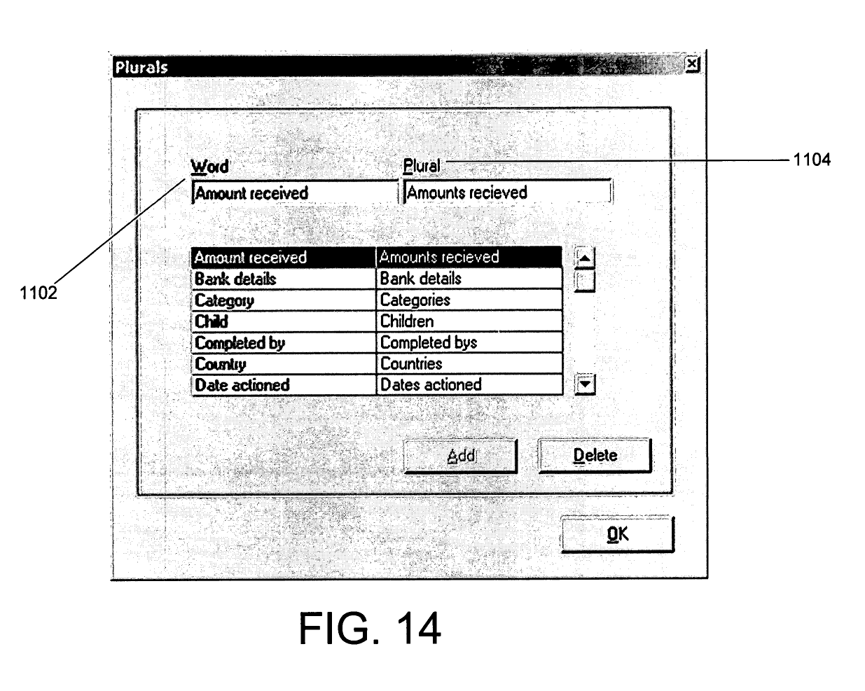

Business concepts and other components of application definitions may be named using familiar and meaningful terminology chosen by the user. When names are entered for business concepts, the BCIM may automatically derive the plural forms of the names, and the user may correct these as needed. As illustrated in FIG. 14, a user may browse a word 1102 and its plural 1104 and make additions or modifications when necessary. These plurals may be shown throughout the BCIM and resulting application functionality as appropriate. For example, they may appear in natural language interpretations of the business concepts. The plural forms modified or entered by the user may be stored in the BCIM for automatic reuse in later instances.

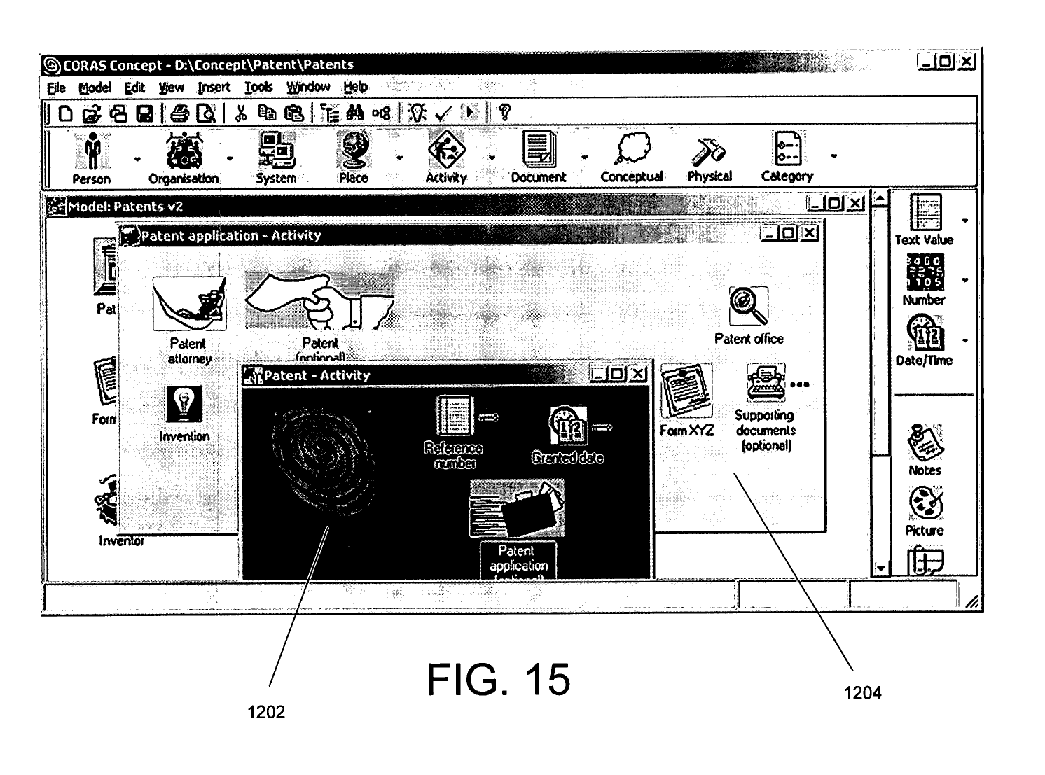

While images, pictures, symbols, and icons may be associated with business concepts, background images may also be provided for a business concept's window according to an illustrative embodiment of the invention. Background images may be displayed each time a business concept's window is viewed, and any components (e.g., business concepts, data items, annotations, help templates, and the like) in the window may appear superimposed against the background. For example, in FIG. 15, a customized background 1202 having a spiral and a blue background is used for the business concept patent. Although in this illustrative example the background is an arbitrary one, it is easy to see how more specific backgrounds images may offer a simple way of providing context for a business concept's definition. This context may be beneficial because it assists in quick recognition and enhanced comprehension of the business concept. For example, the background image for a business concept representing a car loan application may be a scanned image of the loan application form, and the background image for some other business activity may be a depiction of the scene where it takes place. Laypersons such as customers may have an easier time understanding business concepts when appropriate backgrounds are used.

Alternatively, a background for a business concept's window may take the form of a texture or color. Still referring to FIG. 15, the color 1204 yellow has been used for business concept patent application, according to an illustrative embodiment. In this case, the use of contrasting colors may allow a user to easily and quickly differentiate between concept windows. The position and size of each concept window can also be preserved, both during modeling sessions and from one modeling session to the next. This may help the user navigate around large and complex application definitions quickly and easily, by remembering where things were last time (the “visual mnemonic”).

Furthermore, business concepts based on the innate concept activity may be animated according to an illustrative embodiment of the invention. Business concepts of type activity may represent procedures or business processes. An activity may be described as a sequence of steps which together constitute a scene or a situation. As described above, specific business concepts participate in each step of an activity much as the actors in a play obey directions in a script. Thus, according to one aspect of the BCIM, the activity business concept may be enacted using animation techniques, thereby exploiting visual imagery to help create a more understandable application definition.

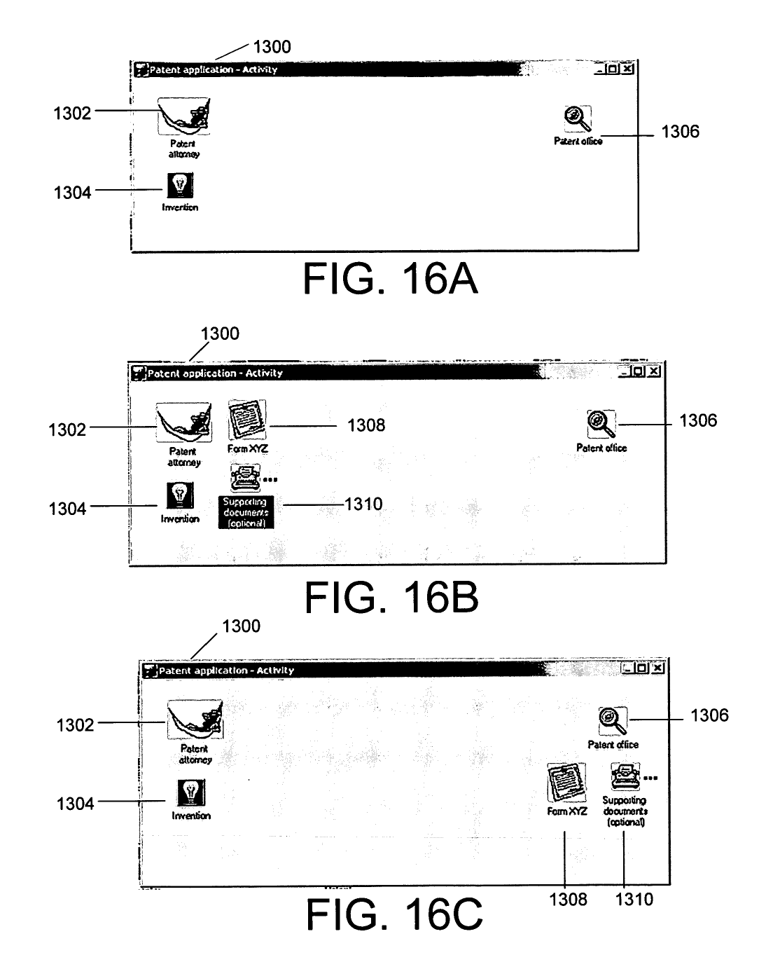

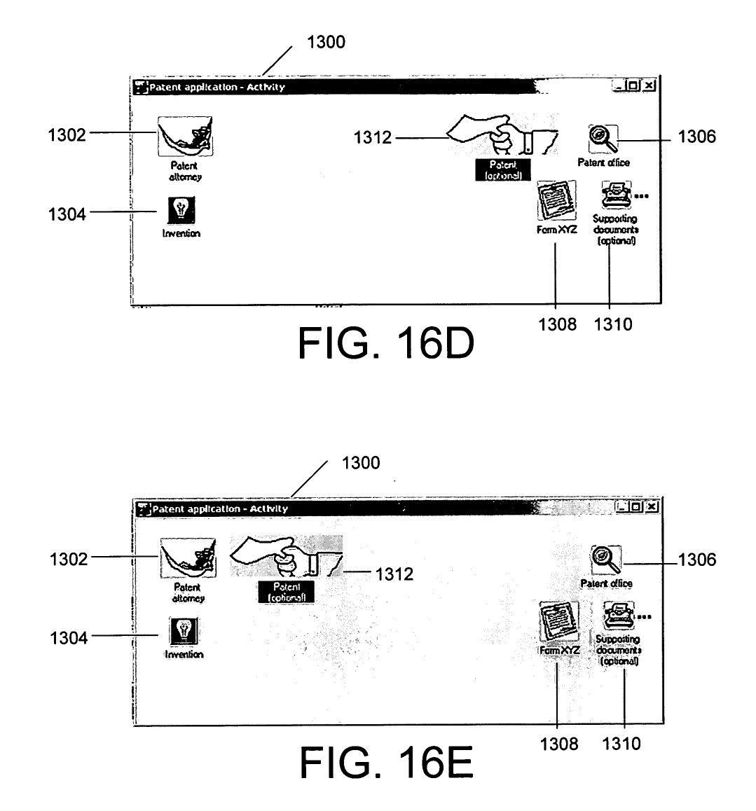

FIGS. 16A-E illustrate a simple animation for the activity business concept named patent application. The starting point in FIG. 16A shows the patent attorney 1302, with an invention 1304 for which a patent is sought. The patent office 1306 is also shown. In FIG. 16B, the patent attorney 1302 prepares a patent application 1308 and the supporting documentation 1310. In FIG. 16C, the patent application 1308 and the supporting documentation 1310 are submitted to the patent office 1306, and the patent application 1308 and supporting documentation 1310 have been animated to move across the window from the patent attorney 1302 to the patent office 1306. In FIG. 16D, the patent office 1306 examines the patent application 1308 and (in this situation) responds by issuing a patent 1312 on the invention 1304. In the final step shown in FIG. 16E, the patent office 1306 sends the patent 1312 to the patent attorney 1302 for forwarding to the client (and the patent 1312 is animated to move across the window from the patent office 1306 to the patent attorney 1302).

The animation may be more sophisticated than the illustrative example shown in FIGS. 16A-E above. One of ordinary skill in the art would understand that more steps can be added, with decision points and alternative scenarios that are animated. One example of an alternative scenario in the above example would be the situation where the patent office responded to the initial application with a request for further information, or refused to allow the patent application by issuing an office action. In such a case, an animation would be included to show the flow of information from the patent office 1306 to the patent attorney 1302.

An aspect of the animation is to help elucidate the detailed structure of an activity, so that the relevant business concepts can be defined more accurately. In some embodiments of the present invention, the animations may be used as a guide merely to assist in the development of the business concepts. However, in other embodiments of the present invention, the animations may be defined rigorously to specify aspects of required application functionality. For example, an application that depends heavily on carefully-controlled workflow may be made to adhere to each step in the animation as a formal state. That is, in the application, certain actions may be taken depending on the states of the business concepts. In the above example shown in FIGS. 16A-E, the business concept patent application 1308 may have certain states, such as:
Patent application not yet prepared
Patent application in the course of being prepared
Patent application prepared
Patent application approved by client
Patent application filed with the patent office
Patent application incomplete
Patent application subject to restriction requirement
Patent application under review by patent office
Patent application approved by patent office
Patent application denied by patent office

These states may be mapped to specific combinations of data item values (e.g., dates, etc.) or other triggers that would be used to control the application logic. In any given state, perhaps only certain actions may be possible and certain states may be the outcome. For example, it would not be possible to send to the Patent Office 1306 a patent application 1308 that was “not yet prepared.” In other states, however, certain actions may be performed automatically by the application in accordance with the work-flow animation. For example, once a patent application 1308 moves to the state “prepared,” the application functionality may automatically prepare a cover letter addressed to a client and including a copy of the patent application 1308 for the client's review. This may be done either by generating a printed copy for mailing or by automatically sending an email addressed to the client with the patent application 1308.

One of ordinary skill in the art would recognize that a variety of animations and associated states are possible. For instance, animations may also include audio-visual animations or simply audio or visual animations separately. In other cases, colors may change to indicate particular states. Furthermore, icons may change to indicate particular states. Many other variations would be appreciated by one of ordinary skill in the art.

IV. Association to Other Business Concepts

According to an embodiment of the present invention, the BCIM assumes that the designer's scenario is a business situation of some form and therefore may use the default set of innate concepts described above. Thus, an application definition in the BCIM may be a collection of related components (business concepts) that represent mental concepts and are arranged to form one or more scenes (activities). Business concepts include a series of associations or links to other business concepts plus other components such as data items and design components. A business concept may lack context except for these associations and its placement within an application definition.

In an embodiment of the BCIM, the user may specify that business concepts are linked. The BCIM may then independently implement the links in the form of associations between generated database tables, objects, windows, fields and other software constructs, so as to achieve the required application functionality. The BCIM makes its own decisions about how to implement the business concepts and relationships in software. Many of these decisions may depend on the target platform for the application functionality. The implemented associations between software components may be generally explicit and well-defined; for example, relationships between database tables may be defined explicitly as constraints and therefore enforce strong referential integrity. This may provide a number of benefits. For example, data manipulation functions requiring well-formed associations may work well; this is why built-in Microsoft Access wizards work exceptionally well on Microsoft Access databases produced by the BCIM.

According to another aspect of the invention, the BCIM has the ability to deduce relationships and associations between or among business concepts, thus reducing the need of a designer to specify these relationships and associations. The deductive modeling aspects of the BCIM will now be described in further detail.

If a user places one business concept (or a data item) in another business concept's window, then the BCIM may denote this as a contains relationship (e.g., one business concept contains another business concept). The “contains” relationship identifies the constituent concepts of the business concept. For example, in a business concept representing a car, the constituent concepts might represent wheels (plural), doors (plural), an engine (singular), and so on. Although this example illustrates the physical inclusion of automotive components (e.g., wheels, doors, engine, and the like) in a car, conceptual inclusion is also possible. For instance, the business concept car might include the business concept manufacturer even though the cars (i.e., vehicles) do not actually contain car manufacturers (i.e., manufacturing companies) in reality.

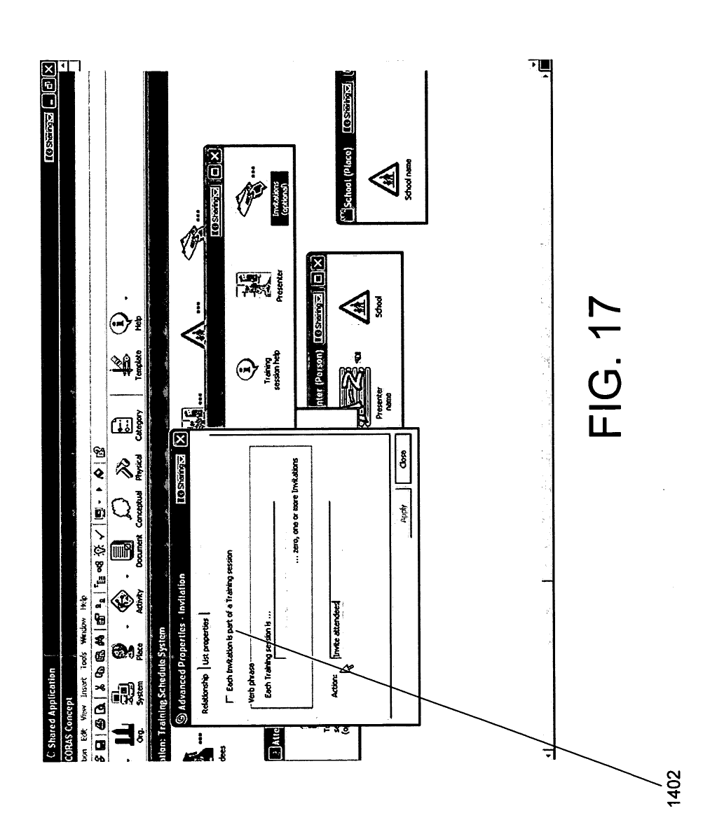

Any contains relationship may optionally be designated as apart relationship, which denotes an assembly-part relationship (similar to aggregation or composition in object-oriented design terminology). For an illustrative example of how the BCIM denotes this part relationship, refer to checkbox 1402 as shown in FIG. 17. This part relationship may be used to help build usable application functionality, when the referent of mental concept is a clearly part of another referent. One example may be the relationship between a business concept order and the order lines that are part of the order. It is clear that the order lines are part of the business concept order in an assembly-part relationship. Similarly, in the example of a business concept representing a car above, the wheels, doors, and engine may be designated as having an assembly-part relationship with a car.

In addition, each business concept may be declared by a user as the same as another business concept. This indicates that the referent of the relevant mental concept is similar or equivalent to the referent of another mental concept. For example, when the business concept contract employee is defined to be the “same as” employee, then one can assume that contract employees are employees. However, this does not mean that the business concept contract employee is identical to the business concept employee, since it may relate to fewer individuals than the business concept employee. That is, the business concept contract employee may be more specific than the business concept employee. In other words, if employee is treated as the set of all employees, then the set contract employee is a subset of employee.

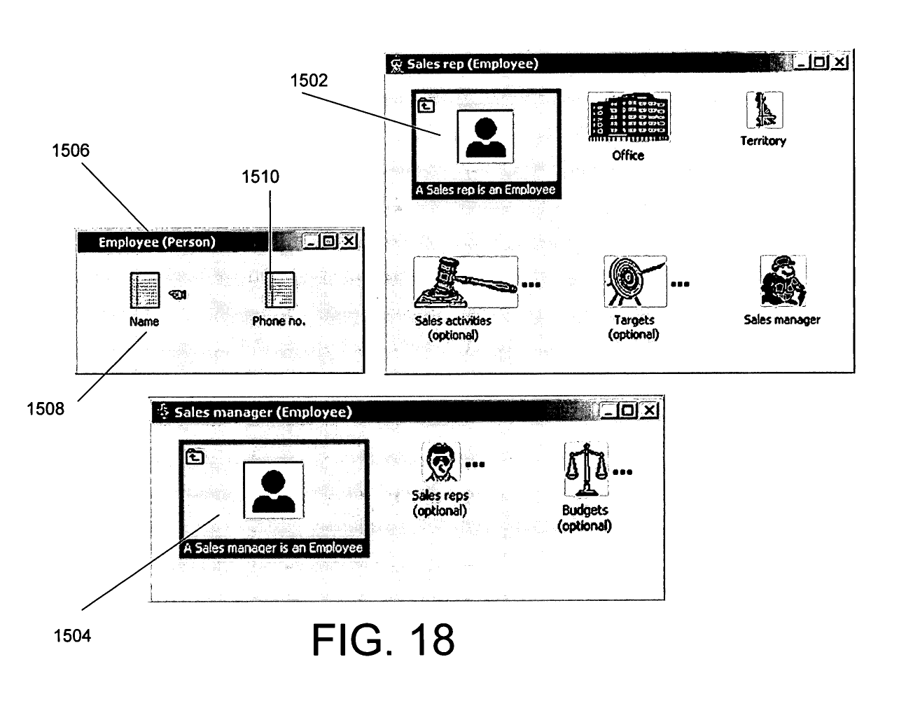

In an embodiment of the BCIM, each “same as” business concept's window may include a prominent indication that the business concept has been defined in terms of another business concept. For example, as indicated in FIG. 18, an icon label 1502 indicates that business concept sales rep is an employee, which is based on innate concept person, and an icon label 1504 indicates that business concept sales manager is also an employee. The newly defined business concepts (e.g., sales rep and sales manager), each known as a child business concept, will then assume all properties of the business concept that they are the “same as” (e.g., the parent business concept employee). This kind of relationship may be similar to subtyping, generalization, or inheritance in conventional modeling techniques such as UML.

Other components may be added to a child business concept's window so that it extends the properties inherited from the parent business concept. In the example illustrated in FIG. 18, two business concepts have been made “the same as” the employee business concept: sales rep and sales manager (see icon labels 1502 and 1504). In each case, both the sales rep and sales manager business concepts have additional properties not found in the employee business concept. In particular, the employee business concept contains only data items name 1508 and phone no. 1510. However, the business concept for sales rep additionally contains the business concepts office, territory, sales activities, targets, and sales manager. Similarly, the business concept sales manager additionally contains the business concepts sales reps and budgets. Note that the business concepts sales rep and sales manager are also related by a distinct association relationship; that is, each sales manager manages zero or more sales reps. This distinct association relationship may be entirely independent of the “same as” relationships.

Any “same as” relationship may optionally be designated as an exclusive relationship, which indicates that the roles are mutually exclusive. For example, if the business concepts full-time student and part-time student were the same as a business concept student and also exclusive, then a student could not simultaneously be a full-time and a part-time student. In one embodiment of the BCIM, the default may be to assume that roles are not exclusive, since this may be the most likely scenario.

In providing application functionality, the “same as” relationships defined in the BCIM may be used as follows:
1. If the child business concept has no additional properties, and it cannot exist independently of its context, then it is treated as an alternative name for the parent business concept and no additional system components (database tables, pages, etc.) are generated for the child business concept.
2. In all other cases (e.g., if the child business concept does have additional properties not found in the parent business concept), then it may be implemented via its own system components. The child business concept may be treated as a subset of the parent business concept. Components related to the two concepts are linked in the application.

Another aspect of the differential design by the BCIM is the predictive modeling of business situations based on statistical probability of association between the referents of innate concepts. The decisions made by the BCIM when predictively modeling are based on statistical analysis of many system designs, application definitions and real-world business scenarios.

According to one aspect of the invention, the BCIM may contain default cardinalities between business concepts based on the innate concepts of these business concepts, as shown in the relationships table of Table III. According to one embodiment, when one business concept is placed in the window of another business concept, the BCIM may default a cardinality according to Table III. Because a relationship may be mandatory (“must have”) or optional (“may have”), along with one or many, there are four possibilities as indicated by cardinalities 1-4 in Table III.

TABLE III

| “has” | Person | Organization | System | Place | Activity |
|---|---|---|---|---|---|
| Person | 1 | 2 | 1 | 4 | 1 |
| Organization | 3 | 1 | 4 | 4 | 1 |
| System | 1 | 1 | 1 | 1 | 1 |
| Place | 1 | 1 | 1 | 1 | 1 |
| Activity | 4 | 4 | 4 | 4 | 1 |
| Document | 4 | 4 | 1 | 3 | 1 |
| Conceptual object | 4 | 2 | 1 | 1 | 2 |
| Physical object | 4 | 4 | 4 | 4 | 4 |
| Category | 1 | 1 | 1 | 1 | 1 |

| | | Conceptual | Physical | |
|---|---|---|---|---|
| “has” | Document | object | object | Category |
| Person | 1 | 1 | 1 | 4 |
| Organization | 1 | 3 | 1 | 4 |
| System | 1 | 1 | 1 | 4 |
| Place | 2 | 1 | 1 | 4 |
| Activity | 4 | 3 | 1 | 4 |
| Document | 1 | 1 | 4 | 4 |
| Conceptual object | 4 | 1 | 4 | 4 |
| Physical object | 1 | 1 | 1 | 4 |
| Category | 1 | 1 | 1 | 4 |

| Cardinality | Optional or mandatory | Single or Multiple |
|---|---|---|
| 1 | Mandatory (must) | Single (one) |
| 2 | Mandatory (must) | Multiple (many) |
| 3 | Optional (may) | Single (one) |
| 4 | Optional (may) | Multiple (many) |

So, for example, if a business concept based on the innate concept person were placed inside the window of a business concept based on the innate concept organization, the BCIM may deduce that cardinality number three should apply. In that situation, the BCIM would assume that a person of the given type (first business concept) can be related to zero organizations or one organization of the given type (second business concept). As another example, if the business concept based on the innate concept organization were placed inside the window of a business concept based on the innate concept person, then the BCIM may deduce that cardinality number two should apply. In that case, the BCIM would assume that organizations of the given type (second business concept) can be related to many people of the given type (first business concept). This understanding may be utilized when generating the system components (e.g., database tables, relationships, pages, and the like) in the generated application, in the absence of any specific overriding properties set by the user.

Another example illustrates how the BCIM supports deductions for common scenarios in the form of activities. In a situation where a user wishes to define a business concept such as a sale, which is based on the innate concept activity, the user may add an additional business concept to sale, such as customer (based on innate concept person) to represent the customers involved in sales. In addition to knowing that the business concept for sale contains the business concept customer, the BCIM may automatically deduce that the business concepts sale and customer are related through cardinality number four in Table III. In other words, any specific role in a business activity is usually the responsibility of a single individual and that person can undertake many such activities over time. Thus, the BCIM may implement a many-to-one relationship between components corresponding to the business concepts sale and customer in the generated application. Again, the user may override this deduction made by the BCIM if it is inaccurate.

The ability of the BCIM to predictively model and deduce relationships may have several beneficial effects.
a. The amount of effort required in defining applications is reduced, since fewer details must be specified explicitly.
b. Consequently, applications can be built more quickly and therefore more cheaply.
c. Quicker modification is possible, since elements that are not explicitly specified do not need to be “unspecified” when changes are being made.
d. The likelihood may be increased that correct structures will be created by less experienced designers, since the structures applied by default are statistically more likely to be correct than other possible structures.
e. Business concepts are more reusable, since they contain fewer explicit links to other concepts.
f. This also means that it becomes possible to consider defining and building applications “on the fly” in JAD (joint applications design) sessions or other similar group-based workshops.

The business concepts in a BCIM application definition do not necessarily correspond to one or any number of system objects or components that may be found in software to provide resulting application functionality. Further, the cardinalities discussed above do not necessarily translate directly to relationships between particular system objects or components derived from business concepts. Instead, the BCIM makes independent decisions regarding how to implement application functionality matching the business concepts within the context of a given software environment. These decisions may take into account many factors, such as the target platform(s), and may change depending on these factors.

The BCIM is not limited to any particular application platform embodiment. It can implement the business concepts in the application definition for a variety of application platforms such as Microsoft Windows, Unix, Linux, OS/2, Java/J2EE, Microsoft ASP and NET, HTML, JavaScript, CGI/Perl, ANSI SQL, Visual Basic, C, C++, J++, C#, Microsoft Access, Oracle, Microsoft SQL Server, DB/2, MySQL, Postgres, non-relational data storage mechanisms such as XML, Lotus Notes, spreadsheets and “flat” files. This platform independence makes the BCIM especially user-friendly, since it does not require that the user have technical knowledge of particular platforms, or indeed of any programming languages or system design concepts.

Further, application maintenance includes revisions to business concepts, but does not result in the user having to meticulously alter existing application structures. This radically reduces the amount of effort required for system maintenance. In contrast, to implement the equivalent of a new or modified business concept using traditional development methods and technologies typically requires many changes at a detailed level to multiple system components, including database tables, relationships, indexes, sequences, HTML pages, scripts, program code, XML configuration files, graphics, styles, software class definitions, and/or stored procedures. The designer needs an intricate understanding of the particular format and programming languages of those components in order to modify them and to maintain the current functionality and database integrity. In the case of contemporary web applications, this is a major issue because of the sheer number of technologies that must be mastered simply to build and maintain a single software application, and the number of distinct points of failure where incorrect modification can cause an application to fail.

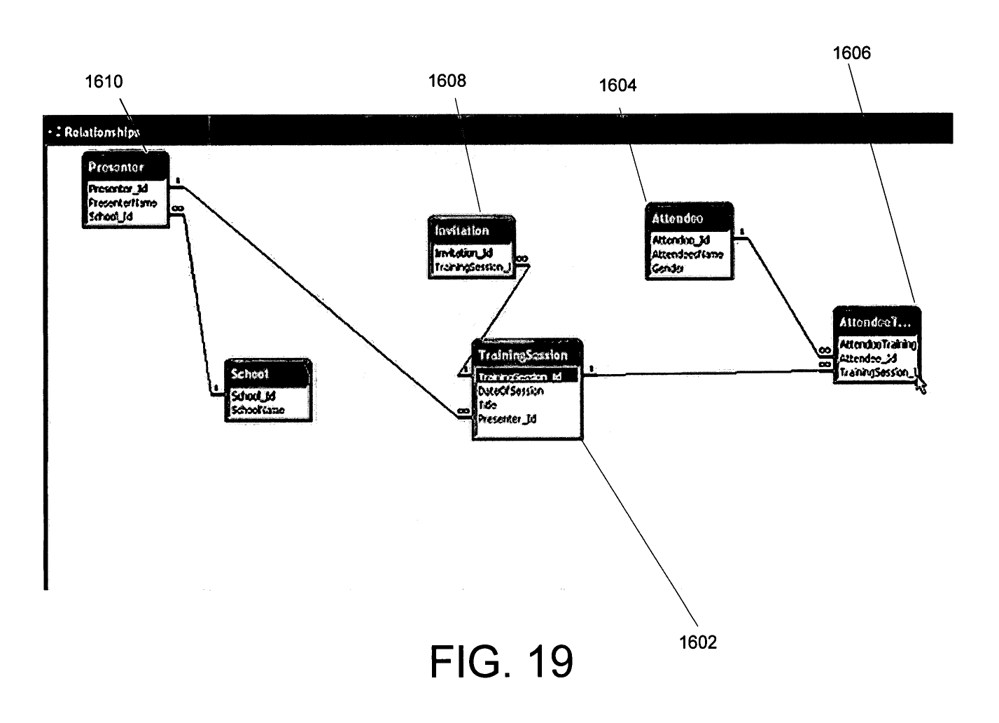

As an example, consider FIG. 19, in which the BCIM has created an application fragment in Microsoft Access and implemented certain database relationships including a many-to-many relationship between the TrainingSession table 1602 and the Attendee table 1604. This many-to-many relationship utilizes an AttendeeTrainingSession table 1606 to join the TrainingSession table 1602 to the Attendee table 1604. Specifically, both TrainingSession 1602 and Attendee 1604 tables are related to AttendeeTrainingSession table 1606 in a one-to-many relationship, thereby effectively creating a many-to-many relationship between the TrainingSession table 1602 and the Attendee table 1604.

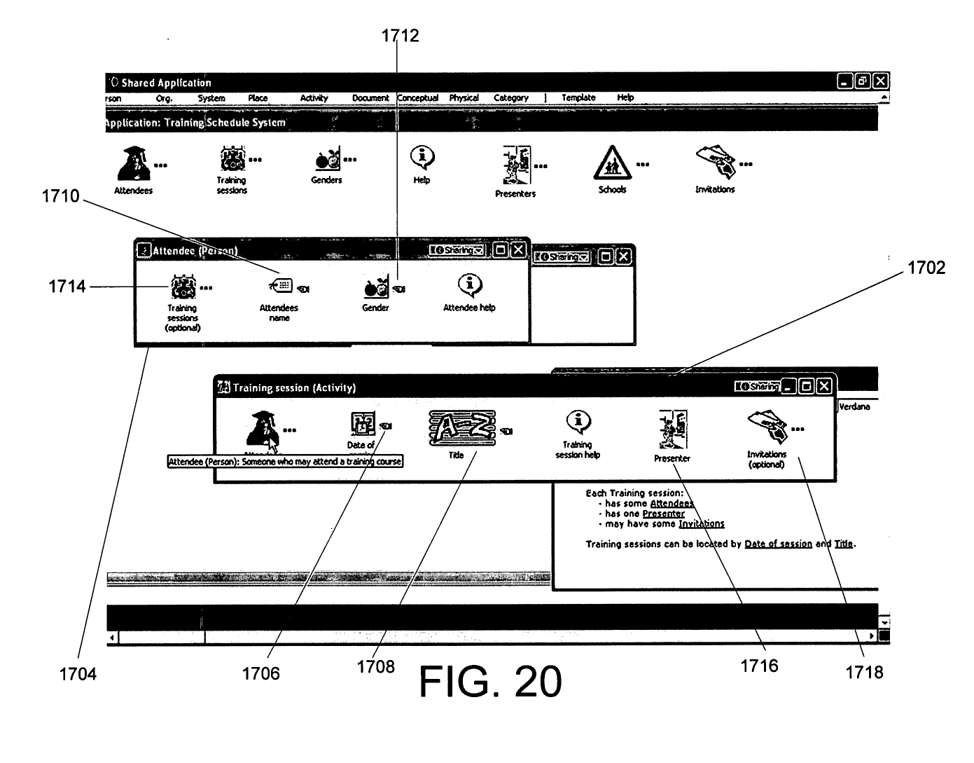

Now refer to the underlying business concepts in the application definition shown in FIG. 20 that was used by the BCIM to implement the relationships described in FIG. 19. In FIG. 20, there are business concepts training activity 1702 and attendee 1704. Business concept training activity 1702 includes a locator consisting of date of session 1706 and title 1708. Business concept attendee 1704 includes a locator consisting of attendee name 1710 and gender 1712. To be sure, date of session 1706 and title 1708, which are part of the locator for the business concept activity 1702, are not primary keys (nor secondary keys) and attendee name 1710 and gender 1712, which are part of the locator for the business concept attendee 1704, are not primary keys (nor secondary keys). Instead, in FIG. 19, the primary key for the TrainingSession table 1602 is TrainingSession_Id and the primary key for the Attendee table 1604 is Attendee_Id, both of which are independent of the locators specified in the application definition. Accordingly, the locator(s) for each business concept in the BCIM are independent of any primary keys (and secondary keys) in the implemented tables in a database.

In addition, while FIG. 19 includes a table AttendeeTrainingSession 1606, no such corresponding business concept is shown in FIG. 20. Furthermore, in FIG. 20, the definition for the business concept training session 1702 additionally contains the business concepts presenter 1716 and invitation 1718 while the definition for attendee 1704 additionally contains the business concept training session 1714. Referring to FIG. 19, the TrainingSession table 1602 does not directly contain information regarding the presenter and invitations, but instead utilizes many-to-one and one-to-many relationships to link to the Presenter table 1610 and Invitation table 1608, respectively.

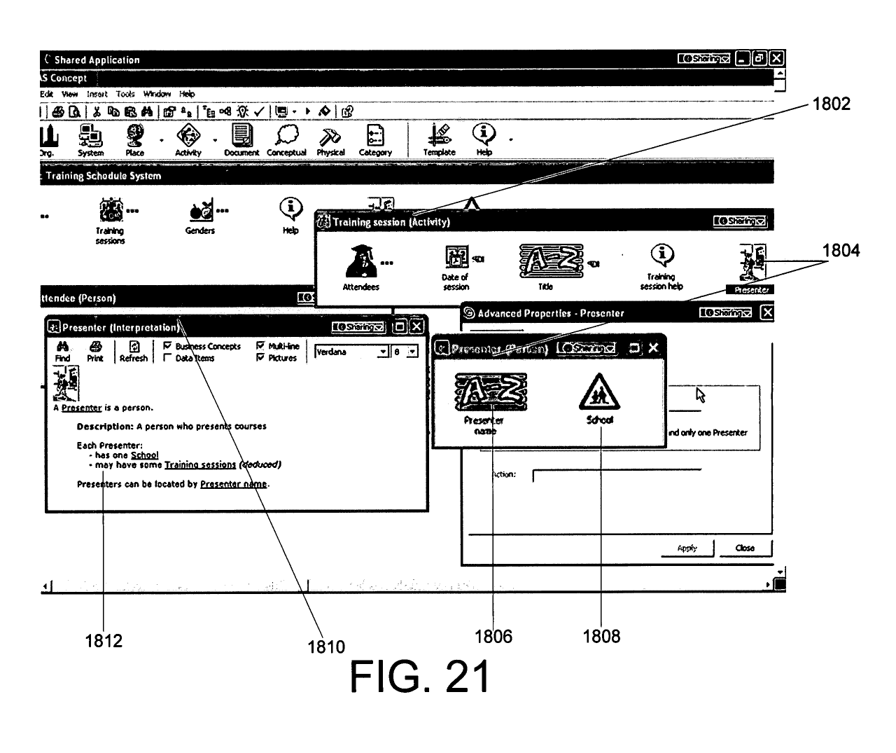

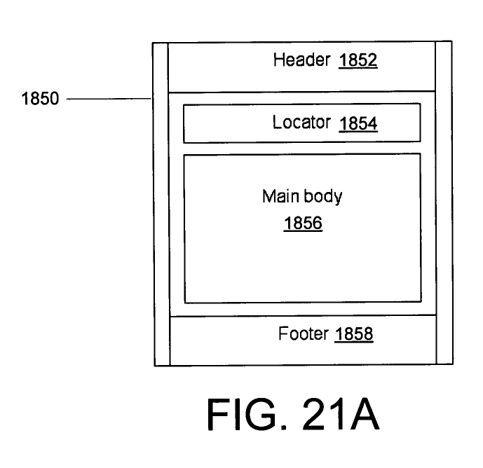

As an further example, in FIG. 21, the business concept training session 1802, which is based on innate concept activity, has been defined to contain, among other things, the business concept presenter 1804, which is based on the innate concept person. The business concept presenter 1804 has been explicitly defined to include only the data items presenter name 1806 and school 1808, and not to explicitly include the business concept training session 1802. However, when viewing the interpretation in the presenter interpretation window 1810, there is an indication 1812 that the BCIM has deduced that each presenter may have some training sessions. This corresponds to cardinality number four in Table III, which is deduced because the business concept presenter 1804 has been placed inside the window of the business concept training session 1802. Cardinality number four indicates that a training session may be carried out by a single presenter, and a presenter can undertake many such training sessions over time. Therefore, indicator 1812 follows from this interpretation of cardinality number four when it states that each presenter may (optional) have some training sessions (multiple). While the BCIM has deduced a relationship between the business concepts presenter 1804 and training session 1802, the BCIM has not included an explicit indication in the presenter 1804 window of the training session 1802. This reduces the complexity of the visual definitions that the user must work with, and also allows deductions to be overridden by the user with minimal effort and change to the definition.

While the information in Table III has been determined statistically based on a particular sample of application areas, one of ordinary skill in the art would appreciate that there are alternative ways to structure and determine cardinalities. For example, one or more of the following could be used to generate an alternate version of Table III:
a. A different sampling of application structures could be used, thereby resulting in a statistically different set of cardinalities. For example, different tables of cardinalities could be available for use in different industries, reflecting the common relationships in each business domain.
b. A BCIM tool may learn by experience. That is to say, if two concept types are frequently related in a particular way, the tool would learn to relate them that way in the future. This would lend itself to the use of neural networks, for example, to identify and react to these relationship patterns.
c. The table of default cardinalities could be extended to n dimensions, allowing more factors to be taken into account than the two innate concepts directly involved in the relationship. For example, the table could also take into account context—the types of concepts that are nearest (in logical or physical terms) to the two involved in the relationship.
d. If different and extended lists of innate concepts were available for use in different industries, as outlined earlier, each could have their own table of default cardinalities. For example, in a scientific laboratory setting the “person” and “organization” business concept types might be less useful, but the “physical object” and “conceptual object” business concept types could be specialized to produce a longer and more useful list of innate types with associated default cardinalities.

In one embodiment of the BCIM, default cardinalities may be used when business concepts are first created and related to other concepts. They can then be overridden as required. In addition, any cardinality not explicitly stated may be deduced using the same rules when the application is interpreted (e.g., when the natural-language interpretation or object class diagram are viewed and when applications are built for particular platforms).

Other rules may be applied to deduce and default various other aspects of an application definition. These are discussed below.

Deduction of page layout in generated user interface. User interface forms (pages) produced by a BCIM typically have a standardized layout containing several blocks as shown below. A simplified example of a layout 1850 is illustrated in FIG. 21A. The header 1852 and footer 1858 blocks may contain links and may be common to many pages. The other blocks may vary according to the purpose of the page. In the example shown in FIG. 21A, the block 1854 labeled “Locator” may contain locator fields and useful links. The block 1856 labeled “Main body” contains a variety of things depending on the purpose of the page. For example, on a page that shows a single record, the “main body” area may display a number of “tabs.” Tabs are a structuring device, analogous to the tabs used in card indexes or folders, which are commonly used in software user interface design to reduce the amount of information being presented to a user whilst allowing easy navigation to linked information. The BCIM may automatically creates tabs for use in generated user interfaces. Each single view page may have a “Details” tab containing non-locator fields, many-to-many relationships, and links to associated items. In addition, the BCIM may creates a tab for each part relationship as described below and for each “strongly-related” business concept (based on affinity). These types of relationship are discussed below.

Deduction of part relationships (aggregation). The BCIM may deduces part relationships based on the innate types being used. As an example, Table IV illustrates a sample table for the part-of attribute that may be utilized according to an embodiment of the BCIM:

TABLE IV

| | | | | | | | Conceptual | Physical | |
|---|---|---|---|---|---|---|---|---|---|
| “is part of” | Person | Organization | System | Place | Activity | Document | object | object | Category |
| Person | False | True | False | False | False | False | False | False | False |
| Organization | False | True | False | True | False | False | False | False | False |
| System | False | True | True | True | True | True | False | True | False |
| Place | False | True | True | True | True | False | False | True | False |
| Activity | False | True | True | True | True | False | False | False | False |
| Document | False | True | True | False | True | True | False | True | False |
| Conceptual object | True | True | True | True | True | True | True | True | False |
| Physical object | False | True | True | True | True | False | False | True | False |
| Category | False | True | True | False | True | True | True | True | True |

According to Table IV, a person is most typically not part of another person (False) but, if related to an organization, is typically part of that organization (True). As another example, an activity is not typically viewed as part of a document (False) but, if related to an activity, is typically part of that activity (True). As outlined above, for deduction of cardinality, the part relationship can be deduced when an business concept is being assembled, interpreted, and the like, and can be subsequently overridden by the user as required.

Note that the “part” relationship may typically be exclusive; in other words, any given business concept will have a mandatory part relationship with at most one other business concept. Accordingly, the BCIM will by default select at most one relationship to make “part” for each business concept. Further, in a one-to-many relationship, the “many” end will typically be part of the “one” end rather than vice versa, for the same reason. As an example, consider a situation where a customer places orders for multiple products. Each order has several order lines, each of which specifies an individual product. Because of its mandatory relationships with the order and product concepts, the order line concept could be construed as part of either order or product. The BCIM will choose between these alternatives by consulting rules such as those in Table IV and will choose to make order line part of order.

Notwithstanding the above discussion, the BCIM may support multiple mandatory part relationships. Although this may be counter-intuitive, it allows for the common, rather loose, interpretation of the meaning of “inclusion.” It may be possible to model a given business concept as a mandatory part of more than one business concept if this is the intended meaning.

Deduction of affinity between concepts. The degree of closeness with which two concepts are related may be used by the BCIM to default several aspects of an application definition. For example, the physical grouping of business concepts within a business concept (e.g., placement of icons in windows) may be used as a guide to determine the placement of elements within generated user interfaces. Concepts that are physically close together in the application definition may be close together in the generated user interface. Concepts that are nested (item groups) may be grouped in the user interface, perhaps with white space or borders to suggest their differentiation from surrounding items.

The logical distance between two concepts may also be useful. Any two business concepts in an application definition may be related directly (e.g., explicitly) or indirectly (e.g., implicitly). The number of hops that must be traversed between two business concepts may be an indicator of how related they are in logical terms. So, for example, the BCIM can use this information to structure menus and site maps. Items that are closely related (e.g., in the logical sense) may appear grouped together. Items that are unrelated or only distantly related may appear further apart. This may provide a form of “chunking” in generated user interfaces which greatly aids comprehension and increases usability. It is similar to the idea of partitioning a corporate schema into subject areas or sub-schemas. In traditional development methods this is normally a job for a skilled information system architect and requires significant expertise. However, it may be done automatically by a BCIM, which means that no such expertise is required. This method of grouping may be distinct from the inherent grouping of concepts according to their underlying innate concept. These two distinct grouping methods allow two different routes to any given data item or function in the application. Users may choose their preferred approach.

Another difference from conventional practice is that the automatic partitioning afforded by analysis of affinity applies at multiple levels. Instead of splitting an application into a single group of sub-applications, BCIM may split the business concepts into a hierarchy of nested groups, from lowest to highest levels. This may be analogous to, for example, the way one might think about an individual's contact details. At the highest level, we can consider the business concept contact details as a single concept. Closer examination reveals that the business concept breaks down into further business concepts and/or data items: address, phone number, email and so on. Each of these items, in turn, breaks down into sub-items. For example, the business concept phone number can be broken down into several components: international dialing code, area code, local number, extension, and the like.

Deduction of user roles and security permissions. The “current user” of an application may be denoted by the login account business concept. If present, this concept may be linked to other security-related business concepts. However, it may also be linked to one or more business concepts representing application users who can have login accounts. For example, in the application definition for a medical records application, the login account business concept may be linked to a doctor business concept (based on innate concept person). A BCIM may understand from this association that doctors will have login accounts and therefore should (by default) be able to log into the application. This means that the BCIM may deduce the need for a doctor user role, in order to control the security access permissions for doctors. Similarly, any other person or organization concept linked to login account (directly or indirectly) may result in a deduced user role. The BCIM may also create other standard user roles including public (public user), registered user (generic or “base” logged-in user), admin (system administrator) and developer (system developer). The BCIM may then create default permissions for the user roles. These permissions include the following:
a. The public role may give access only to public resources (e.g., login page). By default, there may be no public tables or reports, but an empty group may be created to contain any that are added later.
b. The registered user role may give access to secure pages (e.g., site map, report list, and the like) and tables (by default, any tables) excluding those with restricted access.
c. The admin role may give access to administration (e.g., security) tables and pages.
d. The developer role gives access to developer-only tables and pages (e.g. system configuration).
e. Deduced roles may be given access to their linked data in a restricted mode. For example, in the medical records example, the role doctor may receive access to patient records, but each doctor may be allowed access only to their own patients. This is termed “own” access and is more fully discussed below.

To create these permissions, the BCIM may set up suitable resource groups that contain the relevant resources. For example, in the above example a resource group called “Doctor tables” may be created. This may contain database tables that doctors have access to. This kind of deduction involving login accounts typically takes place only for those linked business concepts which are based on the innate concepts person and organization, since these are the most likely to actively log into an application. However, this can also be extended to other innate concepts. For example, in the case where an external system can automatically connect to an application (e.g., using Web services) the external system may need security permissions of its own.

As mentioned above, a BCIM may deduce the need for security permissions that restrict data access based on ownership of data (e.g., a sales person “owns” sales that they have made, and consequently an application might show each sales person only their own sales). This security setting may be deduced by tracing associations between business concepts. In the medical records example, the doctor business concept might be linked to a patient concept (e.g., each doctor has zero or more patients). This association might signify the relationship between a doctor and the patients that he/she treats. Since doctors may be able to log into the application, a BCIM could deduce from this that the doctors' access to patient records needs to be restricted so that they can see and modify only the records for their own patients (i.e., patients they are linked to).

Thus, an aspect of deducing “own” access may involve two steps: (a) identifying candidate user roles by examining the business concepts linked to the login account concept, and (b) restricting access to each of these roles based on the business concepts that can be linked to the roles' corresponding business concepts. The above discussion has focused for clarity on direct links (e.g., the link between the doctor and patient business concepts) but it may be possible to deduce indirect links by traversing multiple relationships. So, a BCIM may be capable of applying similar reasoning as described above to deduce user roles and security permissions even when the connection between the relevant business concepts may be indirect.

To illustrate the use of indirect relationships in deducing “own” access, consider an example of a software application for use in educational administration, which keeps track of teachers, courses and students. Each teacher may teach one or more courses, each of which may be attended by many students. Students can choose which courses they take and so each teacher may or may not give a course that is attended by any given student. The corresponding application definition might include the following associations:
a. login account (1 only) to teacher (O or 1)
b. teacher (1 only) to course (O or more)
c. course (O or more) to student (O or more)

A BCIM may deduce the implicit association between teacher and student as equivalent to a direct many-to-many relationship. Based on this, a BCIM would then be able to default security permissions for teachers such that they can see and modify records only for students and courses that they teach.

In cases where multiple routes are available between the same business concepts, a BCIM may decide which path to use by applying a configurable algorithm that can take into account, for example, the type of the association (e.g., preferring part relationships over other relationships), the cardinality (e.g., preferring one-to-one over one-to-many, and one-to-many over many-to-many), and the length of the route (e.g., minimizing the number of associations traversed).

There may be a number of cases where the deduced permissions differ from those outlined above. In particular, the user role types “administrator” and “developer” may be treated as special cases. By default, any roles of these types are not subject to the restricted security (“own” access) but instead can see all data for a given resource, if they have access to it at all. Users with “administrator” user roles generally receive access to all system resources with the exception of those essential for proper functioning of the application, which may be restricted to users whose have a user role of type “developer.” These defaults can, of course, be overridden at run time by someone with a user role that allows them to alter security permissions.

Deduction of user interface content. A BCIM may deduce which items to include in user interface views. This may be controlled by a set of attributes which state whether any given item should be visible or hidden in any given view (e.g., list view, single view, batch edit view, and the like). The rules for one embodiment of the BCIM are shown in Table V below. The user may be free to modify the default settings as required.

TABLE V

| | | Mandatory | Optional | | |
|---|---|---|---|---|---|
| | | fields | fields | Multi-value | |
| | | (including | (including | fields | |
| | Locator | single-row | single-row | (many-to-many | Multi-row |
| View | fields | links) | links) | relationships) | links |
| Single- | Yes | Yes | Yes | Yes | Appear as |
| row view | | | | | tabs or |
| | | | | | links |
| Single- | Yes | Yes | Yes | Yes | Appear as |
| row new | | | | | tabs or |
| | | | | | links |
| Single- | Yes | Yes | Yes | Yes | Appear as |
| row edit | | | | | tabs or |
| | | | | | links |
| List view | Yes | Yes | No | Appear | Appear as |
| | | | | as links | links |
| List new | Yes | Yes | Yes | No | No |
| List edit | Yes | Yes | Yes | No | No |
| Advanced | Yes | Yes | Yes | No | No |
| search | | | | | |
| Crosstab | Yes | No | No | No | No |
| Picklist | Yes | No | Yes | No | No |

One of ordinary skill in the art would readily recognize that the deductions and defaults specified above are examples only, and could be modified according to a variety of contexts. These deductions may be tailored depending on the context in which the BCIM is used.

V. Application Definition Properties

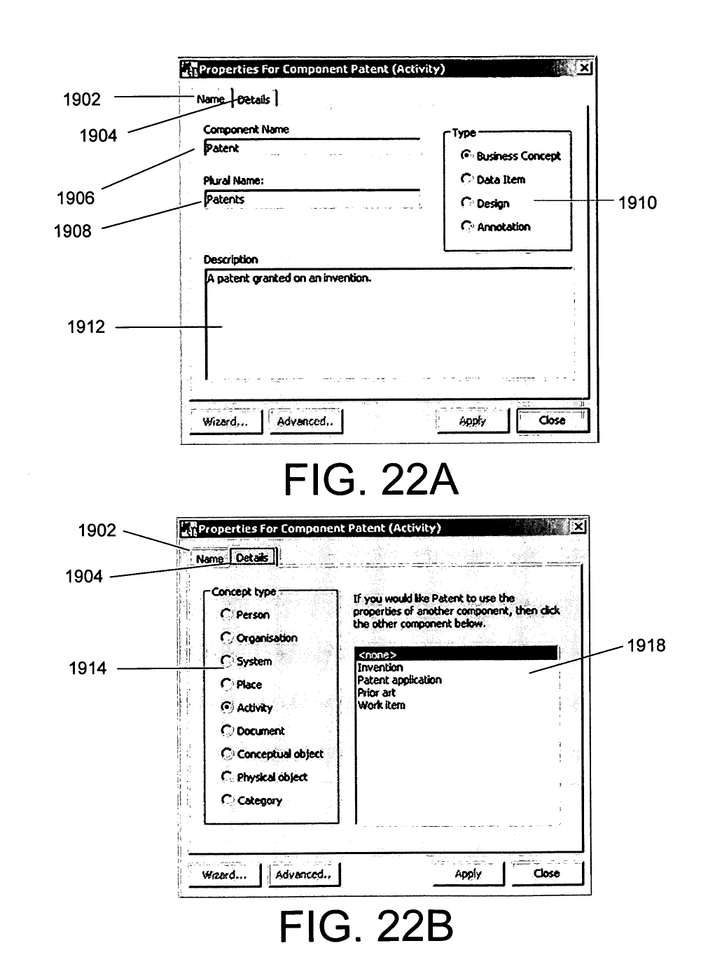

Each concept in an application definition, including business concepts, may have certain properties that can be modified. As illustrated by the Name tab 1902 in FIG. 22A, a user can modify the name 1906, plural name 1908, type 1910, and description 1912. With respect to the type 1910, a user can designate a component as a business concept, a data item, a design, or annotation. If the user designates a component as a business concept, then the Details tab 1904 contains the following options as illustrated in FIG. 22B. Referring to FIG. 22B, a user can select the appropriate innate concept 1914, which includes person, organization, system, place, activity, document, conceptual object, physical object, and category. A user can also designate that the business concept is the same as another business concept (1918).

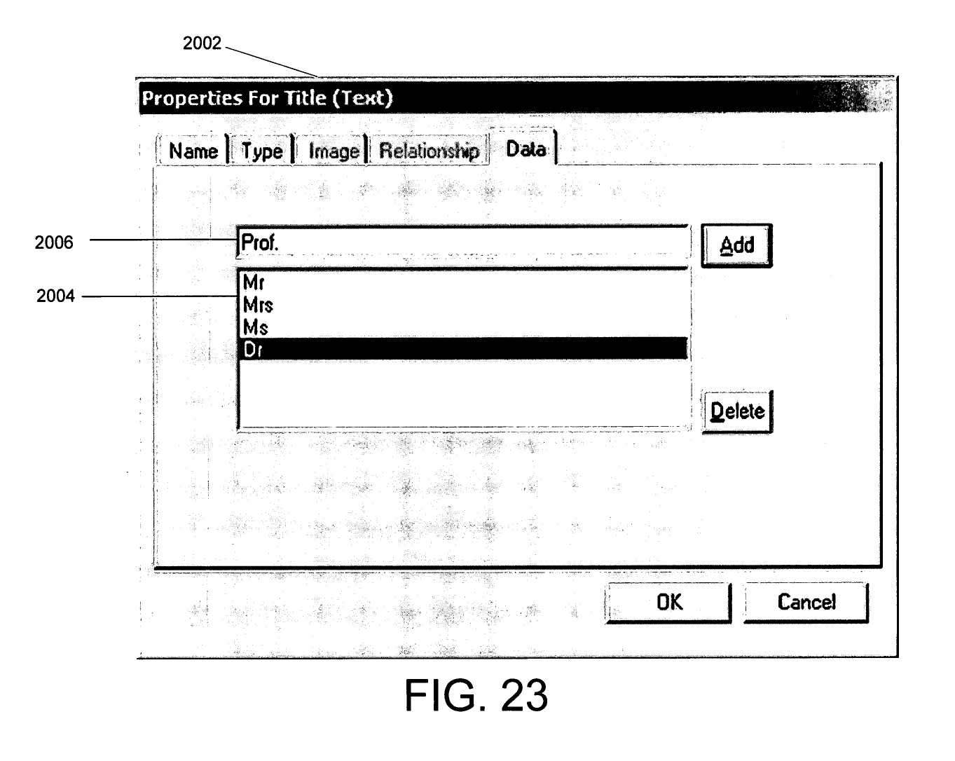

Further, a list of valid values can be specified for any data item. In resulting application functionality, the value of the data item may be constrained to the values in the list. The list may be modified by altering the underlying application code or by changing the application definition and recreating the application. FIG. 23 illustrates the properties for the title 2002, which is a data item of type text. As shown in FIG. 23, title 2002 contains a list of salutation values 2004, such as Mr, Mrs, Ms, and Dr. If desired, a user could add an additional salutation value 2006, such as Prof. Thus, in the generated application, title 2002 may be constrained to the current salutation values 2004.

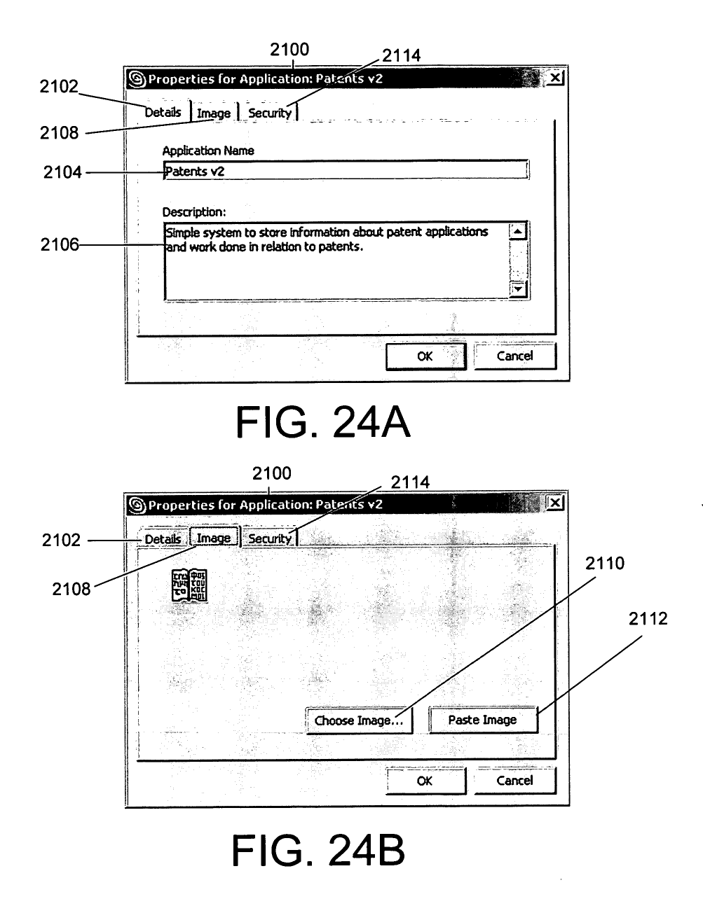

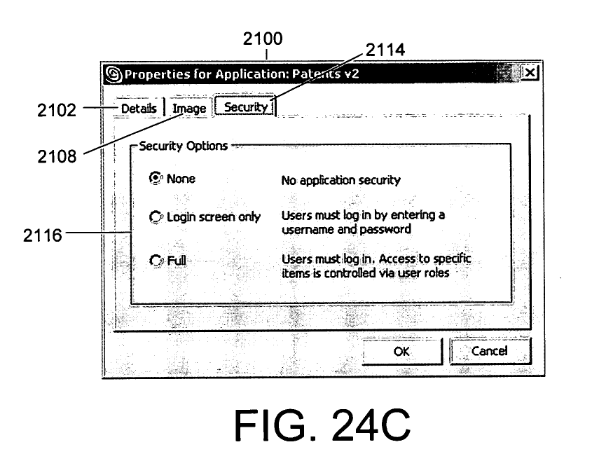

Properties are set for the generated application as a whole in a similar way to properties for business concept. Referring to FIG. 24A, in the details tab 2102, a user may set the name 2104 and description 2106 for the application 2100. In the images tab 2108 of FIG. 24B, the user may choose an image (2110) or paste an image (2112). The selected image will then be associated with the application definition 2100, and will be used throughout resulting application functionality. A use of this feature may be to paste in a company logo so that it will appear in resulting application functionality.

In the security tab 2114 of FIG. 24C, the user may choose a security level 2116 for the generated application. If the user chooses the “Login security” option, the resulting application functionality will allow users to log in but will not otherwise distinguish between users with regard to permissions (i.e., user roles will not be used). For the “Full” security option, a BCIM may allow user groups and their capabilities to be included in resulting application functionality. In one embodiment of the BCIM, this may be enabled using a data structure containing user roles, system resources, system actions and system permissions, which will now be described.

Each user role may be allocated a number of permissions that allow users with the specified role to perform a given action on a specified (e.g., named) group of system resources. System resources may include named pages, tables, functions, and reports. Available actions may include create, read, update, delete, download (document), download (export data), search, advanced search, global search, upload (document) and upload (import data). The lists of system actions, system resources, system resource groups, user roles, and permissions are extensible by the user (with the appropriate permissions of course). Each permission stipulates whether it applies to single-row actions, multi-row actions, or perhaps both. The access level granted by each permission may be full or restricted (which may be equivalent to “own” access as mentioned previously). When an application is built, a BCIM may set up a suitable default set of permissions, user roles, resource groups, and the like. The resulting application may then (a) allow users to login, thereby identifying themselves to the application, and (b) depending on users' security permissions, allow them to carry out specified actions on the application's tables, forms and reports. The allocation of data access privileges may be done in the application rather than at design time. This means that it can be modified swiftly and does not require the services of a database administrator. It is applied in real time while the application executes.

Based on the data access privileges, the application's user interface may be structured at run time appropriately for each user. For example, when users access BCIM applications, they may be automatically offered certain data and functions depending on their roles. This may mean that different users see different application structures. For example, buttons, links, and menu items may be shown to some users but not shown to others, if the corresponding navigation paths are not available to those users. Tabs on forms may similarly be shown or hidden appropriately. Switchboard items may also be present or absent depending on whether the user is entitled to access the relevant forms.

In this way, data access privileges may be used to craft a single application that appears to different user groups as a series of different applications. For example, in the case of an existing database application for an educational institution, the following distinct pseudo-applications are produced at run time from a single BCIM application:
Exam Results Entry System
Expense claims System
External Examiners System
Quality Assurance System
Internal Administrative Intranet System

Customizations may be added to complete the illusion of interacting with separate applications: each of the above systems may be given its own home page, with specialized menus, graphics and links, and each system may have its own color scheme and standard page layout defined using style sheets.

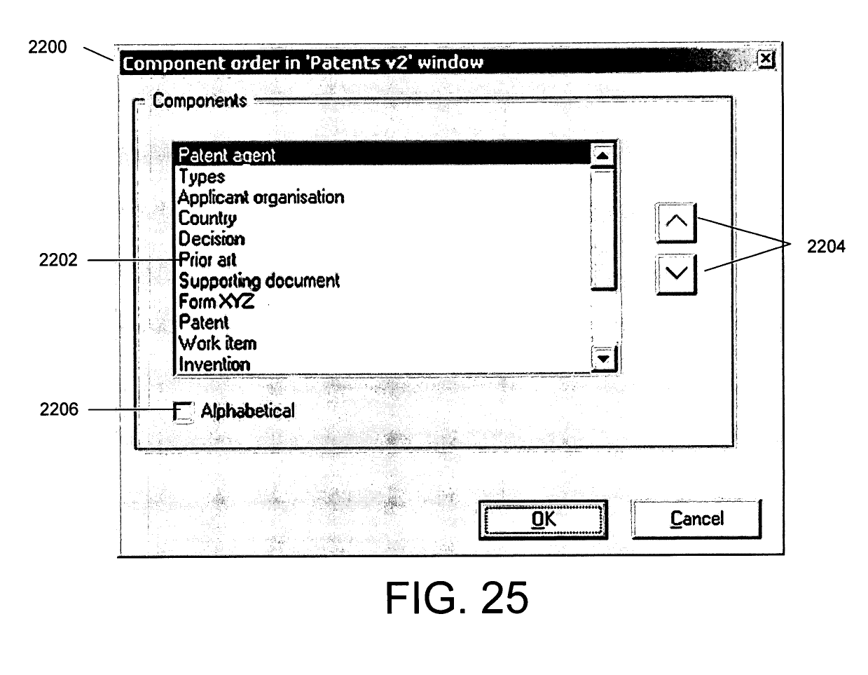

Using a BCIM it is possible to specify the preferred order of business concepts in an application definition that may be used in providing application functionality. The specified order will be used whenever business concepts are listed in the user interface of resulting application functionality. The user may also specify an order for each business concept's sub-components, including deduced subcomponents that do not appear explicitly in the business concept. This ordering may then be applied by a BCIM to menus, list boxes, the application switchboard, home page, or main menu in resulting application functionality. This ordering is used to govern the layout of fields on forms, tabs, and the like in resulting application functionality. FIG. 25 shows an illustrative ordering window 2200 that can be used to order the components 2202, including the business concepts Patent agent, Applicant Organization, and Patent. The arrows 2204 may be used to alter each component 2202's position on the list. In addition there is an alphabetical option 2206 to place the components 2202 in alphabetical order. In another embodiment of the present invention, the order of concepts can be specified simply by dragging and dropping.

VI. Application Definition Views

According to another aspect of the present invention, a BCIM allows the contents of an application definition to be viewed and modified in different formats or views. Illustrative views in a BCIM may include the default view (windows and icons), the interpretation view (natural language), explorer view (hierarchical navigation), object model view (class structure), and three dimensional (3-D) navigator view. Each of these views may be one or more of the following:
1. Dynamically refreshed to show the current concept's definition.
2. Searchable
3. Customizable
4. Capable of navigating and modifying the entire application definition

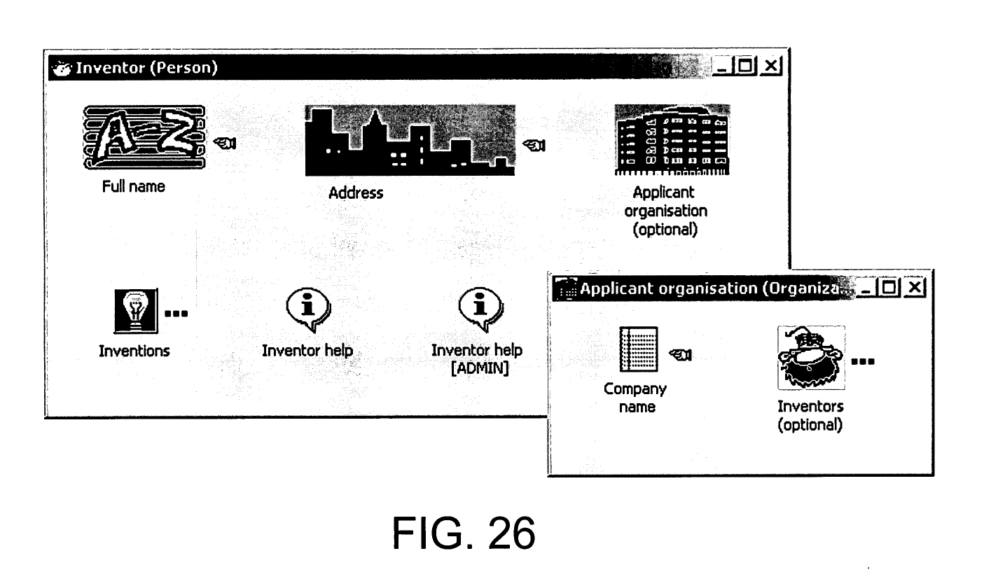

In other words, the views may be alternative and equivalent ways of creating, viewing and modifying an application definition. In some instances, it may be desirable to provide alternate views so that each different user can use one or more that suit their own cognitive style, background, and level of knowledge. This may be particularly true if a BCIM is incorporated within end-user software such as software applications or operating systems, since users of all types and experience will need to interact with it. In the default view, an example of which is shown in FIG. 26, a familiar window-icon approach is used, since this may be likely to be most readily understandable to most people. This view works well for many users, since many people find it familiar and easy to understand through their prior experience with Microsoft Windows, the Apple Macintosh user interface, and other windowing software. Common actions such as dragging and dropping between windows, cutting and pasting, double-clicking, and the like may have a specific but intuitively understandable meaning in the context of business concepts.

Another view, the hierarchical “concept explorer” allows hierarchical navigation of application definitions. Business concepts and other components may be grouped by type for ease of navigation. The entire contents of application definitions are available in this way without the need to repetitively open windows. Any function that can be performed through the default window-icon view in a BCIM may also be performed through the explorer view. In addition, in the window-icon view, if concepts are removed from windows, then they may no longer appear in any windows and may thus be inaccessible in the default window-icon view. The concept explorer allows these concepts to be located by type if they cannot be located by usage (i.e., if they are not at present used anywhere in the application definition) so that they can be examined, modified, deleted, undeleted, and the like.

Once a business concept is defined, it may go through a lifecycle in which it is modified, added to one or more additional application definitions, removed from one or more application definitions, and possibly deleted altogether. The fact that a business concept definition is no longer in use does not necessarily mean it is no longer required, since it may still be useful in the future. Therefore, according to one embodiment, a BCIM may not automatically delete business concepts and their definitions even when they are no longer used. The concept may not be removed from the application definition unless it is marked as deleted. Even in this situation the deleted concept may still be undeleted while the file containing the application definition is still open. Deleted concepts are irrevocably removed only when the file containing the application definition is closed. This gives the user several chances to avoid deleting needed concepts by accident, and promotes reuse.

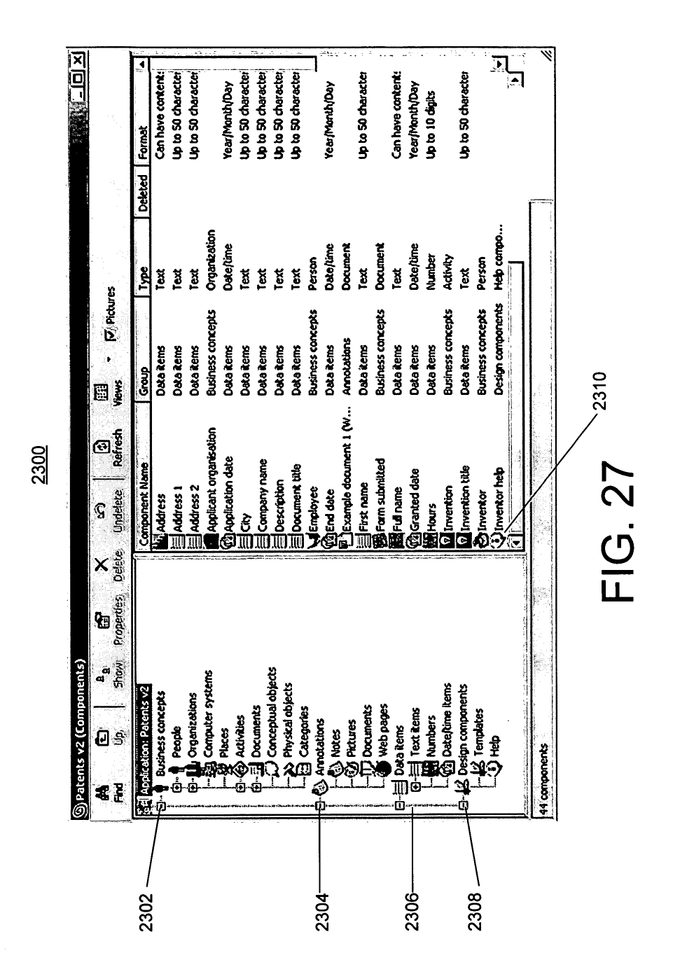

FIG. 27 shows an example of a concept explorer window 2300. The components in the concept explorer window are grouped by types of business concepts 2302, annotations 2304, data items 2306, and design components 2308. In addition, for each component, the associated icon image 2310 is also displayed.

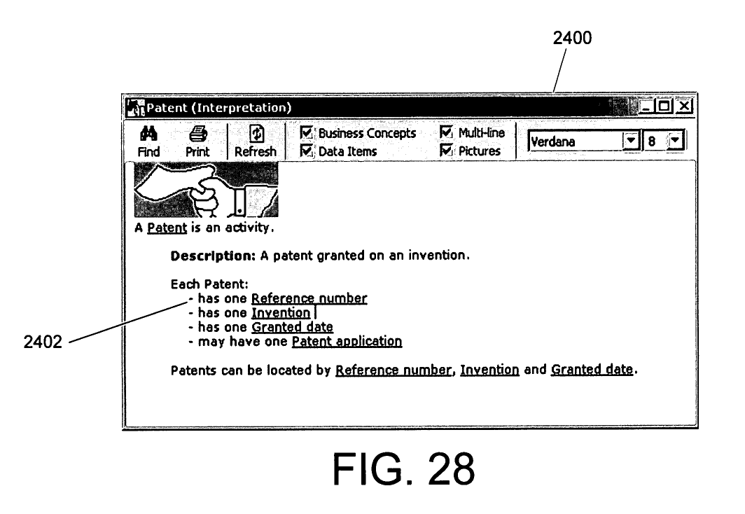

A further view, the “interpretation” view gives an English-language reading of the application definition's contents, either selectively for a single concept or for all concepts in the application definition. The interpretation view may provide hyperlinks so that the user can navigate around the application definition without leaving the interpretation window. FIG. 28 illustrates an example of an interpretation view window 2400. Applications may be documented quickly and accurately using this view. Expressing the interpretation in natural language is possible because concept definitions incorporate concept properties such as plurals, “same as” names and (optionally) relationship qualifiers or verb phrases. For example, the relationship between business concept Customer of innate concept person and business concept Purchase of innate concept activity can be expressed as:
1. A preferred customer is a customer (person).
2. Each preferred customer makes one or more purchases.

In this case, “preferred customer” is a “same as” name for the business concept Customer, “makes” is the relationship qualifier or verb phrase, “one or more” is determined by examining the “multiple” and “optional” properties for the business concept Purchase in the window for Preferred customer, and “purchases” is the plural form of Purchase.

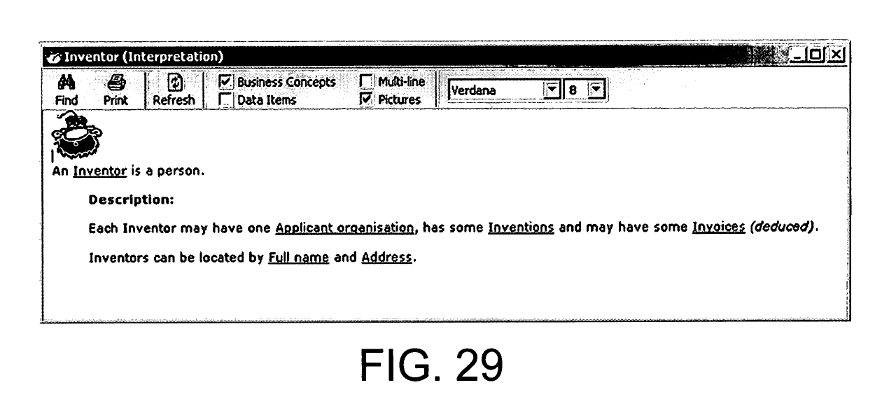

The interpretation view may be filtered so that it shows or hides business concepts, data items, pictures and annotations. The user can print the interpretation directly, search it for specific phrases, or cut and paste it into a program of choice. The user may opt to show or hide various aspects of the interpretation including business concepts, data items, and pictures. The default interpretation style uses indentation 2402 as shown in FIG. 28. An alternative more conversational “sentence-style” form of interpretation according to an embodiment of the invention can also be used as illustratively shown in FIG. 29. This “sentence-style” interpretation may be useful for pasting into specifications, requirements statements, and the like. In addition, the sentence-style interpretation can be very useful as a vehicle for interaction with remote users or customers when deciding requirements. A typical interaction may be as follows:
a. Analyst discusses requirements by telephone and/or email with remote customer.
b. Analyst uses a BCIM to define business concepts.
c. Analyst sends interpretation view of whole application to customer. For example, the analyst may copy the interpretation view into a word processor document and send it to customer by email. On the other hand, the BCIM itself may have functionality to send the interpretation view to the customer.
d. Customer reviews interpretation in document, makes changes as required, and returns document by email.
e. Analyst compares original and modified documents to view changes.
f. Analyst uses the BCIM to make selected changes to application definition.

Most people know how to use a word processor to edit documents, so no special training may be required for the customer to participate in design in this way. In many instances, the use of a natural language interpretation works well with general business users because the interpretation may be inherently understandable, with little need for explanation or coaching of notation or terminology. It is by definition written in the client's own terms since it is natural language. One example where this approach may work well is in offshore software development, where the analyst may be geographically remote from the customer. Another useful application may be with “text to speech” technology for the visually impaired.

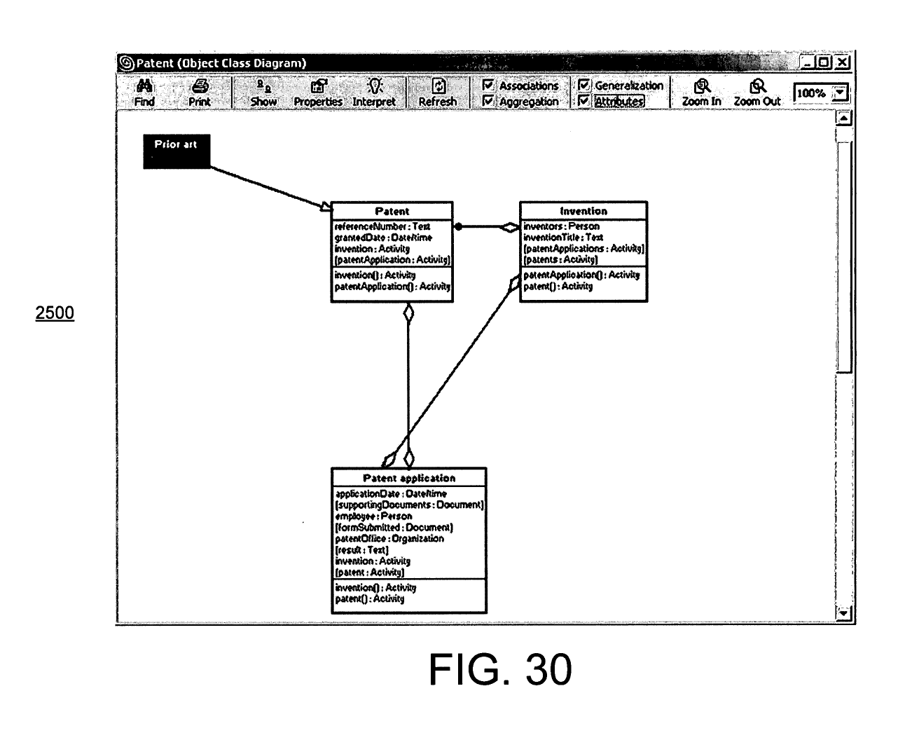

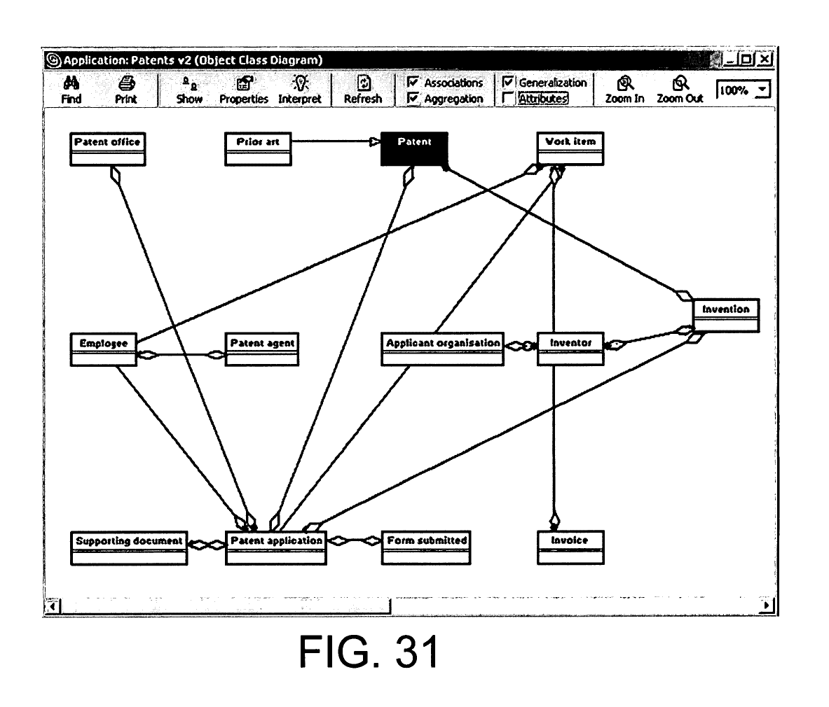

A BCIM may make other views of an application definition available, such as an “object model” or “class diagram” view. One embodiment of the BCIM may use a simplified standard object modeling notation as illustrated in FIG. 30. This view may be especially useful to information technology professionals and to experienced developers with prior training in object-oriented design. The user can choose to hide or show various aspects of the object diagram, including different relationship types (e.g., aggregation, association, and generalization or inheritance). According to one aspect, the relationship types may be color-coded for ease of recognition. The user can choose which standard object modeling notation to use (e.g., UML class diagrams). Other types of diagram may also be displayed, such as Use-Case diagrams, entity-relationship diagrams, functional decomposition charts, flowcharts, RADs (role activity diagrams), DFDs (data flow diagrams), or state-transition diagrams. A BCIM may perform automatic layout of object class diagrams. In this case the user may not have to draw the diagram or position the boxes and lines manually. The entire content and appearance of the diagram may be derived automatically from the contents of the application definition. FIG. 31 shows an object model view of an entire application definition.

The classes represented in the diagram 2500 in FIG. 30 may not necessarily reflect software structures that will actually be implemented by the BCIM in an application. However, they serve as a useful guide to the structure of the application definition for those who are familiar with the notation. They also illustrate the fact that the information contained in an application definition is a superset of that contained in typical systems analysis diagrams like class diagrams.

In an embodiment, the BCIM may also provide support for a 3-D viewer that allows application definitions to be navigated and modified in three-dimensional space. The mind is adept at perceiving information arranged in three-dimensional space, which gives three-dimensional representations significant advantages since they permit more information to be presented and allow the focus of attention to shift over a greater (subjective) area. In the BCIM the 3-D viewer view places business concepts and other components nearer or further away from the viewer depending on how closely they are related with the “current” item being viewed and/or modified. The user may “move” through the model, rotate it, and zoom in to view particular concepts.

VII. Process of Creating Application Functionality

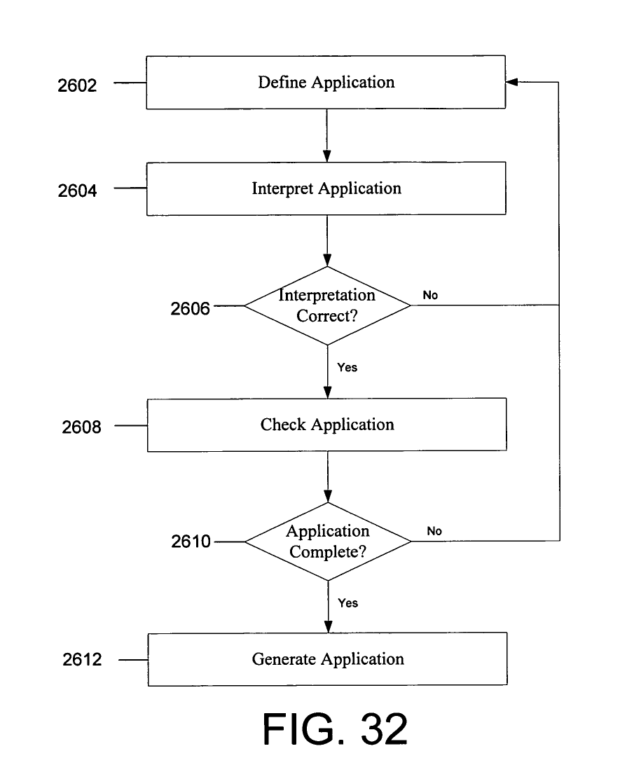

A BCIM may generate software application functionality directly from an application definition (e.g., a grouping of business concepts), which is a computer representation of the user's mental model of the relevant business scenario. To create a new application functionality, the user may carry out the following steps in a BCIM as illustrated in FIG. 32:
In block 2602, the user defines an application by placing business concepts (which may appear as icons or other images) in windows to signify their relationships to one another. The user can create new business concepts and place existing business concepts in the windows of other business concepts. In accordance with an aspect of the invention as described above, the user can specify business concepts as being plural, optional, “part” of another business concept, locators, etc. The business concepts together constitute an application definition. The user can create all of the business concepts in an application definition starting from scratch, or by copying and modifying one or more existing application definitions (or fragments thereof), or by importing an application structure from a non-BCIM application such as an XML (extended markup language) schema definitions or an existing legacy application or database. The creation of an application definition, to define a required application or some set of application functionality, may involve some combination of some or all of the above options.
In block 2604, the user may optionally invoke the “Interpretation” function to check that the meaning of the application definition (i.e., the meaning of the business concepts in the application definition) corresponds to the intended and desired business meaning. The user may then optionally modify the application definition to adjust its meaning accordingly.
In block 2608, the user may optionally invoke the “Check Application” (or validation) function to determine the completeness of the application definition. Any issues highlighted by the check may optionally be corrected by the user at this point by modifying the application definition.
At some point, the user may invoke the “Build/Run” or “Apply” function in block 2612 to create a software application or modify existing application functionality, based on the present contents of the application definition. If the user is creating a new application, the application will then appear and can be used. If the user is modifying an existing application, or using the BCIM embedded within some other system such as an application server, web application, or operating system, the relevant application functionality will be modified, in accordance with the new state of the application definition, next time the functionality is used.

The steps described above can be performed repeatedly and in any order until satisfactory results have been obtained: either a complete software application, with desired behavior, or a piece of application functionality that forms part of some other software. The entire process can be done quickly and might involve altering the application definition many times.

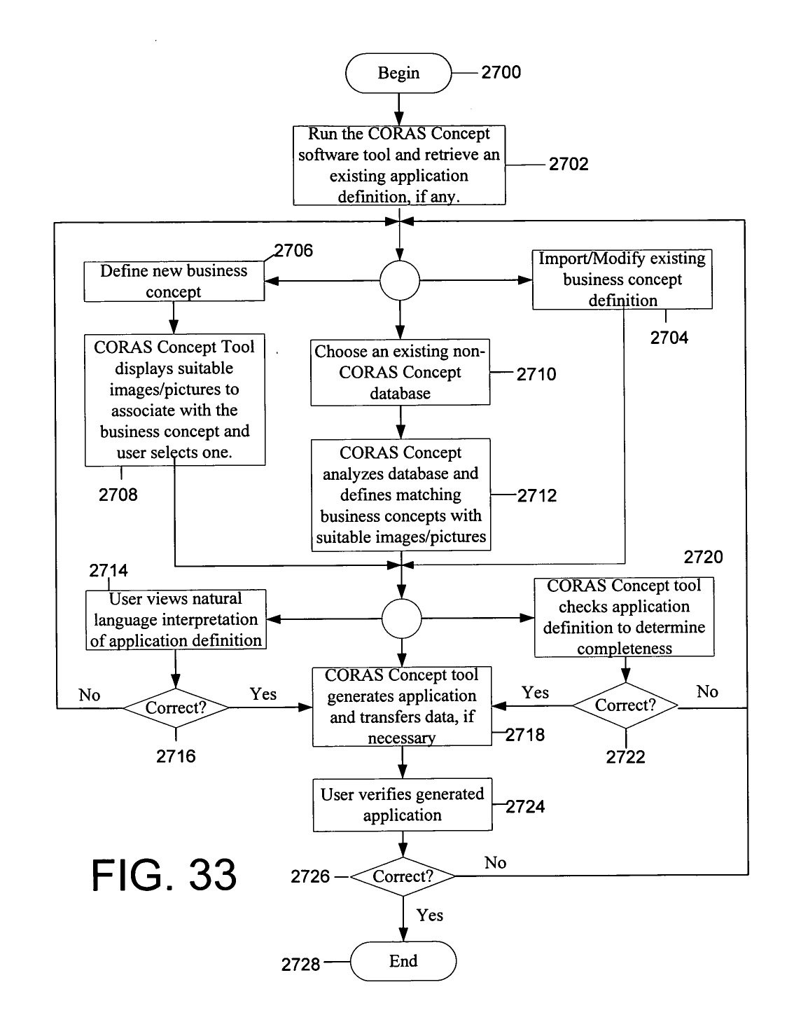

With reference to FIG. 33, the application design and generation steps will now be described in more detail. In block 2702, the user runs a BCIM software tool. The user may begin a new application definition or retrieve the application definition from an existing application, if one already exists. Next, there are several ways in which new business concepts may be added to the current application definition. First, a user may simply define a new business concept using the BCIM software tool as indicated in block 2706. During the process of defining a new business concept, the BCIM tool may guide the user through selecting a suitable image, picture, or the like to be associated with the business concept (block 2708). Second, a user may already have previously defined a business concept that he/she would like to reuse. In this situation, the user may reuse (and perhaps modify) an existing business concept (block 2704), taking it either from the current application definition or from another one. Because this business concept object definition was previously defined, it would already have an existing image, picture, or the like associated with it. Of course, the user is always free to select a different image or picture to be associated with the new business concept. Third, a user may wish to import structures from a non-BCIM application (e.g., an application built using Microsoft Access, Oracle or XML) (block 2710). In this situation, the BCIM tool would analyze the existing structure and deduce new business concepts and associated images and pictures. Again, the user would be free to change any default selections that the BCIM makes on importing the existing structures.

When importing a specific business concept from a non-BCIM application, related business concepts may also be imported in order to provide context and meaning for the specified business concept. However, taken to its logical conclusion, this process could lead to the importing of an entire application definition since every component in a non-BCIM application may be potentially related to every other component, at least indirectly. Therefore, the user may be given the option of specifying precisely which business concepts they do not wish to import, if required. Further, any business concepts that are imported and found to have the same name as an existing business concept may be merged with the existing business concept if their definitions are identical. Any concepts that are named identically to existing business concepts but have different definitions are not merged, and are simply imported with their preexisting definitions. This allows the user to reconcile the conflicting definitions at a later time. It may be permissible for an application definition to contain conflicting definitions; working application functionality can be produced from such an application definition without problems, even if the conflicts are not resolved first. This allows, for example, the full consequences of alternative business concepts for the same mental concept to be explored in the resulting applications before the user commits to a particular approach.

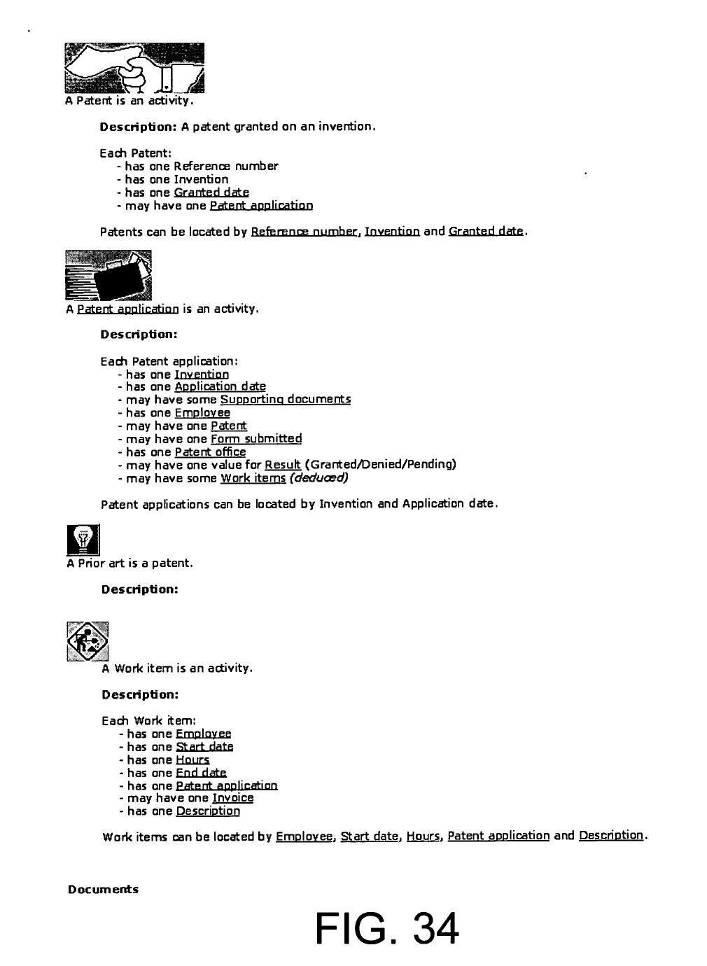

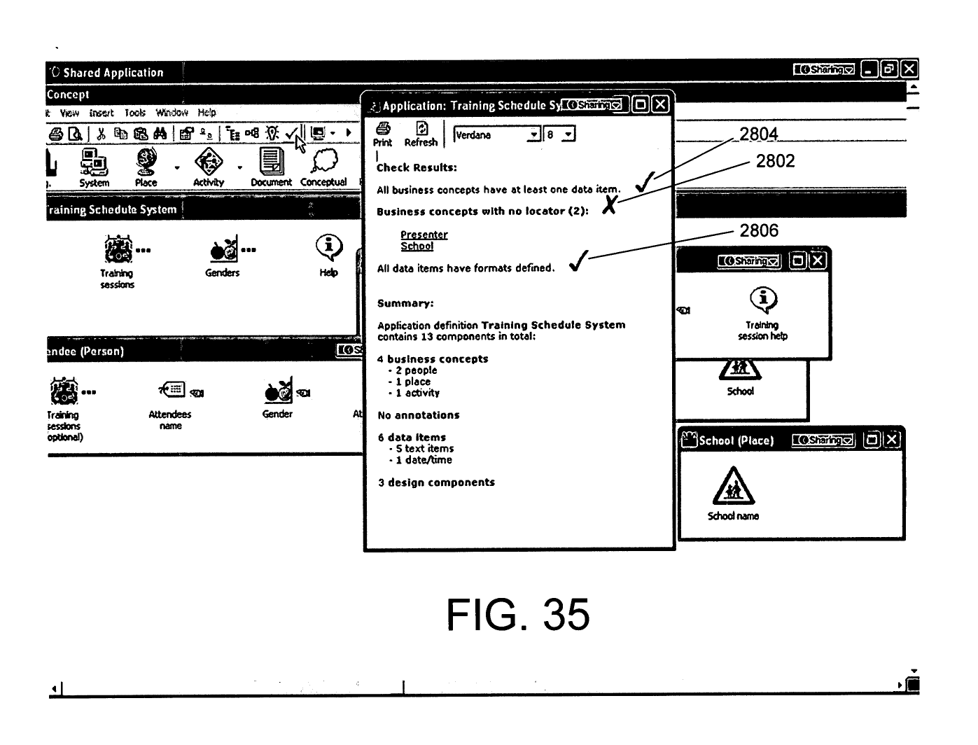

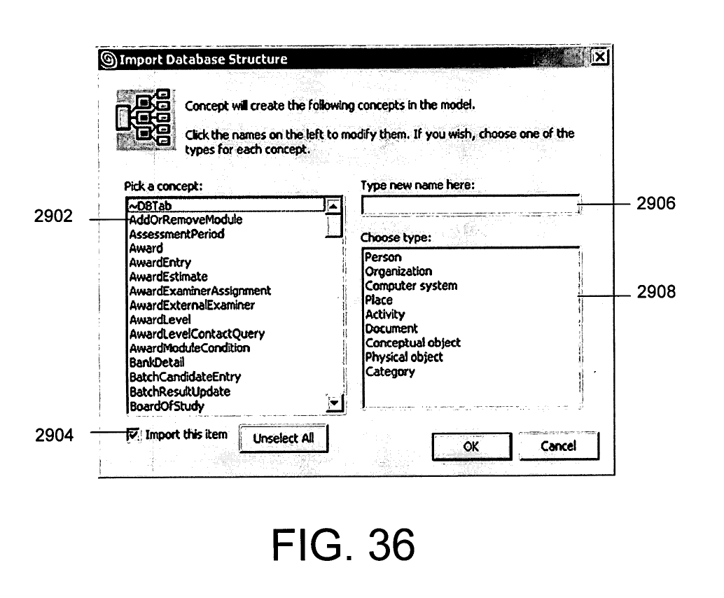

Having defined the business concepts, the BCIM tool may allow the user to view the application definition in natural language format (block 2714). An example of an application definition in a natural language format is shown in FIG. 34. The user may review this natural language format to determine the accuracy of the application definition. If desired, the user may modify the application definition, including through natural language or through the windows with the images that define the business concepts. In addition, the BCIM tool allows the user to check the application definition for completeness (block 2720). FIG. 35 is an illustrative summary of results generated when the BCIM has checked an application definition for completeness. Referring to FIG. 35, the BCIM may indicate that locators have not been specified for certain business concepts (2802). In addition, the BCIM may perform checks, among others, to determine that each business concept has at least one data item (2804) and all data items have formats defined (2806). Of course, the user may continue to modify the application definition. Many other types of checking are also possible, including:
Presence of a description for each business concept, since the presence of descriptions makes application definitions and applications easier to use and to understand.
Identifying business concepts that have the identical images, since this is potentially confusing.
Identifying “circular” relationships (i.e., pairs of business concepts that are linked to one another in more than one way). While not always incorrect, this may be a sign of inaccurate modeling.
Highlighting a predominance of business concepts based on one particular innate concept, since this implies inadequate thinking about the business area and prevents the BCIM from applying its inbuilt intelligence to make deductions.

When the user is satisfied that the application definition is both accurate (block 2716) and complete (block 2722), the user may request that the BCIM tool implements the application functionality and transfers any necessary data (block 2718). At this stage, the user may verify that the application functionality operates as desired (block 2724), and may continue to refine the application definition according to the steps discussed previously.

The process in block 2710 of FIG. 33, in which a non-BCIM database is imported, will now be described with reference to FIG. 36. After choosing the existing database to import, the user is shown a list of candidate business concepts 2902 that the BCIM has deduced from the database structure. The user may choose which candidate business concepts to import through checkbox 2904. Also, for each candidate business concept 2902, the user may enter a new name in text field 2906 and denote an innate concept 2908. If no innate concept is chosen, the BCIM may deduce the innate concept for each concept by matching its name to known names in its thesaurus or other search tool.

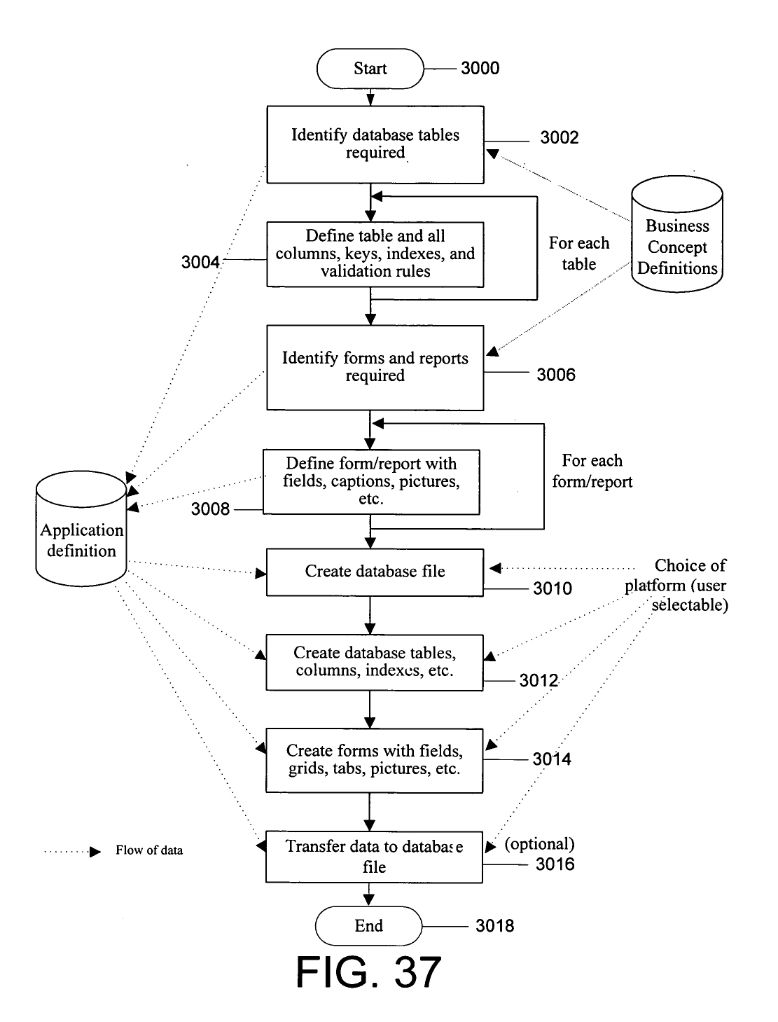

The process by which the BCIM produces application functionality in block 2718 of FIG. 33, will now be discussed in more detail with reference to FIG. 37. Referring to FIG. 37, the BCIM begins the process in block 3002 by first examining the business concepts within the application definition and determining the database tables that may be required based on those business concepts. Once the determination of the appropriate database tables has been made, in block 3004, the BCIM defines, for each table, the necessary columns, keys (e.g., primary keys, secondary keys), indexes, and validation rules. Next, in block 3006, the application definition, which includes the business concepts, may be examined to determine the forms and reports that will be needed in the resulting application functionality. For each form or report, the BCIM then defines the fields, captions, pictures, and the like that will be used with the form or report (block 3008). These tables, forms, and reports that have been defined within the BCIM are not yet platform-specific. Therefore, these tables, forms, and reports may ultimately be implemented in a variety of platforms, including Microsoft Windows, Unix, Linux, Microsoft Access, Oracle, Microsoft SQL Server, DB2, Postgres, MySQL, Java/J2EE, Microsoft NET, Microsoft Visual Basic, Microsoft ASP, C++, Lotus Notes, and so on.

Having defined the desired tables, forms, and reports, if the desired result is a new application, the database can be created in a particular database format (block 3010). For example, to create a Microsoft Access database, this task typically consists of creating an appropriate database file and then building table, form, and report objects within the database file by executing Visual Basic for Applications and SQL statements. In Oracle, this typically consists of setting up a new schema within an existing database file by executing SQL statements. Once the database is created, the BCIM implements the database tables, columns, indexes, and the like in the database (block 3012). The forms or reports with the appropriate fields, grids, tabs, pictures, and the like are built in a manner appropriate to the selected platform(s). For example, in a Microsoft Access implementation, forms would be included in the database file (block 3014). In a J2EE implementation, forms would be generated as standalone components using a combination of HTML, XML, JavaScript, and other elements. Optionally, the BCIM can also import data into the database, generate suitable test data and/or populate it with security data (block 3016). The application generation process is now complete as indicated in block 3018.

Alternatively, if the desired result was application functionality within existing software, the BCIM may adopt a similar approach to specification of required structures, but the implementation can take several alternative forms. For example, it may involve the creation of subsystems, modules or components that can be invoked by the containing software. Alternatively, it can consist of “enacting” the required functionality in an interpretive mode. This is possible because the BCIM tool obviates the need for explicit user interface design when application functionality is constructed. User interfaces are derived directly from business concepts; this practice not only saves time, but also avoids inconsistencies among different user interfaces, and allows for platform portability, upgradeability, etc. All components of the user interface design may be reproduced automatically depending on a range of factors such as platform, business concept definitions, the specific innate concepts in use, and the relative amount of data involved.

For example, when viewing a page in a web application that lists records from the database, by default only 7-10 records are shown at a given moment, since that typically is approximately how much information one can comfortably view on a single web page. On the other hand, if the application is deployed for a platform with lower information capacity, such as a mobile/wireless application, then a smaller number of records would be visible. In a “thick client” (e.g., client-server) implementation on a local area network the opposite might be true, since depending on network speed the user might be able to scroll through a larger number of rows without the overhead of having to frequently request fresh information from the database.

Similar considerations apply to other aspects of the user interface. For example, pull-down list boxes typically contain up to a fixed, but configurable, number of rows (e.g., 100). Beyond that number, locating data in the list may become onerous, and performance may suffer, so the BCIM application may decide at run time to represent the same information using a pop-up window with search capabilities. No explicit design work is necessary since this is a built-in and automatic feature of the application. Another example concerns choice of data view. To avoid excessive database query activity, the default data view representation may be varied according to the amount of data stored in the database for the corresponding business concept. For example, when viewing a list of students, if the list is bigger than a certain size, then the BCIM application makes no attempt to retrieve all of the available data and instead displays a search form where the user may enter selection criteria for the rows to display. In all of these cases the parameters used to govern application behavior may be tuned by the system administrator or the programmer, and the application or other software is dynamically responding at run time to the changing business concepts.

Certain functions may automatically be built into application functionality by a BCIM, regardless of the subject matter addressed by the application. In these features, the behavior typically varies according to the innate concept of each business concept being manipulated. One such automatic feature may be a “site map,” which may appear in Web applications. A sitemap in this context may be defined as a page that gives a summary of all available data areas and functions for the current user. A user may have access to hundreds of different data areas and functions, and therefore this list could become unwieldy and of little use. The BCIM may overcome this obstacle by using the innate concepts to group data areas and functions. For example, the user may be presented with a list of types of people (e.g., customers, staff, employees, and the like), a list of places, a list of activities, and similar lists. This serves to group information in a way which is meaningful to ordinary users and helps to direct them to the areas they want to go.

Another situation when the design is modified according to the innate concept of each business concept is in the presentation of pages representing a single business concept. For example, when displaying the information about a particular customer, an application must decide which linked information should be presented at the same time. This may be achieved by using only those elements which are considered “part of” or have strong affinity to the present business concept. So, for example, contact information may be presented as part of the customer record, and would appear as a tab on the same page, whereas invoices may have less affinity to customer and therefore appear as a link in a less prominent position on the page. In this way, the application may present the most relevant and useful information and functions to the user.

According to an embodiment, the BCIM may provide application functionality that can adapt at runtime, learning to present information that is likely to be most useful. This can be as simple as displaying information or links at the top of the page if the user consistently requests the information or uses the links. It can also involve reordering tabs across the page, presenting links as tabs if they are often used, going straight to a particular sub page first if that typically is the one requested, and other adaptations.

Because business concepts are divided into different innate concepts, this allows each business concept to be treated differently from other business concepts in an application depending on its innate concept, which process is also referred to as “differential design.” This reflects the natural human tendency to regard, for example, people as fundamentally different in kind from documents or other types of thing. Because of the fundamental difference in the way that people perceive people and documents, users may expect to interact with data about people differently from how they interact with data about documents. The specific behavior of the BCIM in this respect can be configured by the user. Examples of such differential design implemented by the BCIM are shown below. These examples consider the case where the desired result is a complete application.

### EXAMPLE 1

### Default Behavior: Simple System (No Differential Design)

In the default behavior of the BCIM, each business concept in the application definition may appear on the switchboard or home page of the resulting application, irrespective of innate concept. Upon clicking on an icon, the user is presented with a list of items (e.g. customers, if clicking on the “Customer” icon or link). If no items have yet been stored, the user is presented with a “single-record view” form in which to enter details. Single-record views bear tabs for related concepts.

### EXAMPLE 2

### Accounting System Style (Differential Design Chosen for Compatibility with Accounting Software)

In the accounting system style, icons may be placed on the switchboard or home page of the generated application in groups (represented, for example, using tabs) according to innate concept:
Activity tab (activity, document, and physical object business concepts). Activity business concepts are presented initially in transaction-style form (like entries in an account). Document and physical object concepts are presented initially using single-record view form with tabs for related business concepts.
Address book (person, organization, and place business concepts). Business concepts are presented in standard address book style with alphabetical tabs, card view, and the like.
Reference data (category, conceptual object, and system business concepts). Business concepts are presented in “lookup table” form similar to a chart of accounts.

### EXAMPLE 3

### “Scheduling” Style

In the scheduling style, person, organization and place business concepts may be chosen from lists. Related activity business concepts may be represented initially in calendar view, grouped for the selected person, organization, and the like (e.g., a monthly schedule of meetings for a selected salesperson). Activities are entered in appointment style (e.g., like a diary entry). The usual calendar zoom in and out facilities may be available.

### EXAMPLE 4

### Bill of Materials/Parts Explosion

In this view, physical object business concepts may be presented using a hierarchical (e.g., tree style) navigator so that any level can be exploded to reveal detail. Navigation from any node to related data is effected using pop-up menus.

### EXAMPLE 5

### Geographical Information System (GIS)

In the GIS view, place business concepts may be represented in map form using a predefined coordinate system and map images. Linked business concepts may be shown as “overlays” and may be hidden or displayed at run time by the application user. For example, a map may show city names, offices, suppliers, sources of sales, locations of a certain type, and the like.

### EXAMPLE 6

### Data Warehouse Style

In the data warehouse style, icons may grouped into fact tables and dimension tables according to type:
Activity business concepts provide data warehouse-style “fact” tables. A data warehouse typically consists of one or more fact tables that can be aggregated by a number of ‘dimension’ tables. The facts can be aggregated in any meaningful way.
All other business concepts provide the dimension tables. The dimensions are used to “slice and dice” the aggregated fact tables in various ways. Results can be presented in any appropriate way (e.g., tabular, pie chart, bar chart, graph, and the like). For example, sales (activity business concept) may be shown grouped by sales region (place business concept) in a pie chart. The user can select at run time what attribute of sales determines the size of each pie slice: number of sales, total sales volume, sales value, and the like.
The user can “drill down” to view the source data for any aggregated fact (which may itself be an aggregation).

According to an aspect of the invention, these design styles do not need to be programmed separately for each piece of application functionality and they are non hard-wired into applications. Instead, they are run-time styles or “views” which can be applied to any applications at the click of a button. Any given application can be used with multiple styles simultaneously by different users, according to the preference of each user. The potential number of differential application design styles is of course numerous, since any combination of representations can be defined based on the finite set of concept types and the variety of ways in which information can be presented and manipulated. The number of possible design styles may be limited however by the capabilities of the target platform. For example, pie charts in the data warehouse interface style may work less well in Wireless Application Protocol (WAP) applications where the display is small and less capable of rendering graphics well.

VIII. The Universal Application

The foregoing discussion has covered the two major end results that accrue from the process of building application functionality using a BCIM: (a) a complete and self-contained software application, and (b) one or more pieces of application functionality that may appear as part of other software programs, whether they be applications software (e.g., stand-alone software) or system software such as an operating system or applications server. The first end result, which we term the “structural” mode of building applications functionality, involves an application generation process which is distinct from, and must precede, the execution of the complete generated application. The second end result, which we term the “interpretive” mode of building applications functionality, involves immediate, interpretive execution of application fragments based on the current state of an application definition. However, one of ordinary skill in the art would recognize that this distinction is not a necessary one and these two end results are merely opposite ends of a continuum. A BCIM can be used in both modes simultaneously, and any given end result may include elements of both.

For example, in one embodiment of the BCIM, some elements of required application functionality are generated once from the application definition and used many times. An example would be properties files and XML configuration files, which for various reasons are best built as separate files form the running application. Yet, in the same BCIM, the modification of an application definition will also result in immediate modification of a running web application, without the need for regenerating any component. For example, this occurs where pages (e.g., forms) in the application are “thrown up” at run time based on the present state of the application definition; each page may be therefore automatically rendered differently if the application definition has itself changed. The decision about whether to use structural or interpretive modes may be left up to the BCIM and may be based on considerations such as security, performance and reliability.

The transition from one application definition version to another may be achieved by “reinitializing” the running application after changes have been made to the application definition. The reinitialization process quickly and transparently reloads internal application descriptions so that subsequent page views conform to the new application definition. Any resources, whether internally cached or held externally to the application, may be refreshed as required. The reinitialization is transparent in that users remain connected, do not lose work and do not need to log in again. Any aspect of an application can be altered this way, very rapidly. This ability to “morph” an application in structural ways at run time presents many advantages over current practice. For example, it means that application development can proceed in a more intuitive fashion, avoiding the need for paper specifications, mock-ups and prototypes. One may start with a very simple version of a required application, and then iteratively change its structure and add further structure until the application meets the requirements. It also means that even finished applications are not fixed in function, but can evolve over time with relatively little effort and little technical knowledge on the part of the user/developer.

The BCIM allows applications to be transformed at run time because it includes run-time components which are responsible for providing application functionality, and which receive and act upon the application definition when it changes. For example, in one embodiment of the BCIM, this may be achieved through an XML application descriptor which is produced from the application definition and consumed by a run-time component. The same functionality could be achieved more directly if the application definition were itself stored in XML form, avoiding the need for an intermediate representation. In other embodiments, similar effects are achieved by building and executing program code dynamically at run time or invoking existing functions in a run-time component. Of course, the foregoing discussion has concentrated on program and user interface structures; to achieve the above-mentioned benefits the BCIM may also implement a mechanism by which database structures are modified to suit changes in an application definition. This may be done in several illustrative ways, including:
Reconstruction of the database structure in a new database to match the new application definition; data is then transferred from the old database to the new database; and
Modification of the existing database structure “in situ”.

The first option may be readily suited to rapid prototyping, where the data in the database is test data, data volumes are low, and the application proceeds through multiple iterations quickly, with structure changing significantly each time. It may be possible to transfer most, if not all, data in each iteration, but this is not critical because loss of some test data is not typically much of a problem. Speed may be more important, so “quick and dirty” data transfer is acceptable. The second option may often be the preferred approach in the case of production applications, where data volumes are often high and loss of data, or loss of data integrity, must be avoided at all costs. Therefore, the BCIM supports both approaches.

If applications can be altered at will, even while they are executing, the distinction between software applications and software application development tools becomes less clear. Let us imagine a software application for, say, stock control, that has been built using a BCIM. The application incorporates its own application definition as well as a BCIM (or access to the functions of a BCIM, provided by the operating system, an online service or other system software). While the user is running the application, he or she can use its embedded BCIM facilities to alter aspects of the application at will. Taken as a whole, the application in question may be its own development tool. This can easily be envisaged in a web application, for example, where one of the links on the admin page could be “Modify this application.” Clicking the link would display a window containing the current application's definition. The user would be able to modify the definition and click “Apply,” at which point the application would be reinitialized according to the present state of the application definition. Although controls may be necessary, to prevent over-enthusiastic users from destroying their own applications and/or data, software applications with this degree of flexibility would be very useful and more powerful than today's software applications, which are essentially fixed in function as far as the user is concerned.

According to an illustrative embodiment, BCIM applications can be considered a new class of software product that combine features of today's packaged software applications with the ability of end users to alter the software dynamically. This is the concept of the universal application, a software application that can morph in any way, provided the user is able to alter its application definition appropriately. Such a universal application may exist in the form of run time components used in the embodiments of the BCIM mentioned above. These run time components can alter their behavior to match any application definition, and can therefore be thought of as applications with arbitrary functionality except that the innate concepts are fixed.

To enable users to best utilize this new kind of highly configurable or very flexible application, suitable reusable application definitions and business concepts may be available. The user may then simply browse for and choose the most suitable ones to use in their own applications. Further, the use of shared, standardized business concepts may guarantee the ability for applications to interoperate and work together. Shared libraries of business concepts, as will be discussed below, is one way this could be achieved. Another way is through the BCIM applying suitable predefined relationships between the innate concepts, irrespective of what business concepts are used. This would allow “meta models” to be applied, within which specific application definitions can operate. For example, a common business scenario is the situation where an individual is a member of an organization. When this occurs, the individual typically plays a particular role within the organization. This may be modeled as a series of relationships between the two archetypal innate concepts (person and organization), regardless of any business concepts. The BCIM may apply this particular scenario as a framework within which application definitions are interpreted, so that structural elements of the application definition would be deduced and need not be stated explicitly. In this embodiment of the BCIM, less explicit detail would be required within an application definition, since common details such as the one above could be assumed. This differs from the simple deduction of relationship types outlined already, since the BCIM would not depend on the user to state the existence of a relationship between two business concepts; the mere presence of the two business concepts would imply the existence of the relationship. One of ordinary skill in the art would recognize that there are many “standard” relationships whose presence could be inferred between the different innate concepts, provided agreement existed as to which relationships to assume, and the innate concepts were universally shared. In fact, the table of default cardinalities (Table III), which has been derived statistically from a large number of application definitions, is evidence that such “standard” relationships exist between the innate concepts.

IX. Data Migration

As outlined above, the BCIM supports a rapid application development process in which prototype application functionality can be developed and modified quickly. One way to test prototype software functionality may be to use it by entering and retrieving data. However, this can become tedious and slow when test data must be entered repetitively. Therefore the BCIM may incorporate the ability to generate plausible test data and/or to move test data quickly and intelligently between prototypes. This feature allows prototyping to proceed quickly by building test data quickly and preserving test data as much as possible between application versions. The process by which the BCIM creates test data or migrates it from a pre-existing database format into a database generated or modified in accordance with an embodiment of the present invention will now be described more fully.

Data in existing applications may need to be validated and cleaned before it can be loaded into new applications. Often, the data for application functionality produced by the BCIM must come from several existing database or other sources, some with questionable data integrity. As an example, the data may contain invalid values, data that does not match between tables, duplicative data, or missing values. The problems of loading data into applications are considerable and time-consuming. Thus, the BCIM incorporates an automated data migration facility. As in all BCIM features, advantage is taken of the innate concept framework and the known structure of relationships between business concepts. Databases can quickly be loaded with data from disparate sources, regardless of their original data integrity level, or with generated data. Data may be loaded from pre-existing databases, spreadsheets, comma separated value (CSV) files, tab delimited text files, XML files, fixed-width text files, and the like.

In the BCIM data migration facility,
1. A user specifies which business concepts in the generated application to load data into, and optionally provides a data source for each business concept that is to be loaded with data.
2. For each source provided, the BCIM maps the source with the destination and identifies matches in data item names. The user may correct this mapping as required.
3. The BCIM identifies the correct order to load data so that referential integrity will not be compromised. For example, if purchases must be loaded and each purchase refers to an existing customer, then customers will be loaded before purchases. If each customer is placed in an existing sales region, then sales regions will be loaded before customers.
4. The BCIM loads the data in the correct order, either moving data from the specified source or manufacturing suitable test data based on the innate concept for each table to be loaded. For each destination table, a distinct row is created for each unique set of values that can be found in the source data. Data that fails validation and cannot be interpreted is replaced by default values.

The approach taken by the BCIM data migration facility ensures that data can be loaded easily in a reliable and predictable manner. The BCIM data migration facility ensures that as much data as possible loads without being rejected and makes it convenient for the user to subsequently check that the data has loaded successfully. Additionally, a minimal amount of user effort is required to make subsequent corrections and the entire data migration operation can be undone and redone at will.

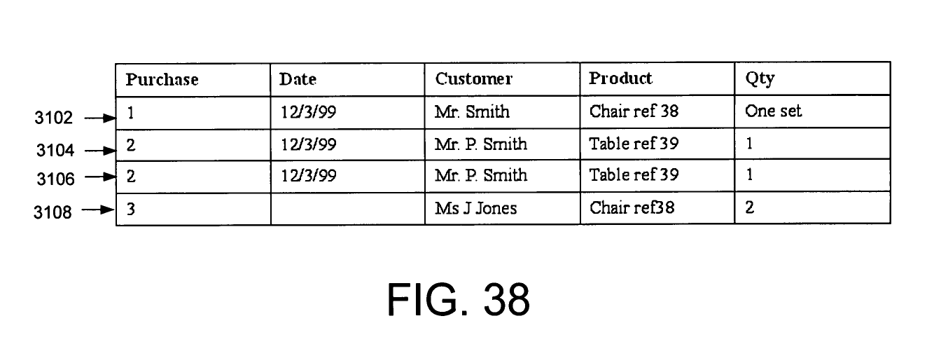

For example, consider a situation where data about purchases and customers must be loaded from a non-BCIM generated data source with poor referential integrity (e.g., a spreadsheet). The table in FIG. 38 shows purchases that must be loaded into a database generated by the BCIM. The first three rows, rows 3102, 3104, and 3106 are presumably for the same customer. However, the customer name has been entered differently in Row 3102 compared to Rows 3104 and 3106, causing a potential failure of referential integrity. In addition, the quantity for the purchase at row 3102 is not numeric, the purchase at rows 3104 and 3106 has been entered twice, and the date for the purchase at row 3106 is missing. When the non-BCIM generated database attempts to find a customer's account details, only one of the purchases will match, unless the customer's details have been replicated, which is itself undesirable. In such a case, the BCIM will:
Attempt to interpret the quantity value for the purchase at row 3102 as a numeric value, converting “One set” into the number 1.
Create two customer records, matching the two alternative spellings of the customer's name—“Mr. Smith” shown in row 3102 and “Mr. P. Smith” shown in rows 3104 and 3106. Each purchase in rows 3102, 3104, and 3106 would be connected to one of the two customer records. This arrangement provides nominal referential integrity and the user of the generated application is then free to reconnect one of the purchases to the correct customer record.
Ignore the second purchase at row 3106, since it is identical to the first purchase at row 3104.
Insert a default value for the date in the purchase at row 3108 if the date is mandatory.

After loading all data, the BCIM reports to the user a list of problems encountered, interpretations made, and default values inserted. The report is a list of links to data records so that the user can navigate to the records in question. The user may then inspect the results and correct the data where necessary, or decide to undo the data load and repeat the results. The BCIM data loader generally does not reject data records unless absolutely necessary.

X. Example Application Functionality Produced by BCIM

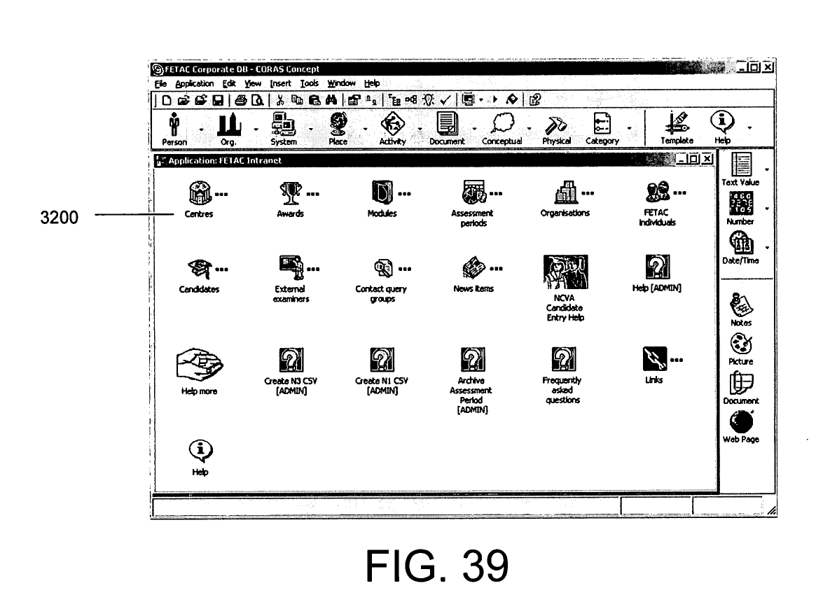

As an example, the application definition 3200 shown in FIG. 39 was used by the BCIM to generate a complex web application. The generated application runs under Sun Solaris with Sun One Application Server and Oracle 9i. However, the application could also be built for alternative platforms (such as other web platforms or client-server platforms) in which case it may look similar or different, depending on the capabilities and conventions of the selected platforms. The examples given below refer to a complete application produced using a BCIM in advance of use. However, very similar examples would apply to the case of altering the application at run time and producing application fragments in an interpretive mode as discussed earlier.

Apart from the inclusion of corporate information (header and footer) and color scheme, the pages in the example generated application are uncustomized except where otherwise indicated. The various functions provided by the generated application have been shown on separate pages, since this is the default mode of operation. However, one of ordinary skill would recognize that the same functions (list view, single-row edit, site map, and the like) may easily be shown together as “panes” or “portlets” on larger pages. In addition, alternative implementations in other platforms will also be presented for comparison.

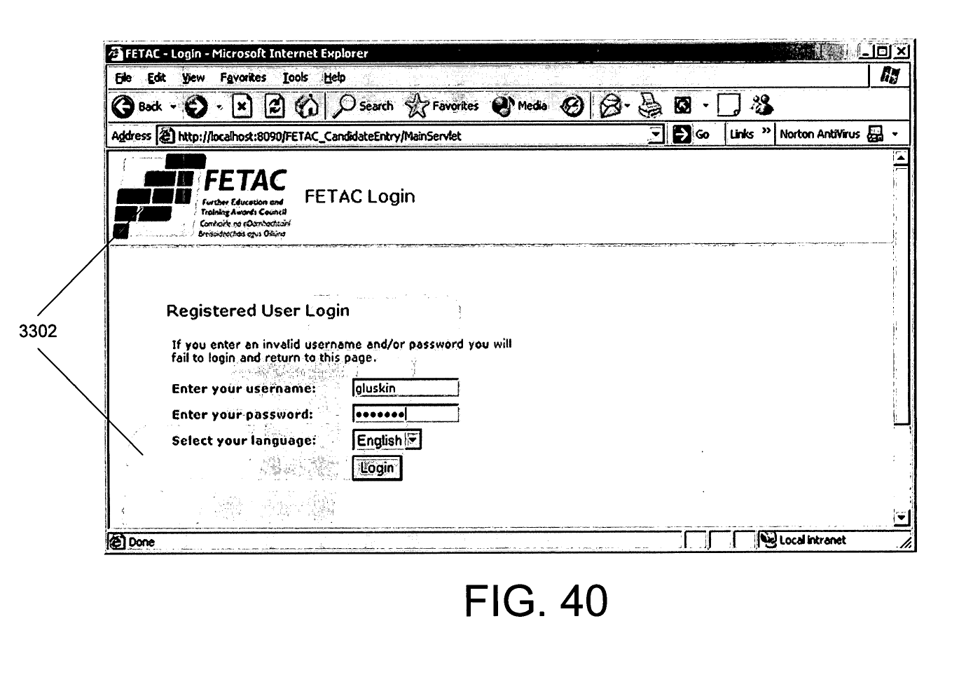

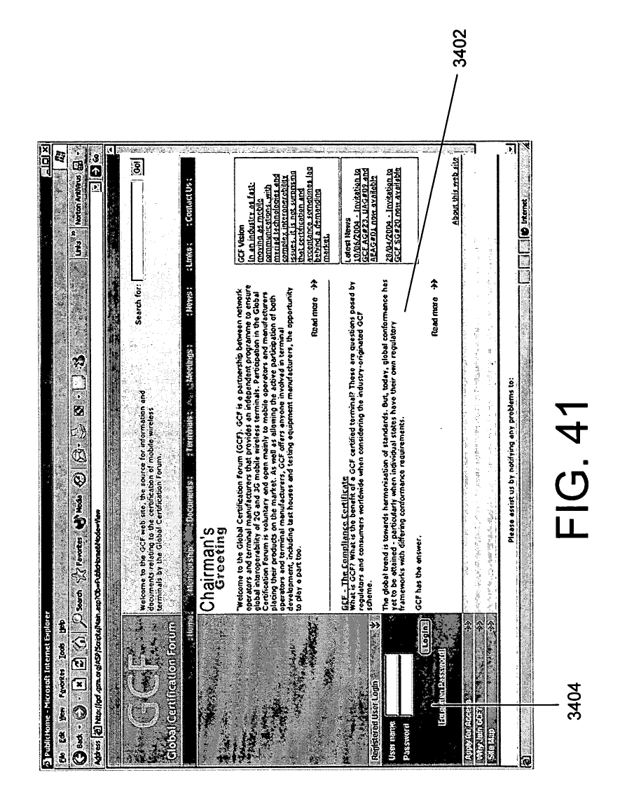

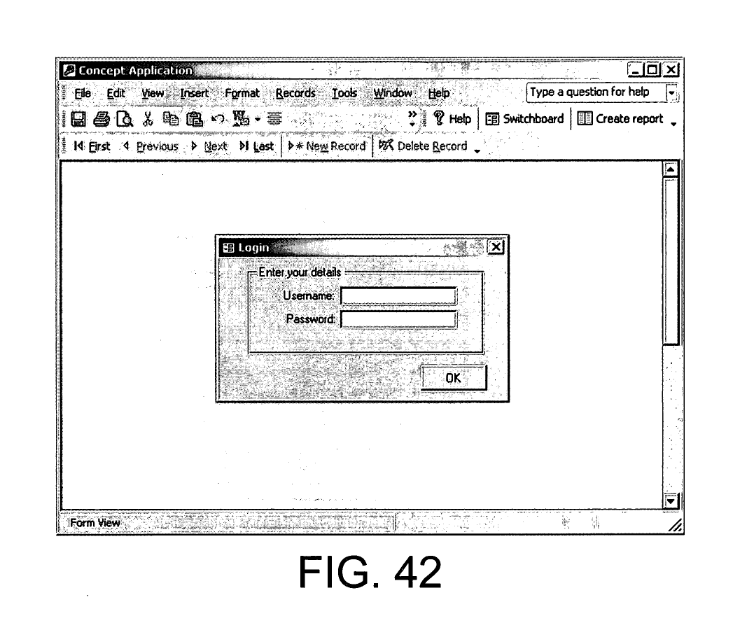

The generated application, which has user role security included, contains a login page as illustrated in FIG. 40. In the FIG. 40, the default login page has been customized by addition of graphics 3302. A more customized page which also includes login facilities is shown in FIG. 41. FIG. 41 is an example of one out of many “public” pages 3402 in an application that is accessible on the World Wide Web (i.e., the Internet). Users do not need to log in to use the public pages. This public setting is achieved automatically by configuring a user role of type “Public” in the application's security settings. The panel 3404 on the left, which appears in varying forms on all pages in this application, is achieved through the use of a custom “include file” that is embedded in the page template using a placeholder. For comparison, a client-server application as shown in FIG. 42 may use a different look for the login window.

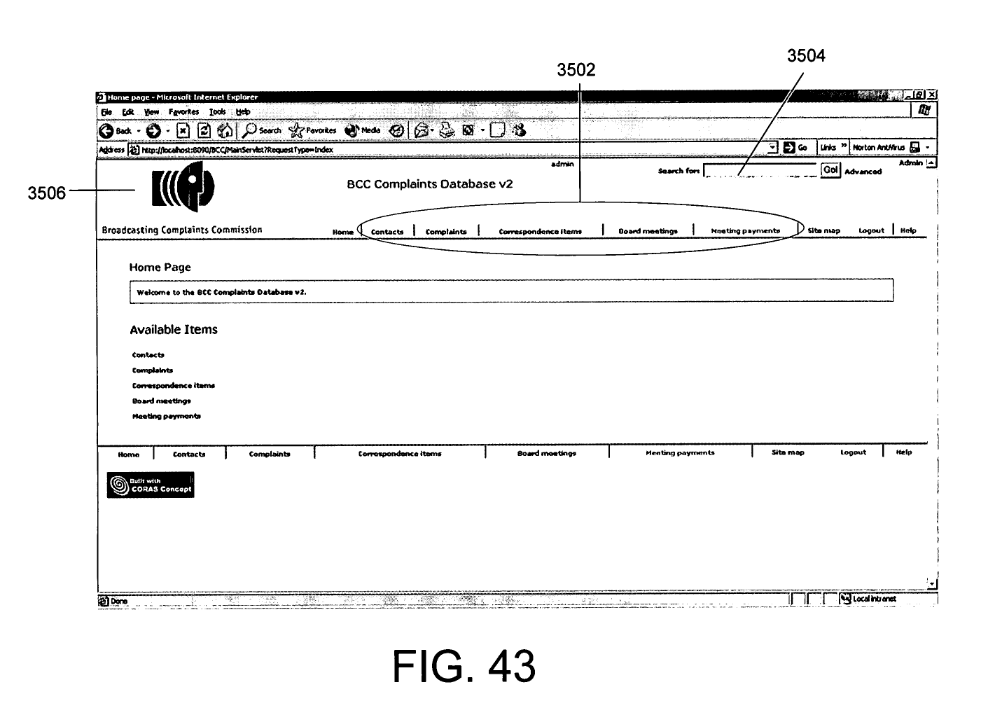

Once the user has successfully logged in, a home page (or “switchboard”) may be displayed. An example of a home page with a default format is shown in FIG. 43. Note the automatic inclusion of the relevant organization's identity 3506. The layout of this page is generated entirely automatically by the BCIM, including the menu bar links 3502.

In addition, items appear in the menu bar if their corresponding business concepts have been placed in the main application definition window (e.g., 3200 of FIG. 39). The color scheme, font face and size, and the like on all generated pages is determined by standard templates, also referred to as stylesheets. This means that changes to the appearance of the site may be made easily at run time by modification of the stylesheets. The list of styles in the stylesheets includes tab styles and the following sample styles shown in Table VI:

TABLE VI

| | | MenuItem |
|---|---|---|
| Body | Label | A: visited |
| Border | Line | MenuLine |
| Description | Link | NewLink A: hover |
| DescText | Link A: hover | NewLink A: link |
| ErrorText | Link A: link | NewLink A: visited |
| ExtraHeading | Link A: visited | PageLink A: hover |
| Group | ListHeading | PageLink A: link |
| Header | ListRow1 | PageLink A: visited |
| HeaderLink A: hover | ListRow2 | PageTitle |
| HeaderLink A: link | MenuDivider | SubHead |
| HeaderLink A: visited | MenuItem A: hover | TableHeader |
| Input | MenuItem A: link | Text |

In addition, the built-in global search function may be automatically added at the top of every page, as shown by the search function 3504 in FIG. 43. This built-in global search function may allow a full-text search of the entire database of the generated application, by default excluding “system” tables such as security tables.

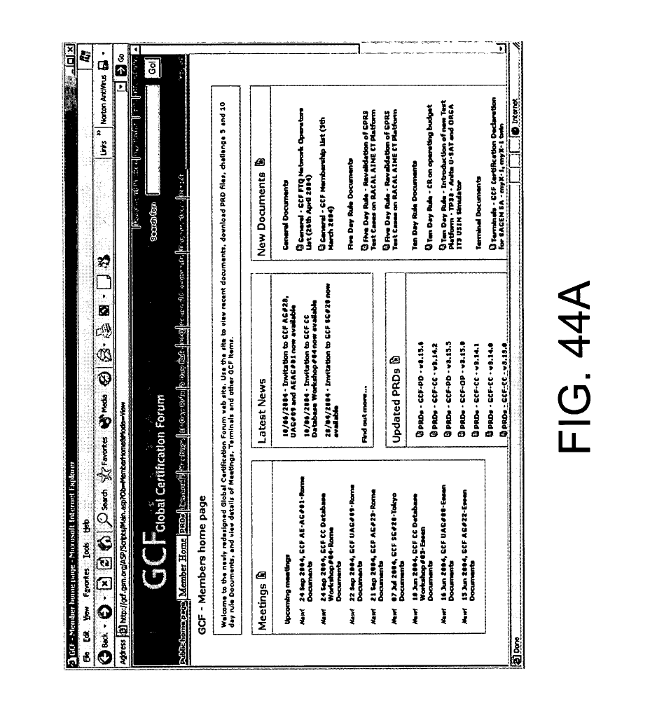

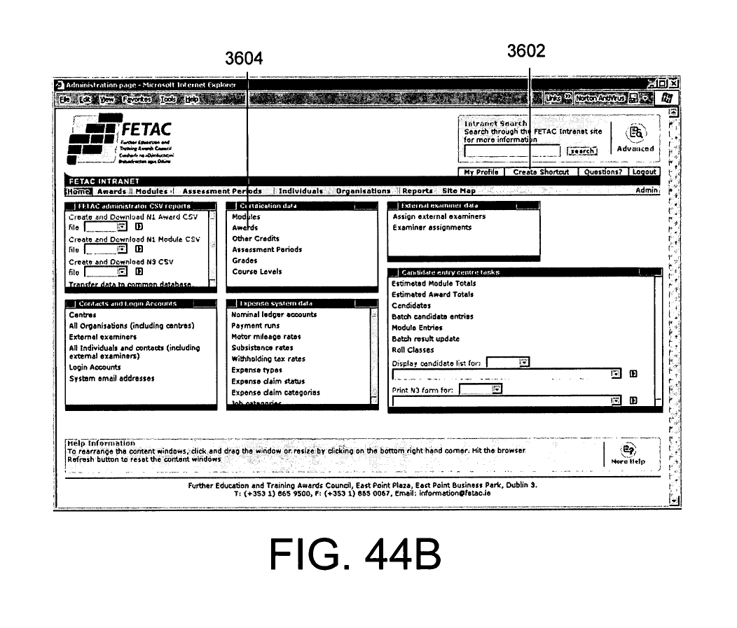

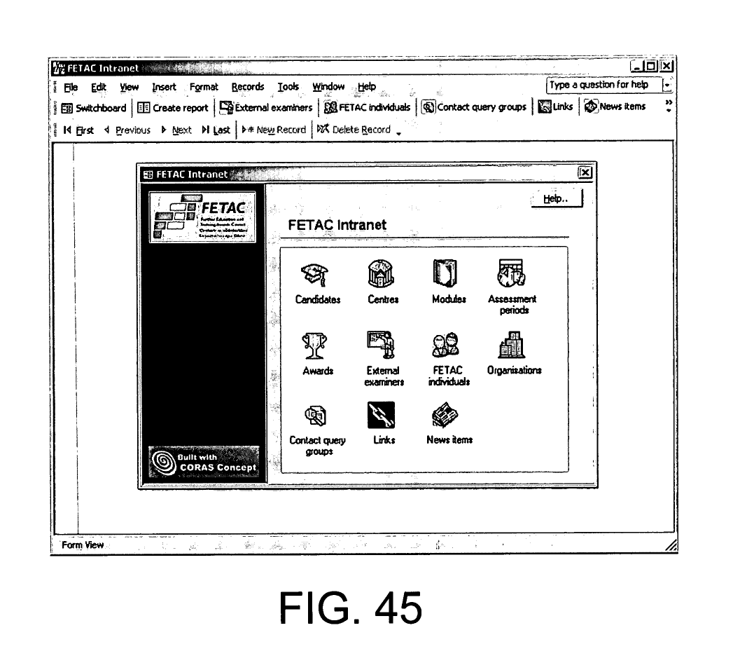

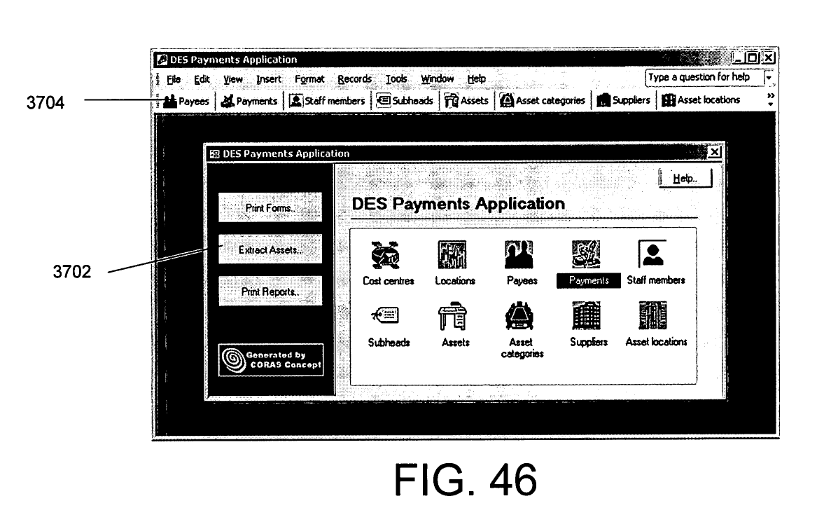

Simple customization (e.g., using the BCIM's API) of the pages in the generated application can produce a drastically different appearance, as in the two examples shown below in FIGS. 44A and 44B. The example in FIG. 44B is an “administration page,” but fulfills a similar function to a home page as shown in FIG. 44A. The “Create shortcut” link 3602 in FIG. 44B allows the user to add a shortcut to the current page on their home page. For comparison, the corresponding home page (or “switchboard”) in a client-server application could be quite different than the one shown in FIG. 43 while still fulfilling similar functions. Such an example of a home page in the client-server application is shown in FIG. 45. A customized home page for the client-server application is shown in FIG. 46. FIG. 46 illustrates buttons 3702 added in custom code, using the BCIM's API, to perform specific functions. Note the toolbar 3704 at the top of the screen shown in FIG. 46, which gives access to the same areas of the system as the home page. This allows users to navigate freely throughout the application without needing to return to the home page. Generated web applications may incorporate a similar menu bar at the top of each page.

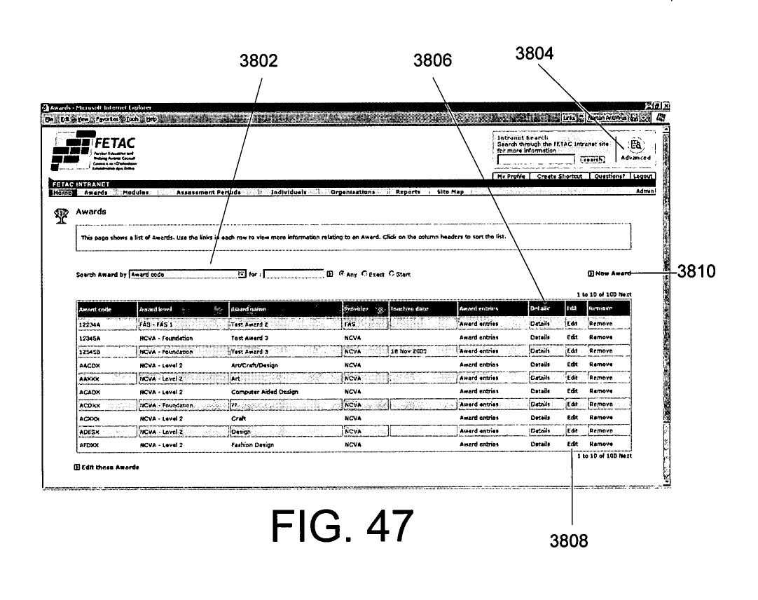

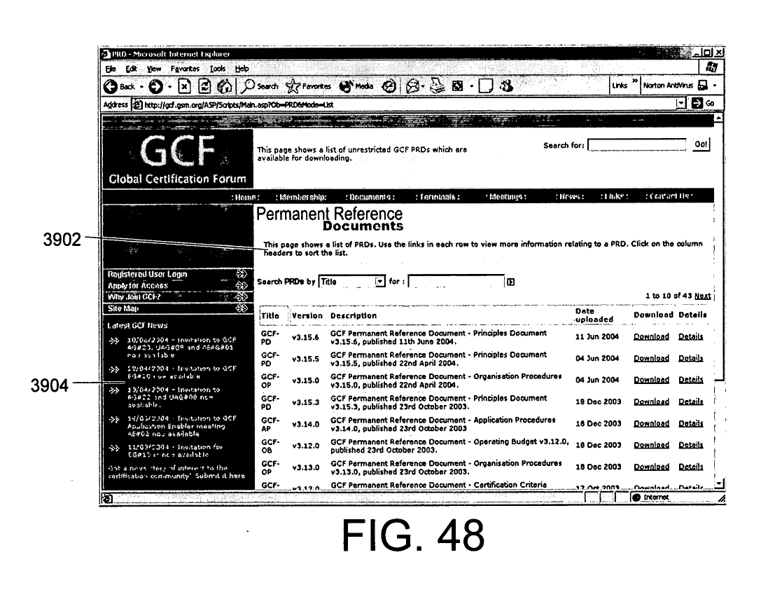

From the home page, the user may follow any available links to use the generated application as necessary. In general, links are shown only if the user has the permission to use them (based upon their user roles). When each link is clicked the application will respond with a suitable page corresponding to the link. For example, in the Web application shown in FIG. 44B, clicking the “Awards” link 3604 leads to an unfiltered list page as shown in FIG. 47. A list page from another application is shown in FIG. 48 for comparison. In resulting application functionality, lists may be sorted by clicking on column headers, subject to the application's built-in performance optimization algorithm. This means that if sorting would be likely to create too much of an overhead (e.g., if there are too many rows to sort) then the application will by default not offer the “sort” link.

FIG. 48 also illustrates the use of text blocks. The text block “This page shows . . . ” 3902 has been added to the page by the system using data from the database. The BCIM includes content management capabilities in applications automatically if the user selects this option. With text blocks, text is indexed by page and by placeholder within the page. Text blocks may be reused on multiple pages. This means that a user with appropriate security permissions can keep the text up-to-date without knowing how to write well-formed HTML. In addition, new placeholders can easily be added to page templates by editing their HTML source, allowing the system to be fully extensible.

The page shown in FIG. 48 also illustrates the use of “grids” 3904. A grid may be simply a table of data taken from a database table or query according to rules specified in its placeholder (e.g., tag). The news items on the left are placed automatically on the page by virtue of a grid placeholder 3904 in the page template. The grid placeholder 3904 takes the form of {Grid Table=“NewsItem” Rows=“8” . . . }.

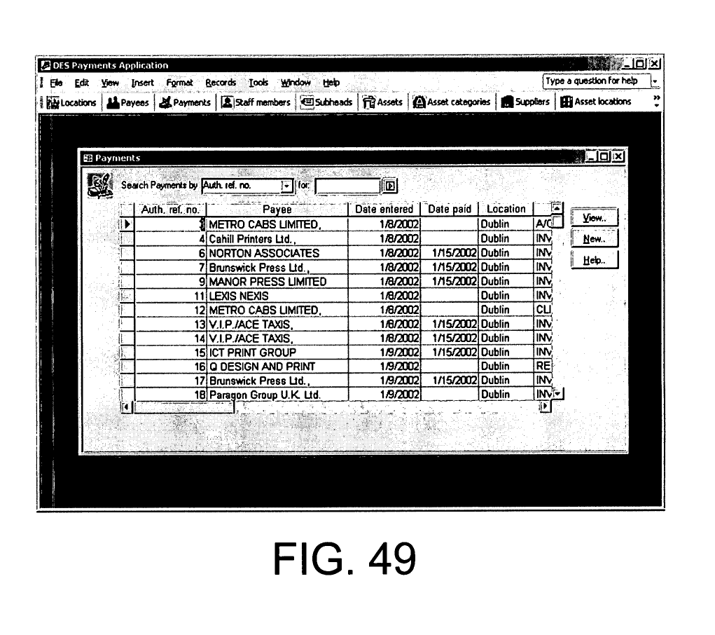

For comparison, a client-server list page that has similar functionality to the list pages shown in FIGS. 47 and 48, but a different appearance, is shown in FIG. 49.

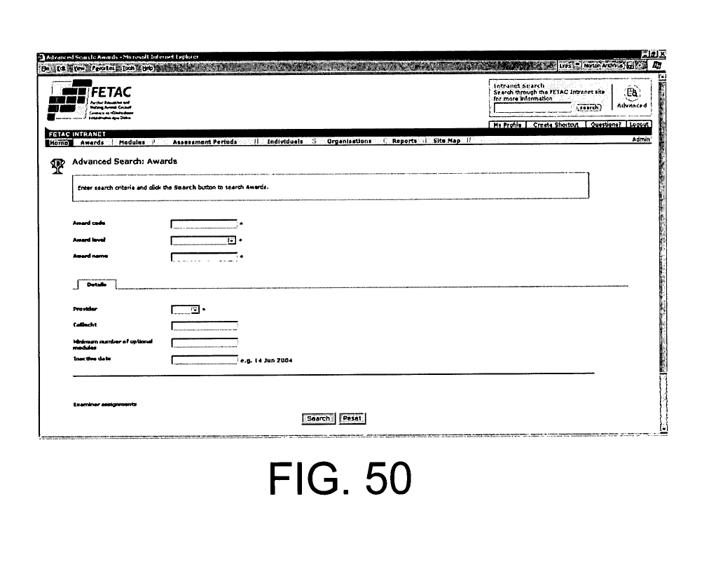

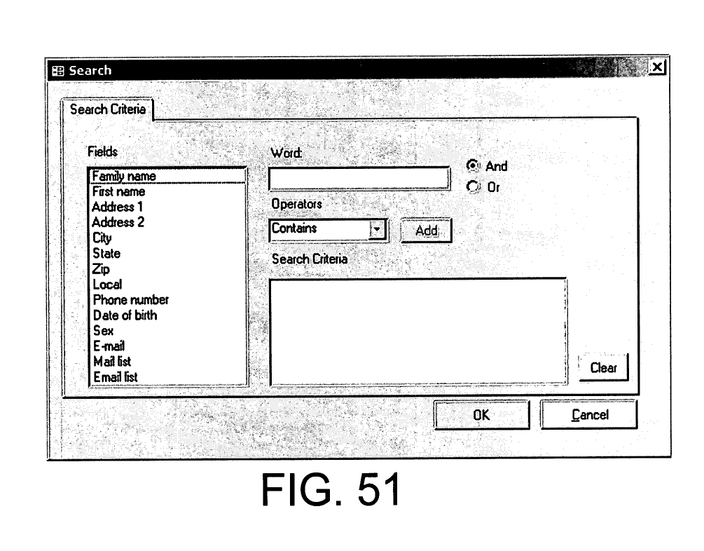

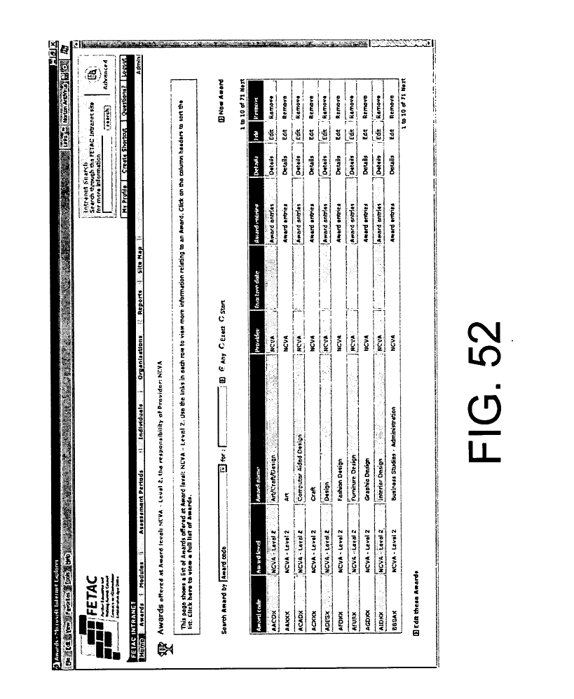

In FIG. 47, the user may elect to search a list using the search controls 3702 built into the list page. Alternatively, the user may use the advanced search page by selecting “Advanced” 3804. In response to selecting “Advanced” 3804, the application displays a page for advanced searching of data for the current business concept as shown in FIG. 50. The advanced search page may also be shown automatically when the number of rows to be listed on a list page exceeds a pre-defined limit (configurable by the system administrator). This may be another built-in performance optimization feature, which avoids unnecessary overhead in displaying pages and assists the user in finding the information they want. For a client-server application, the advanced search feature is handled in a similar way as shown in FIG. 51. The results of an advanced search may be filtered on one or more dimensions. The example shown in FIG. 52 is filtered by Award level and Provider. Similarly filtered lists can be achieved in a number of ways, including by navigating from a link on a single-view page. Subject to security permissions, any result list can be downloaded into an external file in a user-specified format. When downloading, the user may specify what format to use and which fields to download. The downloaded data retains the sort order and filter properties of the original list.

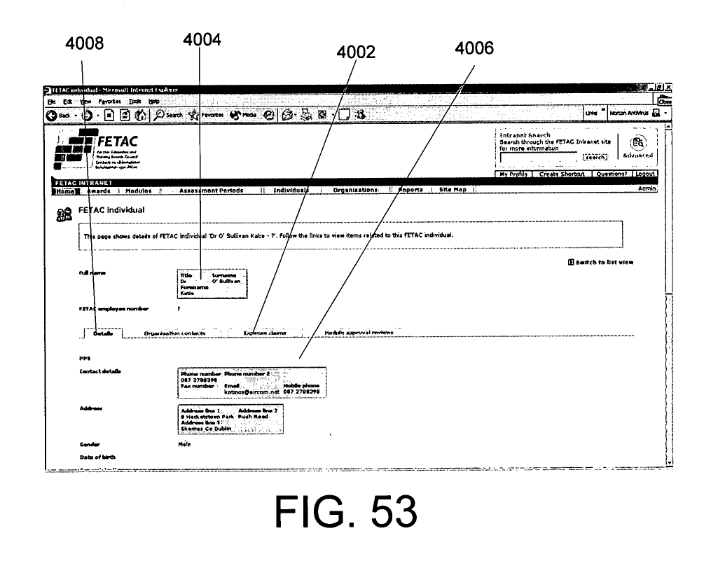

Each item in the list can be viewed if the user clicks “Details” 3806 as shown in FIG. 47. The example in FIG. 53 shows the detail of a single individual. Note the automatic inclusion of tabs 4002 for related “part” business concepts. The fields 4004 above the tabs constitute the business concept's locator as defined in the application definition. The fields 4006 on the “Details” tab represent the non-locator information.

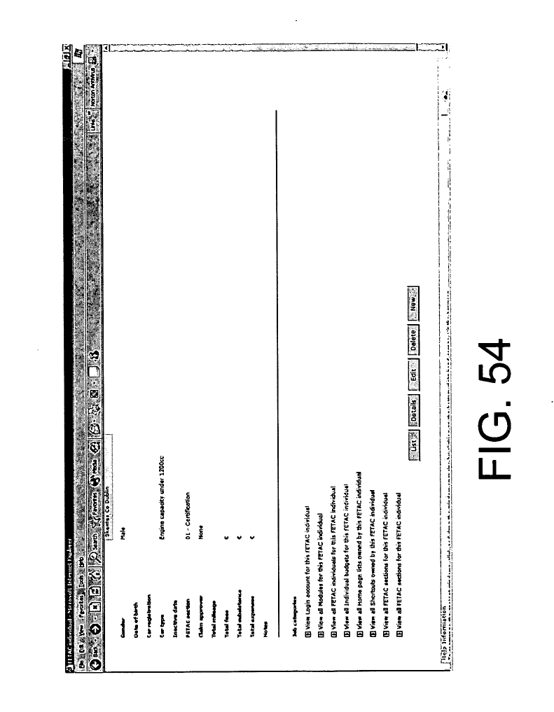

Every item on a page is displayed as a link if there is a relevant navigation path and the user is allowed to view the results (e.g., subject to security configuration). The bottom half of the page in FIG. 54 reveals a number of links to data associated with this individual, which appear provided that the user has permission to traverse them. Notice the use of the “verb phrase” to distinguish the different relationships.

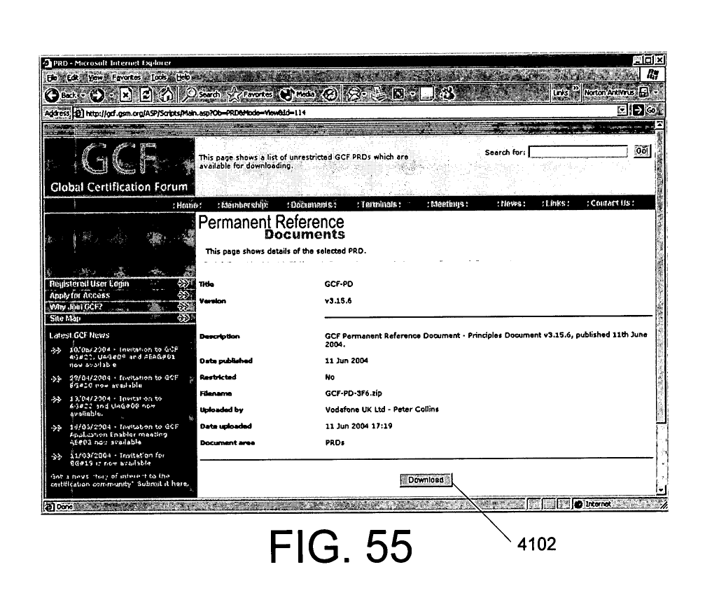

FIG. 55 shows a single-row view style. Note the inclusion of the “Download” button 4102, which appears because the business concept in question is defined with innate concept document. The BCIM understands that downloads are appropriate for this innate concept.

In both of the examples in FIGS. 54 and 55, a “parent” table (e.g., Individual, Document) is linked to a “child” concept (e.g., External Examiner, Permanent Reference Document). In these cases, requesting a record where a child record exists will result in the child record being displayed. No data is hidden since child records automatically inherit all properties of their parents.

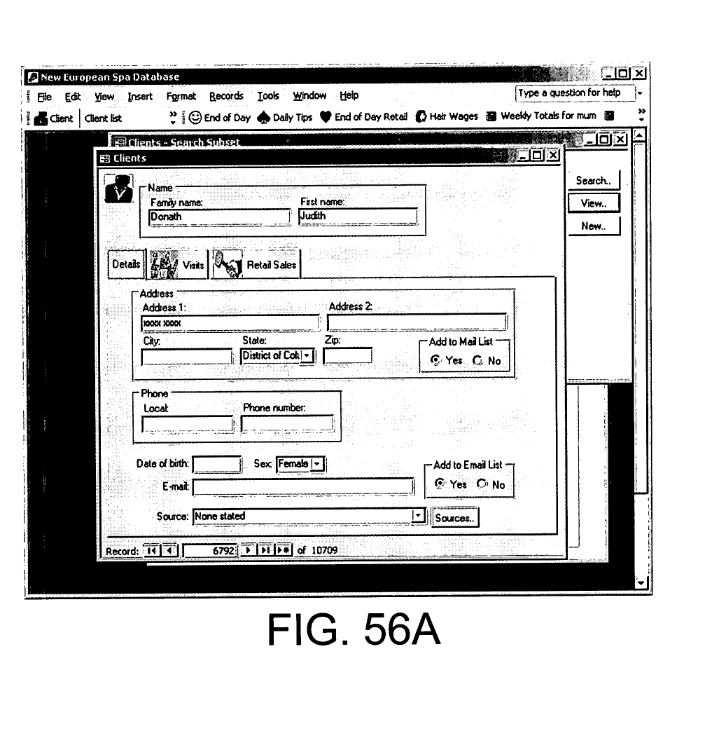

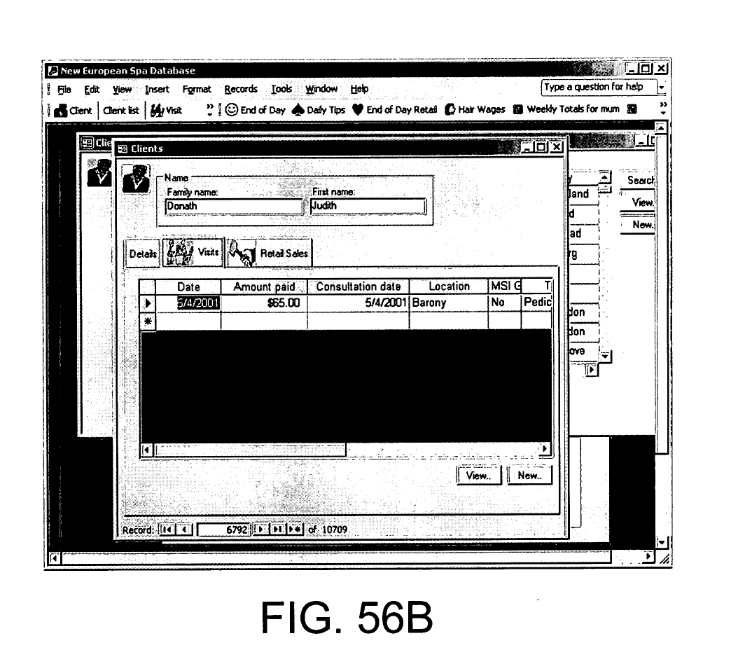

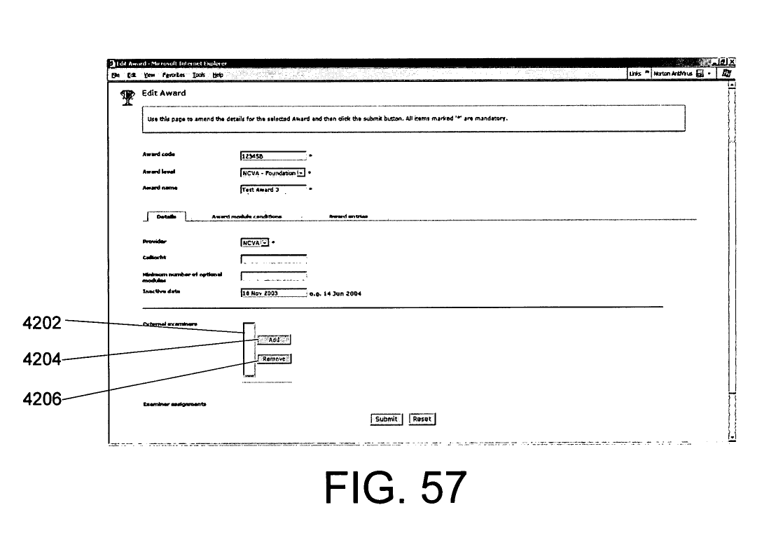

FIG. 56A shows an example of a client-server application that illustrates the tab layout. Clicking a tab as shown in FIG. 56B shows related information that may be edited. Similar capabilities may be found in web applications. Subject to security permissions, the user may edit any database row, by clicking an “Edit” link or button 3808 illustrated in FIG. 47. The system displays the data in “edit mode” as shown in FIG. 57. Although any field can be altered, referential integrity may not be compromised since (a) all links are achieved through pick lists, (b) client-side validation provides user-friendly messages in the case where mandatory links are unspecified, and (c) database constraints ensure that even if the client-side validation is bypassed, invalid data cannot be entered into the database.

In the example shown in FIG. 57, the “External examiners” multi-select box 4202 has two buttons: “Add” 4204 and “Remove” 4206. Many-to-many relationships are rendered this way when the number of items to choose from exceeds a user-defined limit. In this case, clicking the “Add” button 4204 will provide an independent pick list window where the user may search for data in a similar way to searching on list pages. Where the number of rows to choose from is less than the user-defined limit, the system instead displays them explicitly in the page so no independent pick list window is required. In both the pick list and in-page list, what is listed are the locator values for the table in question.

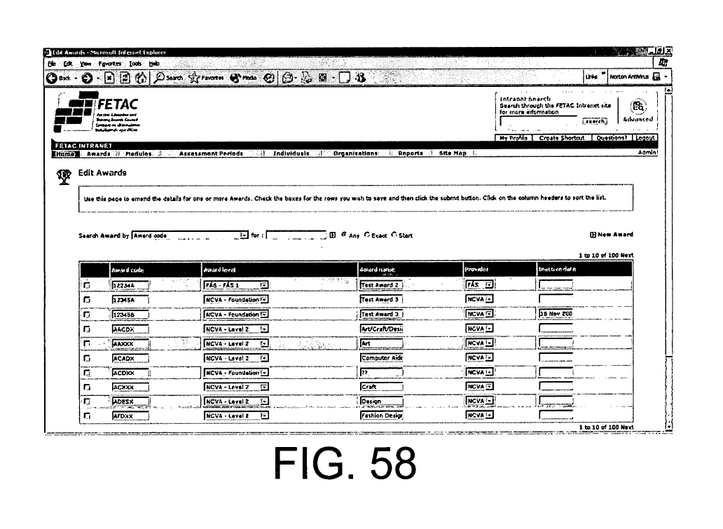

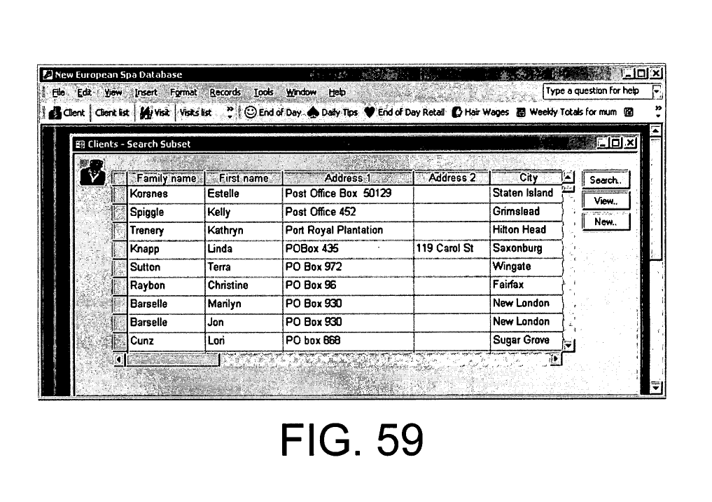

The user may prefer to edit items in a batch, as shown in FIG. 58. In FIG. 58, one or more rows may be altered simultaneously. The corresponding method for client-server applications is similar as shown in FIG. 59. Any update or insert page is available as a single-view page or as a list (batch) page and the user may switch between the views at will.

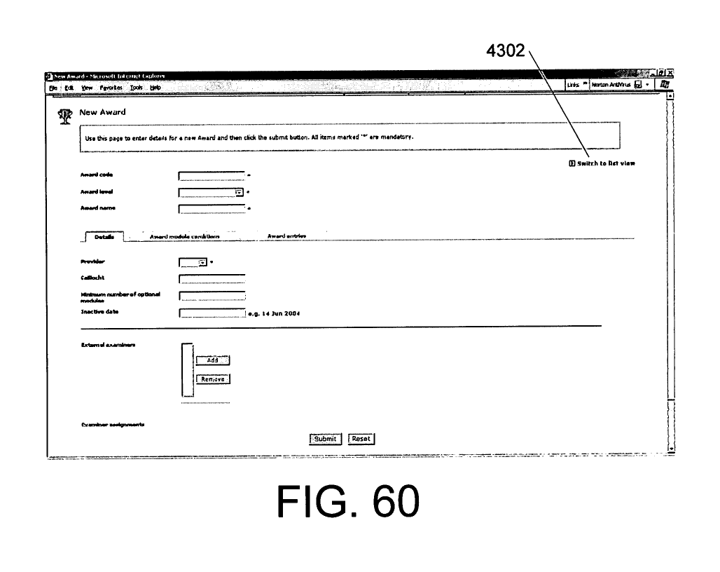

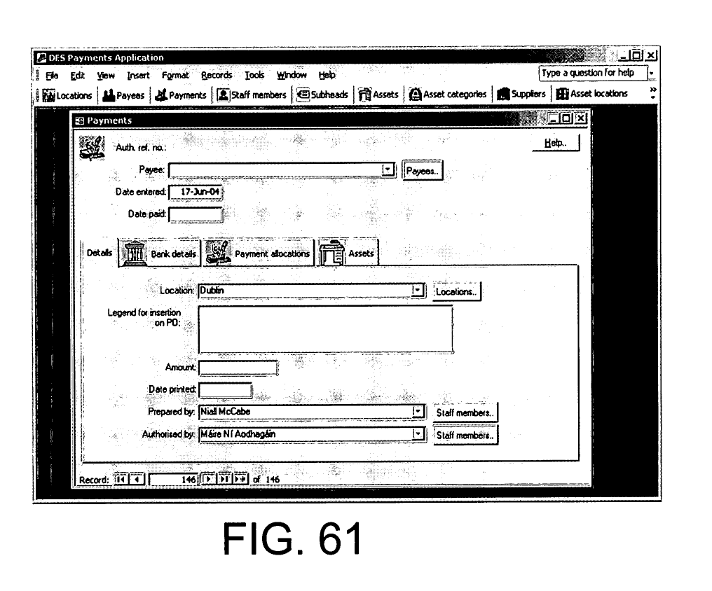

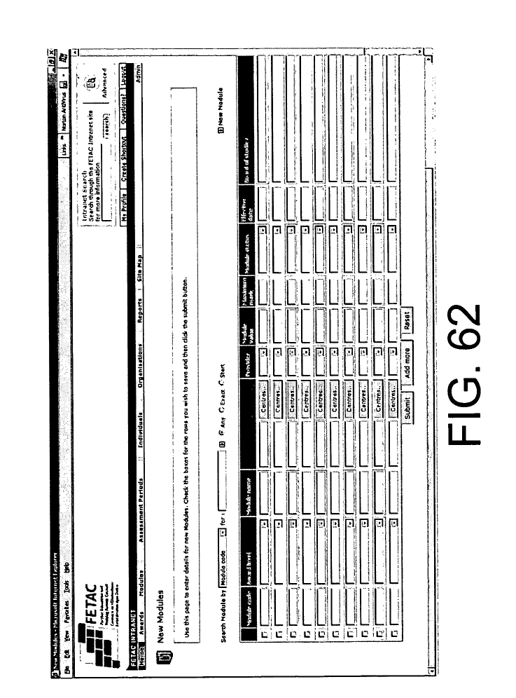

The example in FIG. 60 shows a data entry form, which is the result of clicking a “New” link or button 3810 in FIG. 47. Data may be entered in any order and the user may click on the tabs to enter related data. However, the application will ensure that no partial transaction is committed to the database and that all data saved in the database has referential integrity. In a client-server system, a similar form as illustrated in FIG. 61 is displayed. Note that certain fields have default values, which were specified in the application definition. In FIG. 60, the user may prefer to enter data in batch mode, in which case the user may click on the “Switch to list view” link 4302 and view a page as illustrated in FIG. 62. Any fields already entered on the single-row view will be carried over onto the batch entry page as default values. This allows the user to speed up batch entry where rows to be entered share common values. It also reduces load the on the server, since a batch update transaction containing ten rows is processed as a single transaction and consumes less resource than ten individual transactions.

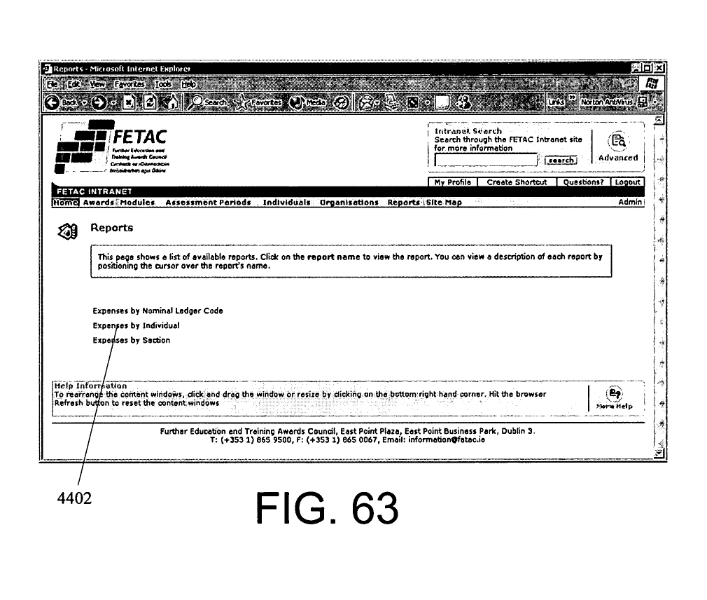

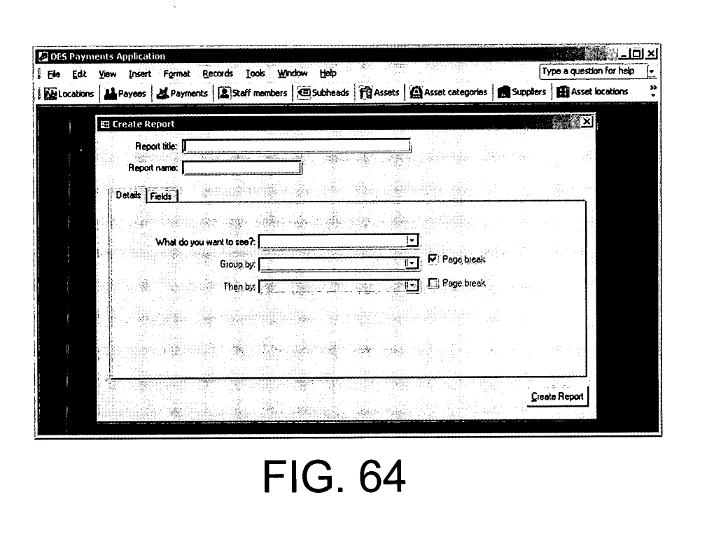

In addition, the BCIM allows predefined and user-defined reports to be made available through a standard report browsing interface as illustrated in FIG. 63. Any reports that have been defined appear automatically on the reports page, provided the user has permission to access them. If the user clicks the title 4402 of a report, the system first asks for any parameters (e.g., selection criteria) and then displays the report output in the browser. The user may page through the results, search, filter and/or print. Alternatively the user may define their own reports as shown in FIG. 64. To create a new report, a user needs only to specify what values are to appear and to select options for paging, sorting, grouping, totals, and the like. The BCIM is able to offer reports without having a complex report generator because it can assume many aspects of the application's design will follow a standardized design approach. For example, the fact that every database relationship is necessarily present and fully-formed means that data can be connected automatically to appear on the report. The benefits here are similar to those discussed above in the context of user interface design.

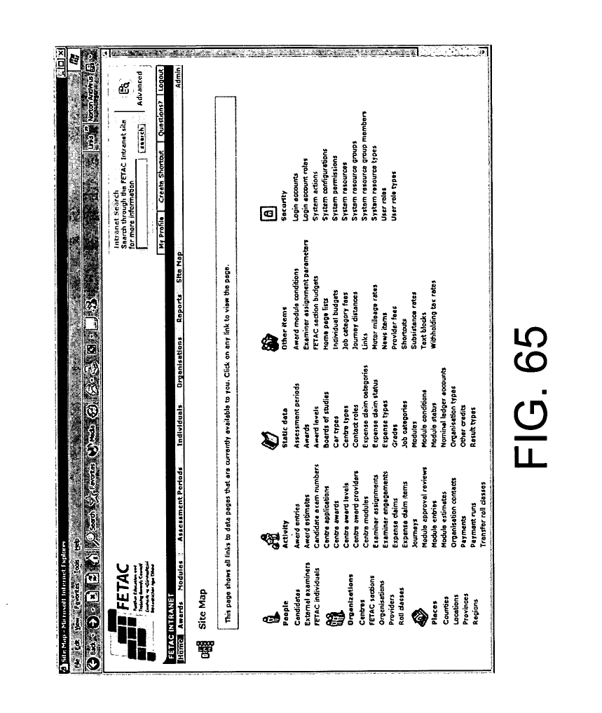

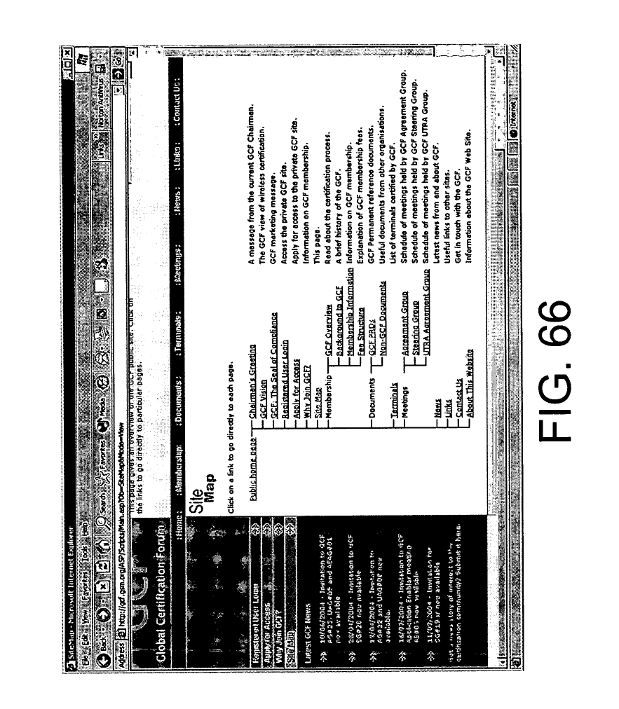

Each application may automatically include a site map page or home page (e.g., see FIG. 65), which is dynamically constructed according to the user's current permissions. Therefore the site map may show only links which the user can traverse or navigate through. The links on the site map may be conveniently grouped into different categories based on innate concepts associated with the business concepts. A specialized site map page in FIG. 65 is shown in FIG. 66. Specialized site maps are used for other purposes such as choosing a particular table for advanced searching. Other built-in features in applications include:
Automatic transaction logging with full data analysis and drill-down capabilities, producing results in both tabular and graphical form.
System configuration page allowing a user with appropriate permissions to view, modify, and apply system configuration settings.
A self-test feature where the application automatically builds all of the pages it can, to detect errors and compare page contents with previously-saved baseline versions. This is useful for automated regression testing.

The foregoing accounts of resulting application functionality describe a method of structuring applications that works regardless of the content of the applications. In other words, what is presented is a form of standardized design which may be applied to the user interface of any software application. It is especially easy to apply these rules in applications built using a BCIM because these applications conform to certain standards which apply regardless of the business concepts expressed using the BCIM. For example, every concept has a certain innate concept, and every relationship between two business concepts may be fully formed and completely described. It is this consistency in the application definition, enforced by the BCIM, which allows a consistent standard of user interface design to be implemented automatically, without any need for intervention by a human designer.

One of ordinary skill in the art would readily recognize the advantages and benefits of this standardized user interface design and its application in an automated process. Since most if not all user interface design is today carried out by human designers, today's design standards are at best guidelines that a designer may choose to follow or not. In addition, much software is developed without explicit or strongly-enforced design standards or guidelines. For this reason many software applications use idiosyncratic design styles which cause the user to have to learn a different way of working for each program. In addition, design conventions can vary within a single software application, especially if multiple designers or programmers are involved in its creation. Consequently, using these software applications is more difficult than it might be. Aspects of the BCIM overcome these difficulties by making user interface design and workflow consistent not only within each application, but across all applications. It makes possible a level of consistency in software design that has previously been unattainable except through onerous manual effort.

XI. Linking Applications

Although many business software applications may exist independently of other applications, it is often desirable to link applications together. Linking applications is necessary because (a) an organization's data may be spread across multiple existing applications; (b) several applications may need to cooperate to perform some important function; (c) large applications may be generally difficult to use and modify; and (d) it is generally impractical for an organization to satisfy all of its needs with a single application. This linking may take many forms; for example, sharing data between applications, or invocation of one application by another. The BCIM allows applications to be linked in various ways, including but not limited to:
Concurrent database access—two or more applications can be linked by transparently sharing specific data tables or whole databases.
Invoking external functions—an application can invoke an external application or function.
Providing access to internal functions—an application can allow fragments of its own functionality to be invoked by an application or function.
Invoking data access functions—a generated application can share data with an external application through the use of appropriately-designed external functions (e.g., Visual Basic code to invoke ODBC (open database connectivity) routines, giving access to data in an ODBC-compliant external database).
Web services—a generated application can offer and consume XML-based web services.
Using the BCIM API, applications may be linked in arbitrary ways to other applications and/or data sources.

The following sections discuss these various options for linking applications in more detail.

Two BCIM applications, generated for the same or different platforms, may share all or part of a common database. For example, a J2EE (Java 2 platform, enterprise edition) web application and a WML (wireless markup language) wireless application may both have access to data in the same Oracle database. To achieve this linkage between the single database and the two applications, the user simply uses the BCIM definition to generate from the same application definition twice, choosing different forms (user interface) platforms (e.g., J2EE and WML) but a common database platform (e.g., Oracle). This is the simplest case since the two applications assume an identical database structure. In this case the applications operate independently but any data is stored in the common database.

Alternatively, two BCIM applications (for the same or different platforms) may be linked together by using shared concept definitions. This can be done by making one or more business concepts in one application definition a “shortcut” to a business concept in another application definition. For example, a billing application definition could include the person business concept “Employee” as a shortcut to the person business concept “Staff member” in a human resources application definition. The business concept Employee is then used in the billing application definition in the typical manner, except that it is not explicitly defined in the billing application definition, since its actual definition resides in the human resources application definition. This is a slightly more complex example than the preceding one, because the two applications are working with different database structures, of which some elements are shared.

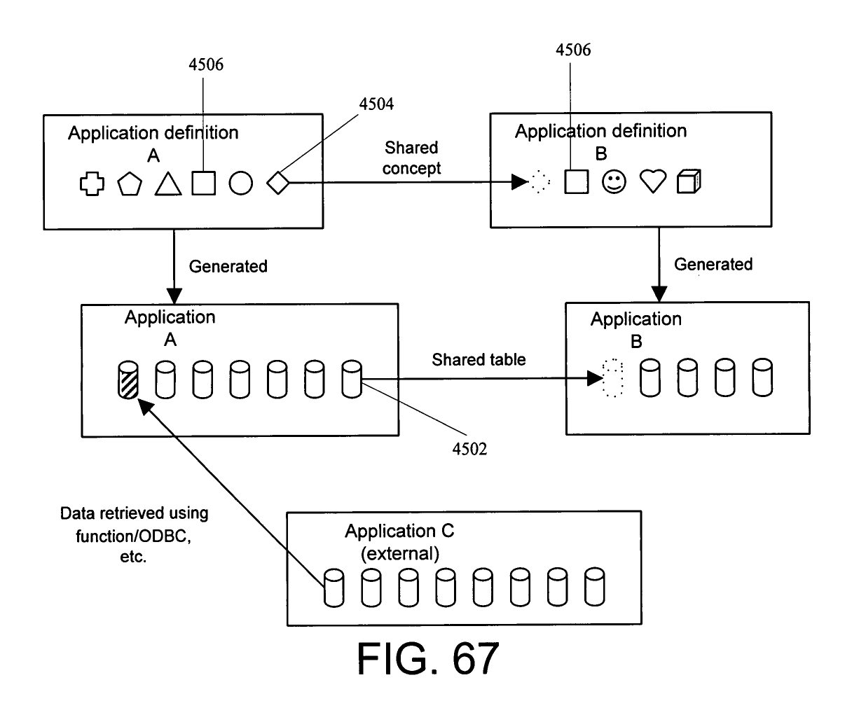

FIG. 67 illustrates three applications that have been linked. In FIG. 67, Applications A and B have been generated from separate application definitions. However, they share a data table 4502 because their respective application definitions share a common business concept as represented by the diamond 4504. Note that the business concept represented by the square 4506 is also common to Applications A and B; however, it is not shared between them, and therefore the corresponding applications do not share a table for this business concept. Instead, a copy of the table is present in both applications, and therefore data stored in one table will not appear in the other table. Application C is an external (e.g., legacy) application. Code in application A invokes custom functions to retrieve data from application C. Since arbitrary code may be placed in the Application C, any type of data linkage is possible from Application C to Application A.

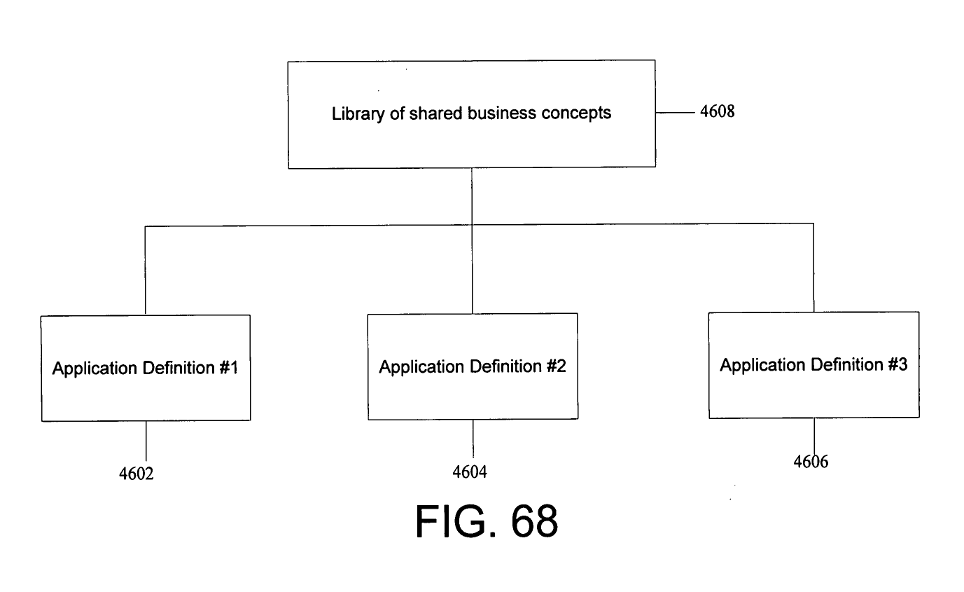

The BCIM can be applied at the enterprise level, extending the use of shared business concepts further. In this case, all of an organization's major business concepts might be mapped out in advance and made available in a central location. A two-tier approach is then used to define business concepts. For example, in FIG. 68, each of the applications definitions 4602, 4604, and 4606 is defined as a “view” of selected business concepts from the pool of enterprise-level business concepts 4608 (i.e., a collection of shortcuts). In other words, each of the application definitions 4602, 4604, and 4606 share one or more of the business concepts as shortcuts from the pool of enterprise-level business concepts 4608. Thus, those shared enterprise-level business concepts are mapped to one or more applications, which may then be fully or partially implemented by the BCIM or by external application such as CRM (customer relationship management) or MRP (materials requirements planning) systems. Further, each application may also include its own business concepts that are not shared. In addition, each application may include business concepts that inherit aspects from one or more enterprise-level business concepts 4608, but vary their properties to suit local needs.

Linked applications may also be useful where security considerations dictate that access to certain data or functionality must be restricted. Rather than providing complex security logic within a single monolithic application, it is may be convenient to meet the requirement by designing two linked applications and to provide an appropriate security level for each part. For example, a corporate system that handles sales order processing and also stores sensitive salary information might be dealt with by splitting the application into two halves: one application for sales orders and one for personnel records. The sales order application has relatively light security, while the personnel records application is strongly password-protected. Relevant data (e.g., employee names and departments) may still selectively be shared from the personnel records application to the sales orders application without any loss of security. This solution works well where there are few distinct groups of users, each with well-defined, relatively static security requirements. In situations where a more complex and flexible security set-up is required, user roles and system resource groups can be used as previously outlined.

One of ordinary skill in the art would readily recognize variations of the linked applications. For example, the BCIM could be used to integrate legacy applications with dissimilar schemas. Further, the BCIM could be used to integrate applications using XML by importing the XML specifications into the BCIM and then generating conforming applications.

XII. Virtual Applications and “Service Library” Applications

Breaking up a large application into a number of smaller applications may also be useful according to an embodiment of the invention. For example, it may allow large applications to be managed more easily without the loss of functionality. In an embodiment of the BCIM, a generated application may be partitioned into “virtual applications” for this purpose. Each virtual application may be operated and maintained individually, as a distinct software application, but overall design may be controlled using a single application definition. To enable this partitioning into virtual applications, the application may incorporate the following database tables:
Virtual application table—this contains an entry for each virtual application.
Virtual application resource table—this contains an entry for each system resource which is considered a member of the specified virtual application (e.g., system resources include pages, tables, and reports).
Virtual application user table—this contains an entry for each user that is permitted to access the specified virtual application.

Thus, the partitioning of an application into virtual applications may be determined at run time (or, at least, deployment time) rather than at design time. Each virtual application consists of a subset of the resources owned by the (physical) application of which it is a part. Virtual applications can overlap; any given resource may be shared amongst several virtual applications. Each virtual application can have its own style sheets, templates, properties, customizations, and the like. However, all virtual applications within a single physical application may share the same databases. At run time, when a user logs into a specific virtual application, the application checks that the user is permitted to use the virtual application in question, in addition to performing its normal user authentication checks. Once logged in, the user may be presented with only those resources that are part of the current virtual application (given appropriate permissions, as usual). This means that a user may be denied access to a resource if it is outside of the scope of the current virtual application, even if the user has permission to view a particular page, table, or report in the virtual application.

There are several benefits to dividing large applications into virtual applications:
Although they may work in a consistent way, virtual applications can look different from one another, in terms of layout, content and color scheme. This may increase usability through ease of recognition and recall.
Using virtual applications may be a simpler arrangement than linking multiple heterogeneous applications. For example, the use of a single, common database ensures data integrity and avoids the need for complex interfaces.
Maintenance may be simplified, since there is in reality only one application. However, maintenance tasks can be split so that, for example, customizations pertaining to a particular vertical application can be developed, tested and deployed separately from other customizations.
Deployment is easier and deployment options are more flexible. For example, the same physical application can be deployed on every server, but specific virtual applications can be mapped to specific servers.

Taking the idea of partitioning applications to its logical conclusion, every function offered by an application can be made capable of being invoked separately (e.g., via web services). An application built using a BCIM can then be used as if it were a library of services, each of which may be available to use in generating new applications. Process orchestration software, such as Fiorano Enterprise Services Bus, could be used for this purpose. Typically, in creating new applications, by assembling services in this way, additional services from other (non-BCIM) services would also be included. Further, the BCIM could be used in building an application which may be automatically enabled to contact and use other applications' web services. Provided the external web services conform to a standard form and terminology, based on that in the application definition, this interaction can be made to work with little need for configuration or programming. In this case, the specifics of how to contact each external web service (e.g., address, etc.) would need to be stored in the application definition or programmed using the BCIM API. In situations where the external web services do not conform to a standard form and/or terminology, the BCIM API can also be used.

XIII. Sharing Application Definitions and Business Concepts

According to an embodiment of the invention, there may be great value in exchanging common application definitions and business concepts, which may be used “as is” or as the basis for new application definitions and business concepts. For example, when designing a human resources application, a user may wish to use an existing application definition that contains business concepts such as job application, interview, job offer, employee, and so on, rather than defining these business concepts from the ground up. The user is then free to refine the business concepts until they closely match the organization's own models and processes. To enable this form of “conceptual reuse,” the BCIM may connect to one or more globally-shared repositories of application definitions. These globally-shared repositories may be accessible from the Internet. One of ordinary skill would recognize that data transfer mechanisms other than the Internet are also possible, including media (e.g., CD, DVD, memory sticks, removable media, etc.) and private networks and the like. Each repository may contain:
Complete application definitions, including custom code, templates (e.g., stylesheets), etc.
Useful fragments of application definitions (collections of linked business concepts).
Individual business concepts.

As an example, a shared repository might contain the application definitions illustrated in Table VII.

TABLE VII

| | | |
|---|---|---|
| Advertising | Financial management | Patents |
| Billing | Funding contacts | Personnel |
| Business planning | Goods inward | Project planning |
| Contacts | Healthcare | Quality management |
| CRM | Help desk | Real estate |
| Diary | Human resources | Rentals |
| Distribution | Insurance | Retail sales |
| Education | Investment banking | Sales performance |
| ERP | Issue tracking | Scheduling |
| Events management | Meetings | Stock control |
| Expense claims | MRP | Timesheet management |
| Farming | Order processing | Transportation |

The repositories may also contain application definition fragments (collections of linked concept definitions). These could provide useful concept definitions applicable to, for example, contact information management, system security, document management, sales, ordering, payments, logging, etc. They are all useful “application pieces” that can usefully be incorporated into full applications. Often, these fragments provide “horizontal” functions (features required in all businesses), whereas the full application definitions are often aimed at “vertical” industries or processes.

XIV. Business Concepts in System Software

One of ordinary skill in the art would recognize that the invention's use of application definitions, innate concepts, and business concepts may be extended to a variety of applications, since it provides a common language that can offer great benefits when used by different applications. For example, one benefit of this common language is that it allows applications to interoperate more easily at a semantic level. A way of achieving and supporting this use of the “business concept” approach between applications would be for it to be embedded within system software such as database management systems, (web) applications servers, and operating systems. This may allow conforming applications to work together. It may also allow “application-like” behavior to be provided by operating systems and other system software, without the need for applications as we now understand them. For example, a result of embedding innate concepts and business concepts in system software may be that users could interact across the board with more consistent and meaningful software constructs, such as people, places and categories, than is the case today.

In present-day operating systems such as Microsoft Windows XP and Linux, users interact with a very limited set of concepts, that are based almost exclusively on software or hardware constructs. Interestingly, these concepts are for the most part artificial in that they exist only within the realm of software and do not relate well with real-world counterparts. An example would be the idea of a “file,” which relates to a collection of electronic information stored on a disk or other medium. In this sense, files cannot exist outside of the computer medium. However, most of these concepts were originally invented to shield the computer user from the actual hardware and software concepts like disk sectors, memory registers and machine code. They did this by choosing useful analogies with mental concepts from the physical world. The idea of a computer file is one example; it was originally used by analogy with paper-based filing systems. Some other examples of these concepts include:
Computer (e.g., “My Computer”) (refers loosely to the physical computer the current user is using)
Document (refers to a collection of data stored electronically; does not refer to physical documents)
Web page (refers to a web page; no other real-world counterpart)
URL (refers to a web address; no other real-world counterpart)
Folder (refers to a category applied to electronic files; does not refer to paper-based folders)
Disk (refers either to a real physical disk or (more typically) to some device capable of emulating the behavior of a disk—e.g. partition, RAM drive, solid state memory device, or network drive)
User (i.e., username and password)
Connection (e.g., to a LAN or the Internet)
Printer (refers to a physical printer attached to a computer, or to some device or software that emulates a printer)
Application (e.g., Microsoft Word) (refers to software running inside a computer or stored on a hard disk; no physical-world counterpart)
Desktop (refers to a specified electronic folder; does not refer to a physical desktop)
Shortcut (refers to an icon appearing in a folder; no physical-world counterpart)
Bug (refers to a fault in a piece of software; no real-world counterpart)
Recycle bin (refers to a category applied to electronic files; analogy with real-world wastepaper baskets and trashcans)

These operating system concepts all represent elements of the “computer world” and some of them have links to certain real-world objects. However, they fail to address the business world in which the computer is used, which is a world of complex business processes in which people and organizations interact with systems and physical objects to perform activities, and so on. Until now it has been considered acceptable for individual software applications to be responsible for throwing up these more meaningful business-oriented software constructs, and they have done so in ad hoc ways. For example, the software application “Microsoft Project” offers the following concepts:
Project (a structured collection of tasks corresponding to a user's project in reality)
Activity (a task that forms part of a project definition, with assigned resources and dependencies; corresponds to a work item done in reality; may have a work structure breakdown)
Resource (a named person or thing that is used by or performs a task; may correspond to real-world people or things)
Duration (a number indicating how much time is spent on a task)

Yet the same software vendor's product “Microsoft Outlook” has different and in some ways conflicting constructs:
Task (an item in a “to-do” list, without dependencies or resources)
Contact (a named person or organization, with no connection to tasks)
Email message (an electronic communication)
Folder (a way of classifying emails)

It should be clear that these are by no means the same concepts, even if some of them have some superficial resemblance and appear to relate to the same or similar real-world concepts. Similarly, every other software application adds its own constructs to the mix, creating a “Tower of Babel” scenario; a typical business runs many software applications, each with its own set of constructs. Most businesses have no realistic hope of getting their applications to work together meaningfully. The underlying problem here is that each software application invents its own set of concepts, so that there is no common “language” for applications to use in communicating with each other. Even if transport mechanisms such as XML or web services exist to convey messages between applications, the applications still have no common vocabulary or shared understanding of the concepts implicit in the messages.

The standard solution to this problem is “system integration”, which normally consists of extensive (and expensive) programming work using a low-level programming language such as Java or Visual Basic. Only larger and well-funded organizations can afford to take this option. There is a multi-billion dollar industry devoted to this task and some of the largest global software services companies consider themselves “systems integrators.” Another popular solution is the use of enterprise-wide software applications (e.g., SAP) which are already integrated because they cover a large proportion of an organization's operations. Apart from expense, this approach brings its own problems, since the organization must alter its own business processes to fit the way the software works rather than vice versa. And, typically, it is still necessary to do integration work because there are some applications the organization must operate which the “enterprise-wide” software cannot replicate.

If BCIMs, application definitions, innate concepts and business concepts, as defined in this invention, are incorporated within system software then many of these problems are prevented. There follows a detailed description of how this works using the present invention. Note that the following description applies not only to disk-based operating systems, such as those used in personal computers (e.g., the “thick client” model), but also to network-based operating systems and other means of interacting with local and remote computers and resources—e.g., via the Internet (the “thin client” model), database management systems such as Oracle, and application server software such as Microsoft Internet Information Server (IIS) and Apache Tomcat. This means that we do not distinguish in the discussion below between traditional client-based operating systems (like Microsoft Windows) and Internet-based portals, software and operating systems, including web search engines (e.g., Google) which are at present taking over more of the functionality traditionally offered by the disk-based operating systems. These are all referred to below using the generic term “system software.”

For system software to “speak the user's language” it has to offer a set of software constructs that match the user's own mental model of their own world. These constructs are the innate concepts used in a BCIM (e.g., person, organization, system, document, place, activity, physical object, conceptual object, and category) and the business concepts defined in terms of the innate concepts. Introducing business concepts into system software shields the user from having to translate their business-related mental concepts into software and hardware-oriented concepts like “file,” “disk,” and “program.”

In present day operating systems, some concepts are extended to provide useful variations. For example, the concept “file” is extended to provide more specific concepts such as “Microsoft Word Document,” “Microsoft PowerPoint Document,” and “Adobe PDF Document.” In an analogous way, if real-world concepts like “person” (i.e., innate concepts) could be used instead, they could be extended to create useful variations like “customer,” “employee,” and “accountant”. The operating system would have a fundamental understanding of what constitutes a person (e.g., knowing what kinds of action make sense in the context of a person) and would be able to store a single list of persons, carrying a useful subset of core data about each known person, whether a person is a customer, supplier, employee, email correspondent or otherwise. Additional data could be stored about individual persons for the specific purposes. One might conceptualize this set of core data as a “conceptual registry”, maintained by the operating system, that individual functions and applications can interact with.

Taking another example, in the context of another type of system software, database management systems, consider a database that contains the following tables: inventor, invention, patent attorney, and patent application. In today's database systems, (e.g., Oracle) the tables would all be represented in a similar way and the system software would not have any semantic knowledge about them, from which to infer properties or behaviors. Any appropriate behavior and/or treatment would need to be added in hand-crafted program code such as Java or SQL. But consider the situation if the database management system were to contain innate concepts. When creating database tables, the user would relate each table, and each column within a table, with the innate concepts. So, for example, the SQL language might be extended as follows. Instead of:
CREATE TABLE PATENT_ATTORNEY
   (NAME NOT NULL VARCHAR2(5) . . .
      we would have something like:
CREATE PERSON TABLE PATENT_ATTORNEY
   (NAME NOT NULL VARCHAR2(5) . . .
      This would inform the database software that each row in the patent attorney table relates to a person. Moreover, the column NAME may be designated as the common data held about all persons, and will therefore be used throughout as a locator for users to browse, select and identify patent attorneys. Armed with this information, the database management software could provide default behaviors appropriate to people. An example would be specific forms of interactivity that suit data about people—e.g., contact or address book, white pages, and the like.

The above discussion has focused for the sake of clarity on the innate concept “person” and considers the implications of embedding person within system software. However, a similar discussion may apply for each of the innate concepts. We will continue to refer to the person innate concept as an example. But, it is readily known to one of ordinary skill that implementation of the innate concepts within system software may provide benefits.

Each computer user operates a unique combination of software applications, and each software application may describe one or more concepts that are not used in any other application. This means that the list of business concepts corresponding to any given innate concept must be open-ended. Applications and system software should be able to manipulate arbitrary business concepts provided they match the list of supported innate concepts. Furthermore, users could be given access to this list and allowed to manipulate it themselves. For example, once the innate concept “person” has been built into system software, each user would effectively have control over their own unique taxonomy of person types (i.e., business concepts with innate concept person). Users could be allowed to add new types or modify existing types at will. This need not cause any problems, provided protection is built into the operating system to prevent users from making changes to structures that would stop functions from working (in other words, properties of business concepts that are required by specific applications should be able to be “locked”). Typically, the person types would be non-exclusive, since a person can easily have more than one role simultaneously.

The foregoing discussion does not imply that each computer may necessarily end up containing a complete list of all people on its hard drive. There are many ways that the information about people could be shared, cached, or linked. For example, data on individuals may be accessed via web search engines. According to an embodiment of the invention, such data may be accessed in a more formal way than simply searching for text on pages. Instead, for example, the search engine may search specifically for people, organizations, places, and so on, using inbuilt innate concepts like “person” “organization,” “place,” and the like rather than search the catch-all concept of a “web page.” Some search engines, such as Google, are already beginning to superimpose this kind of view on the page structure of the Web. However, they are approaching this problem in a piecemeal fashion and in precisely the same way that traditional software has embedded implicit concepts. Consequently, none of the benefits possible from the use of universally-accepted innate concepts are available. What this invention proposes is that users would be much more consistently shielded from system concepts (like “file” and “program”) and would instead interact with software applications and via the web in terms of people, organizations, places, and so on regardless of which search engine, portal, or application software they use. In fact the web and all software applications together would become a “web” of people, organizations, places, and the like rather than a web of pages. It is important to realize, however, that web pages, files and software applications will not cease to exist, since they are the mechanisms (out of many) by which information about a person can be retrieved, viewed and modified. However, their existence may become less and less obvious, just as the existence of disk sectors and machine code has become far less obvious to computer users over time.

Facilities for browsing, searching, viewing, and modifying information on persons may be built into the system software, much as current operating systems provide facilities for browsing, searching, viewing, and modifying information on files (documents) which are useful for specific file types. These person-manipulation facilities would work and be useful regardless of “person type.” Agreement between software vendors on support for the concept “person” would mean that software products would be able to share this data by default.

Because these facilities could be included as a standard part of the system software, there may be no need for software applications to (a) invent corresponding but different software constructs to represent types of people, or (b) provide the functionality necessary for manipulating data about people. Instead, the software application would merely invoke (or otherwise rely on) services provided by system software, much as present-day applications use system services for common tasks such as displaying “file save dialog” windows, opening files, and the like. The system software would itself provide the ability to manipulate data about people, and it would also handle storage of the information. For example, operating systems like Microsoft Windows may incorporate the ability to store people, organizations, places and so on, in addition to their present ability to store files.

To facilitate this way of interacting with system software, a BCIM would become an embedded part of the system software (e.g., part of an operating system). Using a BCIM, users may be able to view, navigate and modify their “taxonomy” of people types (and the types for other innate concepts, as well as the ways in which these business concepts are interrelated). However, as part of the system software, the BCIM would not be used merely to build applications or application functionality, but would affect schemas which are known to the system software and used internally by it.

Some measure of control may need to be built into this function to prevent applications or the user from altering the business concepts and structure in a radical way which breaks system software functions (and hence application) functions. One possibility is that applications and users can add structure but not remove any structures required by the operating system or installed applications, as mentioned above. For example, if the operating system or an application requires the presence of a date of birth for each person, then it would be impossible for an application or the user to remove this property. However, an application or the user would be able to add other properties such as “mother's maiden name” if this of interest for some reason.

However, an aspect of the invention is that these “people types” are in fact roles played by people. Therefore, any given person can have many roles. In this regard, a BCIM is unlike a traditional operating system that provides access to files and file types, because today each file can have only one type. Having only one type for each file in fact reflects a very fundamental shortcoming in today's operating system architecture: the user has to choose at an early stage how best to represent any given set of data. For example, in the case where an end user wishes to do some project costing and scheduling, the obvious choice might be between using a Microsoft Excel spreadsheet (good for the costing part) and using a Microsoft Project plan (good for the scheduling part). The obvious solution is to use the best parts of both programs, acting on the same data. Unfortunately it is not easy to use both programs together. The novice user is instead forced to compromise by using only one application, or by using both applications to create two separate files. More advanced users have the option of linking or embedding the files but this can be extremely complex and requires careful design.

The invention allows system software to apportion an unlimited number of roles to each item (e.g., “person types” in the examples discussed above). Therefore services relevant to each type can be offered simultaneously, either as built-in generic system services or as “add-ins” that correspond to the various functions offered by today's software applications. In this scenario, large applications as we now understand them would cease to exist, because it would no longer be useful to bundle their functions together. In their place would be a number of cooperating services which offer specific functionality and work on data from the operating system's common data repository or “conceptual registry” (whether this is local or network-based).

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for providing application functionality, comprising:
an application definition, wherein the application definition comprises:
a plurality of archetypal categories;
a plurality of business concept definitions, wherein at least one business concept definition corresponds to one of the plurality of archetypal categories, wherein at least one business concept is named and represented by a marker, and wherein at least two business concept definitions have a relationship that is based at least in part on the archetypal categories associated with each of the two business concept definitions; and
a run-time component, wherein the run-time component executes:
the application definition; and
upon modification of one of the business concept definitions, a modified application definition reflecting the modification to the business concept definitions.

2. The system of claim 1, wherein at least a portion of the plurality of archetypal categories are associated with one or more sets of persons, of organizations, of systems, of places, of activities, of documents, of conceptual objects, of physical objects, or of categories.

3. The system of claim 1, wherein the run-time component comprises one or more of system software and application software.

4. The system of claim 1, wherein the executed application comprises one or more user interfaces associated with the business concept definitions, wherein constructs of the user interfaces depend at least in part on the archetypal categories associated with the business concept definitions.

5. The system of claim 1, further comprising at least one window associated with a business concept definition, the window capable of displaying components of the business concept definition.

6. The system of claim 1, further comprising an interpretation function for presenting components of the business concepts in at least one of natural language and object model view.

7. The system of claim 1, wherein the relationship between the two business concept definitions is determined, at least in part, on positions of the markers on a user interface.

8. The system of claim 7, wherein markers in close proximity to each other denote a close relationship between the corresponding business concept definitions.

9. The system of claim 7, wherein markers comprise images.

10. The system of claim 1, further comprising a data table associated with one or more business concept definitions.

11. A method of defining business concept associations, comprising:
providing a plurality of archetypal categories;
defining a plurality of business concepts, wherein at least one business concept definition corresponds to one of the plurality of archetypal categories, wherein at least one business concept is named and represented by a marker, and wherein at least two business concept definitions have a relationship that is based at least in part on the archetypal categories associated with each of the two business concept definitions; and
automatically deducing a relationship between a first business concept definition represented by a first marker and a second business concept definition represented by a second marker based at least in part on a position of the first marker relative to the second marker.

12. The method of claim 11, further comprising: generating at least one database table associated with the deduced relationship between the first business concept definition and the second business concept definition.

13. The method of claim 11, further comprising:
providing a user interface associated with at least one of the business concept definitions, wherein characteristics of the user interface are based at least in part on the archetypal categories associated with the business concept definitions.

14. The method of claim 11, wherein providing a plurality of archetypal categories comprises providing types corresponding to one or more sets of persons, of organizations, of systems, of places, of activities, of documents, of conceptual objects, of physical objects, or of categories.

15. The method of claim 11, wherein the relationship comprises a relationship where a first business concept definition contains a second business concept definition.

16. Software for modeling business scenarios, comprising:
a plurality of archetypal categories, each archetypal category being associated with a category of real-world elements in a business scenario;
an application definition comprising a plurality of business concept definitions, wherein each business concept definition is defined at least in part based on the archetypal categories;
an image selector facility for selecting images corresponding to business concept definitions, wherein the positioning of the images on a user interface denotes, at least in part, a relationship between a first business concept definition and a second business concepts definition;
a generation function, wherein the generation function is operable to generate at least one application based on the application definition.

17. The software of claim 16, wherein at least a portion of the archetypal categories comprise categories associated with one or more sets of persons, of organizations, of systems, of places, of activities, of documents, of conceptual objects, of physical objects, or of categories.

18. The software of claim 16, wherein the image search facility provides a plurality of images for selection based at least in part on the archetypal category associated with the business concept definition.

19. The software of claim 16, further comprising an interpretation function for viewing the application definition in natural language.

20. The software of claim 16, further comprising one or more tables for use in automatically deducing relationships between business concept definitions based at least in part on corresponding archetypal categories.

21. The software of claim 20, wherein the generation function is operable to generate at least one database implementing at least a portion of the business concept definitions and at least a portion of the deduced relationships between the business concept definitions.

22. The software of claim 16, wherein the generation function is operable to generate at least one user interface for at least a portion of the plurality of business concept definitions.

23. The software of claim 22, wherein characteristics of the user interface depend at least in part on the archetypal categories for the business concept definitions.

24. The software of claim 22, wherein characteristics of the user interface depend at least in part on user roles.
